(19) United States
(12) Patent Application Publication
(10) Pub. No.: US 2014/0162746 A1
(43) Pub. Date: Jun. 12, 2014

(54) Method and kit of tools for playing lotto games

(71) Applicant: Alexander Stern, Netanya (IL)

(72) Inventor: Alexander Stern, Netanya (IL)

(21) Appl. No.: 13/936,197

(22) Filed: Jul. 7, 2013

Related U.S. Application Data
(63) Continuation-in-part of application No. 12/934,291, filed on Sep. 24, 2010.

(30) Foreign Application Priority Data
Feb. 5, 2009 (IL) 196915
Nov. 25, 2009 (IL) PCT/IL2009/001106

(51) Int. Cl. G07F 17/32

(52) U.S. Cl. CPC G07F 17/329
USPC 463/17; 273/269

(57) ABSTRACT

A method for playing lotto games using many types of betting elements, each type comprising single betting elements and sub-elements of at least two kinds, forming said single betting elements; said method comprising picking out all betting elements at random one by one from a set and then picking out at random and returning to the set, one by one a particular number of said betting elements, which bring about creation of random sequences of single betting elements and sub-elements containing all possible combinatorial types and using kit of tools for putting said betting elements, picked out at random during both games constituting said method, for writing down results of the games and for making bets, comprising: sets of said betting elements, tables associated with playing desks of a dealer and a player with tokens, tables used in lottery tickets, said tables or combo boxes used in a computer version of the method.

This application is a Continuation-In-Part application of U.S. patent application Ser. No. 12/934,291 titled Lotto Game, filed on Sep. 24, 2010, which is U.S. National Stage of International Application No. PCT/IL2009/001106, filed on Nov. 25, 2009, which claims priority from Israel Patent Application No. 196915, which has a priority date of Feb. 5, 2009.

### FIELD OF THE INVENTION

The present invention belongs generally to lotto games, and more particularly to lotto games allowing player to choose bet combinations and sequences.

### BACKGROUND OF THE INVENTION

Gambling has become very popular all over the world, especially recently. The U.S.A. and several European countries have been operating lotteries for many years. Traditional lotteries usually provide one possibility for gambling, based on the occurrence of a combination of a few numbers or symbols.

A lotto game that provides various possibilities for gambling can substantially increase revenues for a state and give people additional chances to win. It can also provide more entertainment for people and increase their interest while playing the game.

According to prior art, some methods and systems were previously proposed. RU2223805 proposes a lotto playing method and playing cards. This method is developed to increase entertaining effect due to construction with increased playing capacities. However, the method disclosed in RU2223805 is limited because it can be used only with “classical” cards. WO 92/16269 and US 2008/0015005 disclose methods for playing wagering game, which are developed to increase wagering opportunities and interest. However, these methods also can be used with classical cards and numbers. US 2007/0082721, US 2006/0073864, U.S. Pat. No. 6,079,713 and U.S. Pat. No. 5,100,139 disclose methods for playing game, which can be used for lotto games. However, all these methods are also using “classical” cards (shown in FIG. 2) and are not generalized to be played using other table games or their parts, such as chess or checkers board (FIG. 30), international draughts board and domino (FIG. 53).

U.S. Pat. No. 1,463,871 discloses a game, which is played according to the following rules: cards are drawn out of a deck at random, creating random sequence of suits. Many random sequences are created during the Lotto game: four sequences of cards of the same suit, 13 sequences of cards of the same value, sequence of suits and sequence of values of cards, which are created as derivatives of the said above sequences.

Random sequences of cards of the same suit and cards of the same value provide various possibilities for betting, based on choosing combinations of cards of different suits and cards of different values, such as the first card of each suit, the first card of each value and others. In the game disclosed in U.S. Pat. No. 1,463,871 the order of cards within each suit is of no importance. There is no mention of values of cards, but even assuming that it is implied in the idea of the game, the order of cards within each value is of no importance either. So, there are at most only two random sequences: of suits and of values of cards.

In addition, random sequences of gambling games do not include repetitions of previously selected cards or rather the selected cards are excluded from the game.

It is an object of the present invention to overcome the limitations of prior art.

It is another object of the present invention to provide a method, which can be implemented with a large number of games or other symbols.

It is still another object of the present invention to provide a method using all types of combinatorial structures of betting elements.

It is yet another object of the present invention to provide a method allowing a player to win a prize which is proportional to the complexity of his bets.

### SUMMARY OF THE INVENTION

The present invention discloses a method for playing lotto games, which is implemented with the help of each type from a plurality of types of betting elements comprising 52 cards of a standard deck of playing cards, 64 squares of chess or checkers board, 100 squares of an international draughts board, 28 dominos, symbols relating to other table games, numbers or letters of the alphabet of different colours, pictures of different colours and any types of betting elements comprising single betting elements and sub-elements of at least two kinds, forming said single betting elements.

According to one aspect, the present invention provides a method for playing lotto games using various types of betting elements, creating many random sequences of said betting elements containing all possible types of combinatorial structures thereof and providing various possibilities for betting with a wide range of probabilities to win based on said types of combinatorial structures, wherein said betting elements of each type comprise single betting elements and sub-elements of at least two kinds, forming said single betting elements, said method consisting of two parts and comprising:
placing bets on single betting elements and sub-elements or combinations, variations, permutations, combinations with repetitions or variations with repetitions thereof, according to selected by a player bet amount and a chance to win, putting tokens on appropriate spaces of one or more tables on playing desk of a player in a casino or filling in one or more tables in lottery tickets, said tables allow making every possible bet on results of games constituting both parts of said method, each table is designed for a particular kind of bets, or betting with a computing device, using said tables or combo boxes fulfilling functions which are the same as those of said tables;
picking out betting elements at random one by one from a set of said betting elements and putting each betting element face up on a space representing it in a table having a number of spaces according to a number of single betting elements, arranged in rows and columns according to numbers of sub-elements, such that each single betting element is represented by a particular space of said table as a combination of two sub-elements, which makes visual creation of random sequences forming results of games constituting both parts of said method, as follows:
picking out all betting elements at random one by one from a set of said betting elements during a game constituting the first part of said method, which brings about creation of random sequences of single betting elements and sub-elements of different kinds, which are permutations containing variations and combinations of different numbers of said single betting elements and sub-elements and also of variations with repetitions and combinations with repetitions of different numbers of said sub-elements, and writing down results of the game putting tokens or single betting elements from auxiliary sets of said betting elements on appropriate spaces of tables, or marking appropriate spaces of tables on playing desk of a dealer or lottery operator with tables for each result being written down, or with said computing device using said tables and other virtual tools or combo boxes fulfilling functions which are the same as those of said tables;
picking out at random and returning to the set, one by one a particular number of said betting elements during a game constituting the second part of said method, which brings about creation of random sequences of different kinds allowing repetitions of previously selected said betting elements, containing variations with repetitions and combinations with repetitions of different numbers of said single betting elements and sub-elements, and writing down results of the game using said playing desk of the dealer or lottery operator with said tables for each result being written down, tokens and auxiliary sets of betting elements or with said computing device using said tables and other virtual tools or said combo boxes fulfilling functions which are the same as those of said tables;
picking out at random and writing down at least two additional betting elements;
determining whether a successful bet has occurred after each part of the presented method, and in the affirmative case, granting the player winning amount according to the probability of success of his bet.

According to another aspect, the present invention provides a kit of tools for playing lotto games which comprises: sets of betting elements of different types comprising main and auxiliary sets of said betting elements, each type comprises single betting elements and sub-elements of at least two kinds, forming said single betting elements, tables comprising: tables associated with playing desk of a dealer with tokens of two kinds—with numbers and without numbers, tables associated with playing desk of a player with said tokens of two kinds, tables used in lottery tickets, said tables and other virtual tools or combo boxes used in the computer version of the method for playing lotto games; said tables and combo boxes being used for writing down results of the games and for making bets and tables for putting said betting elements, picked out at random during the games constituting the presented method are selected according to a type of betting elements from the following list:
sets of numbered and non-numbered tables having the number of spaces according to the number of single betting elements, arranged in rows and columns according to the numbers of sub-elements, such that each single betting element is represented by a particular space of each of said tables as a combination of two sub-elements;
sets of tables having the number of columns or rows according to the number of the first sub-element with numbered and non-numbered rows or columns respectively and with one row or column;
sets of tables having the number of columns or rows according to the number of the second sub-element with numbered and non-numbered rows or columns respectively and with one row or column;
sets of tables having equal numbers of columns or rows representing sub-elements and numbered rows or columns respectively;
sets of tables having the number of spaces according to the number of single betting elements, arranged in rows and columns according to the numbers of sub-elements, with columns representing the first sub-element and numbered rows and with rows representing the second sub-element and numbered columns, said tables are used with auxiliary sets of betting elements;
sets of numbered and non-numbered combo boxes showing the lists of sub-elements in the computer version of said method;
sets of numbered and non-numbered pairs of combo boxes in the computer version of said method, one combo box of each pair shows the list of the first sub-element and the other shows the list of the second sub-element, such that each single betting element is represented by a pair of combo boxes as a combination of two sub-elements.

According to one of the preferred embodiments of the method, symbols constituting said games are 52 cards of a standard deck of playing cards and wherein in the game constituting the first part of the method, all cards are picked out at random from a deck one by one in order to create random sequences of cards, suits and values of cards and in the game constituting the second part of the method, a particular number of cards are picked out at random and returned to the deck one by one in order to create random sequence allowing repetitions of selected cards, and a player defines himself single cards, suits or values of cards, or combinations, variations, permutations, variations with repetitions or combinations with repetitions thereof to bet according to bet amount and a chance to win.

The method creates many random sequences containing all types of combinatorial structures, which allows said betting.

In the first part of said method 24 random sequences of five different kinds are created: sequence of 52 single cards, four sequences of cards of the same suit, 13 sequences of cards of the same value, sequence of suits, which contains additional two sequences: of black suits and of red suits and sequence of values of cards, which contains additional two sequences: of values of picture cards and of values of non-picture cards. Random sequences allowing repetitions of values of cards and suits are created as derivatives of random sequences of cards of the same suit and cards of the same value respectively, which allows betting on the first cards of different suits, the first cards of different values of cards and additional cards picked out under the same ordinal numbers in different suits and in different values of cards respectively.

In the second part of said method three random sequences allowing repetitions of three different kinds are created: sequence of single cards, sequence of suits and sequence of values of cards.

The arrangement of cards in four rows according to suits and 13 columns according to values of cards makes visual creation of said random sequences containing said types of combinatorial structures in the course of the games.

According to one embodiment, the method can be implemented with the help of a computing device, wherein at the beginning of each game 52 cards of a standard deck of playing cards are placed face down, arranged in four rows according to suits and 13 columns according to values of cards; when a card is picked out at random by a program it is turned over and put face up on its place, when all cards are put face up the game constituting the first part of said method is over, when the card is returned to the deck in the game constituting the second part of said method, it is turned over again and put face down on its place.

According to another embodiment, the method can be implemented with the help of a computing device, wherein at the beginning of each game 52 cards of a standard deck of playing cards are placed face up, arranged in four rows according to suits and 13 columns according to values of cards; when a card is picked out at random by a program it is illuminated or otherwise highlighted, when all cards are illuminated the game constituting the first part of said method is over, when the card is returned to the deck in the game constituting the second part of said method, the illumination is turned off.

The kit of tools for playing lotto games provides various tables which can be used in a casino and in the lottery, said tables and other virtual tools or combo boxes, which can be used in the computer version of the presented method, as follows:

The kit of tools for playing lotto games comprising:

regular tokens without numbers and the following three kinds of tables: tables having one row, tables having non-numbered rows and tables having numbered rows;
following two kinds of tables: tables having one row and tables having non-numbered rows, and following two kinds of tokens: tokens with numbers and tokens without numbers;
said tokens and tables are used by a player to make one or more bets in a casino and by a dealer or lottery operator to write down the results of the game by putting said tokens on appropriate spaces of one or more of said tables.

The kit of tools for playing lotto games, comprising tables having one row and tokens without numbers, which are used by a player in a casino to make bet on one or more cards of a particular suit, cards of a particular value, suits or values of cards, or combinations thereof, and tables having non-numbered rows and tokens without numbers, which are used to make bet on one or more combinations with repetitions of suits or values of cards.

The kit of tools for playing lotto games, comprising tables having numbered rows and tokens without numbers, which are used by a player in a casino to make bet on one or more variations, variations with repetitions or permutations, a number of a row shows an ordinal number of card of a particular suit, or card of a particular value, or suit, or value of cards in variation or permutation, or an ordinal number of suit or value of cards in variation with repetitions, said tables and tokens are used by the dealer or lottery operator to write down the results of the game.

The kit of tools for playing lotto games, comprising tables having one row and tokens with numbers, which are used by a player in a casino to make bet on one or more variations or permutations, wherein a number of a token shows an ordinal number of card of a particular suit, or card of a particular value, or suit, or value of cards in variation or permutation, said tables and tokens are used by the dealer or lottery operator to write down the results of the game.

The kit of tools for playing lotto games, comprising tables having non-numbered rows and tokens with numbers, which are used by a player in a casino to make bet on one or more variations with repetitions, wherein a number of a token shows an ordinal number of a suit or a value of cards in variation with repetitions, said tables and tokens are used by the dealer or lottery operator to write down the results of the game.

The kit of tools for playing lotto games, comprising regular lottery tickets with tables having one row, tables having one column and tables having numbered rows, wherein tables having one row are used by a participant in the lottery to make bet on one or more variations with repetitions of combinations of the first card of each suit and additional cards picked out under the same ordinal numbers in each suit, tables having one column are used to make bet on one or more variations with repetitions of the first cards of every value of cards, tables having numbered rows are used to make bet on one or more variations with repetitions of variations of the first card of each suit and additional cards picked out under the same ordinal numbers in each suit and on permutations of values of cards.

The kit of tools for playing lotto games, comprising tables having 52 spaces, arranged in four rows according to suits and 13 columns according to values of cards, such that each single card is represented by a particular space of the table, which are used by a player in a casino or a participant in the lottery to make bet on one or more single cards or one or more combinations of single cards respectively, putting tokens without numbers or marking appropriate spaces of said tables, one table is used for each single card or each combination of single cards, or for one or two additional cards, and table of the same kind is used by a dealer in a casino or in the lottery to put face up cards picked out at random from a deck and to write down variations of single cards putting tokens with numbers on appropriate spaces of said table, wherein a number of a token shows an ordinal number of a single card in a variation.

The kit of tools for playing lotto games, comprising numbered tables having 52 spaces arranged in four rows according to suits and 13 columns according to values of cards, which are filled in by a participant in the lottery to make bet on one or more variations or variations with repetitions of single cards, a number of a table shows an ordinal number of a single card in variation or variation with repetitions and tables of the same kind are used to write down variations and variations with repetitions of single cards being created in the course of the games constituted the presented method, putting tokens without numbers or marking appropriate spaces of said tables, said tables without numbers are filled in by a player to make bet on one or more combinations with repetitions of single cards, one table is used for each single card.

The kit of tools for playing lotto games, comprising auxiliary decks of 52 playing cards which are used with said numbered tables having 52 spaces arranged in four rows according to suits and 13 columns according to values of cards to write down variations and variations with repetitions of single cards, said auxiliary decks of playing cards are used with said non-numbered tables to write down combinations and combinations with repetitions of single cards.

The kit of tools for playing lotto games, comprising auxiliary deck of 52 playing cards which are used with table having 52 numbered spaces according to the number of cards in a standard deck of playing cards to write down random sequence of 52 cards forming the result of the game constituting the first part of the presented method.

The kit of tools for playing lotto games, comprising tables having four columns according to the number of suits and tables having 13 columns according to the number of values of cards, said tables with numbered rows are used by a player to make bet on one or more variations with repetitions of suits and values of cards respectively, and by a dealer to write down variations with repetitions of suits and values of cards being created in the course of the game constituting the second part of the presented method, wherein a number of a row shows an ordinal number of a suit or a value of cards in variation with repetitions and a total number of rows in each table is equal to the number of draws of cards, said tables with non-numbered rows are used to make bet on one or more combinations with repetitions of suits or values of cards.

The kit of tools for playing lotto games, comprising tables with equal number of rows or columns representing suits and numbered columns or rows respectively and tables with equal number of columns or rows representing values of cards and numbered rows or columns respectively, which are used to write down random sequences being created in the course of the game constituting the first part of the presented method, said tables are used by a player to make bet on one or more permutations of suits and values of cards respectively.

The kit of tools for playing lotto games, wherein said auxiliary decks of 52 playing cards are used with tables having 52 spaces arranged in four rows according to suits and 13 columns according to values of cards to write down random sequences being created in the course of the game constituting the first part of the presented method, said tables with rows representing suits and numbered columns are used with said auxiliary decks of playing cards to write down random sequences of cards of the same suit, said tables with columns representing values of cards and numbered rows are used with said auxiliary decks of playing cards to write down random sequences of cards of the same value.

The kit of tools for playing lotto games, which are played with a computing device, wherein a program uses said tables and other virtual tools, comprising auxiliary decks of 52 playing cards and tokens of two kinds—with numbers and without numbers or combo boxes fulfilling functions which are the same as those of said tables.

The kit of tools for playing lotto games, comprising combo boxes, which are used by a player in a computer version of the method to make bet on one or more cards of a particular suit, cards of a particular value, suits or values of cards, or combinations thereof by choosing from one or more lists of suits and of values of cards, shown by said combo boxes.

The kit of tools for playing lotto games, comprising numbered combo boxes, which are used by a player in the computer version of the method to make bet on one or more variations or permutations, a number of a combo box shows an ordinal number of card of a particular suit, or card of a particular value, or suit, or value of cards in a variation or permutation, said numbered combo boxes are used by the program to write down random sequences of cards of the same suit, cards of the same value, suits and values of cards being created in the course of the game constituting the first part of the presented method.

The kit of tools for playing lotto games, comprising numbered combo boxes, which are used by a player in the computer version of the method to make bet on one or more variations with repetitions of suits or values of cards, a number of a combo box shows an ordinal number of a suit or a value of cards in variation with repetitions, and combo boxes without numbers, which are used to make bet on one or more combinations with repetitions of suits or values of cards, said numbered combo boxes are used by the program to write down variations with repetitions of suits and values of cards being created in the course of the game constituting the second part of the presented method.

The kit of tools for playing lotto games, comprising pairs of combo boxes, which are used by a player in the computer version of the method to make bet on one or more single cards, wherein one combo box of each pair shows the list of values of cards and the other shows the list of suits, such that each single card is represented as a combination of a value of card and a suit, pairs of combo boxes without numbers are used by a player to make bet on one or more single cards, combinations or combinations with repetitions thereof, numbered pairs of combo boxes are used to make bet on one or more variations or variations with repetitions of single cards, a number of a pair of combo boxes shows an ordinal number of a single card in variation or variation with repetitions, said numbered pairs of combo boxes are used by the program to write down variations and variations with repetitions of single cards being created in the course of the games constituting the presented method, non-numbered pairs of combo boxes are used to write down combinations and combinations with repetitions of single cards.

The kit of tools for playing lotto games, comprising two pairs of combo boxes, which are used by a player in the computer version of the method to make bet on one or two additional cards and by the program to write down said additional cards, wherein one combo box of each pair shows the list of suits, the other combo box of the first pair shows the list of values of picture cards, since the first additional card is picked out from 16 picture cards, and the other combo box of the second pair shows the list of values of non-picture cards, since the second additional card is picked out from 36 non-picture cards.

The method for playing lotto games wherein the betting elements are picked out at random from a deck of 64 square cards matching 64 squares of a chess board, each card is of the same color as the matching square, black or white, and the mark of the square is written on the card.

The method for playing lotto games further comprising picking out additional cards at random from eight cards with numbers: 1, 2, 3, 4, 5, 6, 7, 8 or with letters: a, b, c, d, e, f, g, h and two blank cards of white and black colors for two additional draws, wherein one additional draw is made from said eight numbers or letters and the other from said two blank cards of white and black colors, said additional cards are put face up on a desk of a dealer, all squares of a chess board picked out during the game and the results of additional draws are written down by said dealer or his assistant.

The method for playing lotto games which is implemented with the help of numbers or letters of the alphabet, or pictures having additional features to meet the requirements to betting elements, according to the definition of said betting elements.

The method for playing lotto games, wherein said numbers or letters of the alphabet, or pictures are of different colours and each colour group comprises the same numbers or letters, or pictures.

For example, pictures of geometrical figures, planets or currencies of different countries, or others.

The disclosed method for playing the lotto games provides many possibilities for betting with a wide range of probabilities to win. Due to variety of possibilities the games constituting said method can be implemented as lotteries, as casino games or as computer games. In said method a dealer and a player can be humans or automated systems. Playing the games does not require any skills. Participants of the games can play against a house or against others.

All the above and other characteristics and advantages of the invention will be further understood through the following illustrative and non-limitative description of preferred embodiments thereof, with reference to the appended drawings, wherein like components are designated by the same reference numerals.

### BRIEF DESCRIPTION OF THE DRAWINGS

FIG. 1 schematically shows a table having 52 spaces according to the number of cards in a standard deck of playing cards, which can be used:

by a dealer, to put face up cards picked out at random from a deck of 52 playing cards during both games constituting the method;

for writing down the following results of the first game using tokens with numbers:
sequences of various numbers of single cards;
sequences of cards of the same suit;
sequences of cards of the same value;

for writing down additional cards in the second game using tokens without numbers;

by game participants, to make bets on:
variations of single cards in the first game using tokens with numbers;
combinations of single cards in the first game using tokens without numbers or filling in said table in lottery ticket;

additional cards in the second game using tokens without numbers;

FIG. 2 schematically shows 52 cards of a standard deck of playing cards as an example of single betting elements;

FIG. 3A (1-13) and FIG. 3B (14-17) schematically show values of cards and suits respectively as examples of sub-elements;

FIG. 4A (18-30) and FIG. 4B (31-43) schematically show tokens with numbers and without numbers respectively;

FIGS. 5A and 5B schematically show numbered tables having 52 spaces according to the number of cards in a standard deck of playing cards, which can be used:

by a dealer to write down random sequences of single cards with or without repetitions of previously selected cards using tokens without numbers or with the help of auxiliary decks of playing cards;

by game participants, to make bets on variations or variations with repetitions of single cards using tokens without numbers or filling in said tables in lottery tickets;

FIGS. 6A and 6B schematically show non-numbered tables having 52 spaces according to the number of cards in a standard deck of playing cards, which can be used: by game participants to make bets on combinations with repetitions of single cards in the second game using tokens without numbers or filling in said tables in lottery tickets; by a dealer to write down random sequences of single cards with or without repetitions of previously selected cards using tokens with numbers;

FIG. 7 schematically shows a table having 52 numbered spaces which can be used with auxiliary deck of playing cards to write down random sequence of 52 cards;

FIG. 8 schematically shows a table having 52 spaces arranged in four rows according to suits with numbered columns, which can be used with auxiliary deck of playing cards to write down random sequences of cards of the same suit;

FIG. 9 schematically shows a table having 52 spaces arranged in 13 columns according to values of cards with numbered rows, which can be used with auxiliary deck of playing cards to write down random sequences of cards of the same value;

FIG. 10 schematically shows a table which can be used by game participants to make bets on a sequence of the first two suits;

FIG. 11 schematically shows tables which can be used by game participants to make bets on a sequence of the first two suits (tokens with numbers); or to make bets on a sequence of four suits (tokens with numbers); or to make bets on a combination of the first two suits (tokens without numbers); Said table can be used for writing down a sequence of four suits with the help of tokens with numbers.

FIG. 12 schematically shows a table which can be used by game participants to make bets on a sequence of four suits and by a dealer to write down random sequence of four suits with the help of tokens without numbers or marking appropriate spaces of said table;

FIG. 13 schematically shows a table which can be used by game participants to make bets on a sequence of the first two values of pictures cards;

FIG. 14 schematically shows a table which can be used by game participants to make bets on a sequence of the first two values of picture cards (tokens with numbers); or to make bets on a sequence of four values of picture cards (tokens with numbers); or to make bets on a combination of the first two values of picture cards (tokens without numbers); Said table can be used for writing down a sequence of four values of picture cards with the help of tokens with numbers.

FIG. 15 schematically shows a table which can be used by game participants to make bets on a sequence of four values of picture cards and by a dealer to write down a sequence of four values of picture cards with the help of tokens without numbers;

FIGS. 16A-16D schematically show tables which can be used by game participants to make bets on the first card of each value of picture cards;

FIGS. 17A, 17B and 17C schematically show tables which can be used by game participants to make bets;

FIG. 17A schematically shows a table to make bets on a sequence of the first two values of non-picture cards (tokens with numbers); or to make bets on a combination of the first two values of non-picture cards (tokens without numbers); Said table can be used for writing down random sequence of nine values of non-picture cards with the help of tokens with numbers.

FIG. 17B schematically shows a table to make bets on a sequence of the first two values of cards (tokens with numbers); or to make bets on a combination of the first two values of cards (tokens without numbers); Said table can be used for writing down random sequence of 13 values of cards with the help of tokens with numbers.

FIG. 17C schematically shows a table to make bets on a sequence of the first two values of cards (regular tokens without numbers).

FIG. 18 schematically shows a table having equal number of columns representing values of cards and numbered rows, which can be used by a player and a dealer to make bets on and to write down random sequence of 13 values of cards respectively, marking appropriate spaces of the table or using tokens without numbers;

FIGS. 19A and 19B schematically show tables, which can be used by game participants to make bets and by a dealer to write down variations with repetitions of suits;

FIG. 19A schematically shows a table to make bets on variations with repetitions of suits (tokens without numbers);

FIG. 19B schematically shows a table to make bets on combinations with repetitions of suits (tokens without numbers); or to make bets on variations with repetitions of suits (tokens with numbers);

FIGS. 20A and 20B schematically show tables, which can be used by game participants to make bets and by a dealer to write down variations with repetitions of values of cards;

FIG. 20A schematically shows a table to make bets on variations with repetitions of values of cards (tokens without numbers);

FIG. 20B schematically shows a table to make bets on combinations with repetitions of values of cards (tokens without numbers); or to make bets on variations with repetitions of values of cards (tokens with numbers);

FIGS. 21A-21D, 21E-21H, 21I-21L, 21M-21P schematically show a set of combo boxes, which can be used by game participants in a computer version of the method to make bets on a sequence of four cards of each value of picture cards;

FIGS. 22A-22G and 22H-22M schematically show a set of combo boxes, which can be used by game participants in a computer version of the method to make bets on the first card of each value of cards;

FIGS. 23A-23D schematically show a set of combo-boxes, which can be used by game participants in a computer version of the method to make bets on a sequence of four values of picture cards;

FIGS. 23E-23H schematically show a set of combo-boxes which can be used by game participants in a computer version of the method to make bets on a sequence of four suits;

FIGS. 24A-24C schematically show a set of combo-boxes, which can be used by game participants in a computer version of the method to make bets on a sequence of the first three values of non-picture cards;

FIGS. 24D-24F schematically show a set of combo-boxes, which can be used by game participants in a computer version of the method to make bets on a combination of the first three values of non-picture cards;

FIGS. 25A-25D, 25E-25H and 25I-25L schematically show a few sets of combo-boxes which can be used by game participants in a computer version of the method to make bets;

FIGS. 25A-25D schematically show a set of combo boxes to make bets on the first card of each suit;

FIGS. 25E-25L schematically show a set of combo boxes to make bets on a sequence of the first two cards of each suit;

FIGS. 26A-26H schematically show a few sets of combo-boxes, which can be used by game participants in a computer version of the method to make bets;

FIGS. 26A-26D schematically show a set of combo boxes to make bets on sequences of single cards with or without repetitions of previously selected cards;

FIGS. 26E-26H schematically show a set of combo boxes to make bets on combinations of single cards with or without repetitions of previously selected cards;

FIGS. 27A-27D schematically show sets of combo boxes, which can be used by game participants in a computer version of the method to make bets;

FIGS. 27A and 27B schematically show a set of combo boxes to make bets on variations or variations with repetitions of suits;

FIGS. 27C and 27D schematically show a set of combo boxes to make bets on combinations or combinations with repetitions of suits;

FIGS. 28A-28D schematically show sets of combo boxes, which can be used by game participants in a computer version of the method to make bets;

FIGS. 28A and 28B schematically show a set of combo boxes to make bets on variations or variations with repetitions of values of cards;

FIGS. 28C and 28D schematically show a set of combo boxes to make bets on combinations or combinations with repetitions of values of cards;

FIGS. 29A-29D schematically show two pairs of combo boxes, which can be used by game participants in a computer version of the method to make bets on additional cards in the second game;

FIG. 30 schematically shows a table having eight columns and eight rows and black and white squares, identical to a chess board;

Said table can be used:

by a dealer to put face up cards, picked out at random from a deck of 64 square cards representing 64 squares of a chess board during both games constituting the present method;

for writing down the following results of the first game using tokens with numbers:
sequences of various numbers of single squares;
sequences of squares of the same file;
sequences of squares of the same rank;

by a player in the first game to make bets on variations of single squares of a chess board using tokens with numbers and combinations of single squares of a chess board using tokens without numbers or marking appropriate spaces of said table;

FIGS. 31A and 31B schematically show numbered tables having eight columns and eight rows and black and white squares, identical to a chess boards, which can be used:

by a dealer to write down random sequences of squares of a chess board with or without repetitions of previously selected squares using tokens without numbers or marking appropriate squares of said tables;

by game participants to make bets on variations or variations with repetitions of squares of a chess board using tokens without numbers or filling in said tables in lottery ticket;

FIGS. 32A and 32B schematically show non-numbered tables having eight columns and eight rows and black and white squares, identical to a chess board, which can be used: by game participants to make bets on combinations with repetitions of squares of a chess board in the second game using tokens without numbers or marking appropriate spaces of said tables; by a dealer to write down random sequences of squares of a chess board with or without repetitions of previously selected squares using tokens with numbers;

FIG. 33 schematically shows a table, which can be used by game participants to make bets on a combination of the first two columns (tokens without numbers); or to make bets on a sequence of the first two columns (tokens with numbers); Said table can be used for writing down a sequence of eight files (tokens with numbers).

FIG. 34 schematically shows a table, which can be used by game participants to make bets on a sequence of the first two columns;

FIG. 35 schematically shows a table, which can be used by a dealer to write down random sequence of eight files of a chess board using tokens without numbers or marking appropriate spaces of said table and similarly by a player to make bets on a sequence of eight files;

FIG. 36 schematically shows a table, which can be used by game participants to make bets on a combination of the first two rows (tokens without numbers); or to make bets on a sequence of the first two rows (tokens with numbers); Said table can be used for writing down a sequence of eight ranks.

FIG. 37 schematically shows a table, which can be used by game participants to make bets on a sequence of the first two rows;

FIG. 38 schematically shows a table, which can be used by a dealer to write down random sequence of eight ranks of a chess board using tokens without numbers or marking appropriate spaces of said table and similarly by a player to make bets on a sequence of eight ranks;

FIGS. 39A and 39B schematically show tables, which can be used by a player to make bets and by a dealer to write down results of the second game;

FIG. 39A schematically shows a table to write down and to make bets on variations with repetitions of files of a chess board using tokens without numbers or marking appropriate spaces of said table;

FIG. 39B schematically shows a table to write down and to make bets on variations with repetitions of files of a chess board (tokens with numbers); or to make bets on combinations with repetitions of files of a chess board (tokens without numbers);

FIGS. 40A and 40B schematically show tables, which can be used by a player to make bets and by a dealer to write down results of the second game;

FIG. 40A schematically shows a table to write down and to make bets on variations with repetitions of ranks of a chess board using tokens without numbers or marking appropriate spaces of said table;

FIG. 40B schematically shows a table to write down and to make bets on variations with repetitions of ranks of a chess board (tokens with numbers); or to make bets on combinations with repetitions of ranks of a chess board (tokens without numbers);

FIGS. 41A and 41B schematically show tables which can be used for writing down a sequence of squares of each diagonal: black (a1-h8) and white (a8-h1) respectively;

FIGS. 42A-42C schematically show a set of tables, which can be used by a dealer to write down the results of additional draws in the second game's implementation with the help of a chess board;

FIGS. 43A-43C schematically show a set of combo-boxes, which can be used by game participants in a computer version of the method to make bets on sequences of columns with or without repetitions;

FIGS. 44A-44C schematically show a set of combo-boxes, which can be used by game participants in a computer version of the method to make bets on combinations of columns with or without repetitions;

FIGS. 45A-45D and 45E-45H schematically show a set of combo-boxes which can be used by game participants in a computer version of the method to make bets on the first square of each rank;

FIGS. 46A-46C schematically show a set of combo-boxes, which can be used by game participants in a computer version of the method to make bets on sequences of ranks with or without repetitions;

FIGS. 47A-47C schematically show a set of combo-boxes which can be used by game participants in a computer version of the method to make bets on combinations of ranks with or without repetitions;

FIGS. 48A-48D and 48E-48H schematically show a set of combo-boxes which can be used by game participants in a computer version of the method to make bets on the first square of each file;

FIGS. 49A-49D schematically show a set of combo-boxes, which can be used by game participants in a computer version of the method to make bets on sequences of single squares with or without repetitions of previously selected squares;

FIGS. 50A-50D schematically show a set of combo-boxes, which can be used by game participants in a computer version of the method to make bets on combinations of single squares with or without repetitions of previously selected squares;

FIGS. 51A-51D, 51E-51H, 51I-51L, and 51M-51P schematically show sets of combo-boxes which can be used by game participants in a computer version of the method to make bets on a sequence of eight squares of each diagonal: black (a1-h8) (FIGS. 51A-51H) and white (a8-h1) (FIGS. 51I-51P);

FIGS. 52A-52C schematically show a set of combo boxes, which can be used by game participants in the computer version of the method to make bets on the results of additional draws in the second game using a chess board;

FIG. 53 shows an example of the method's implementation with the help of dominos.

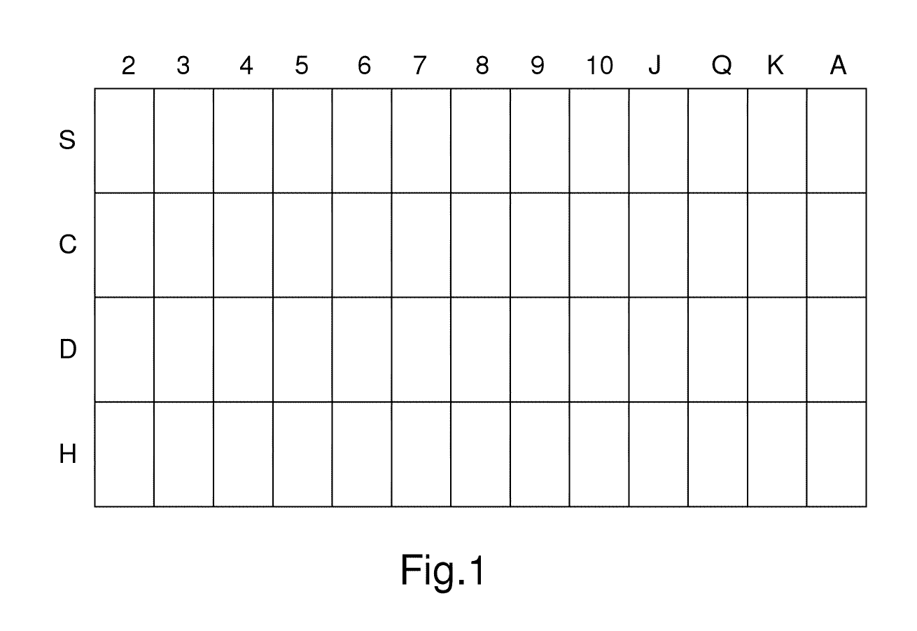

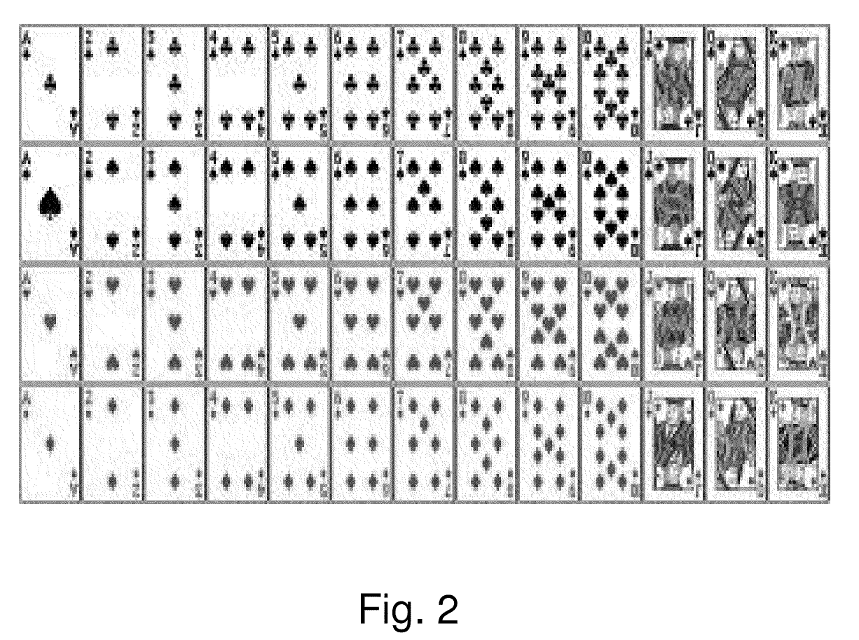

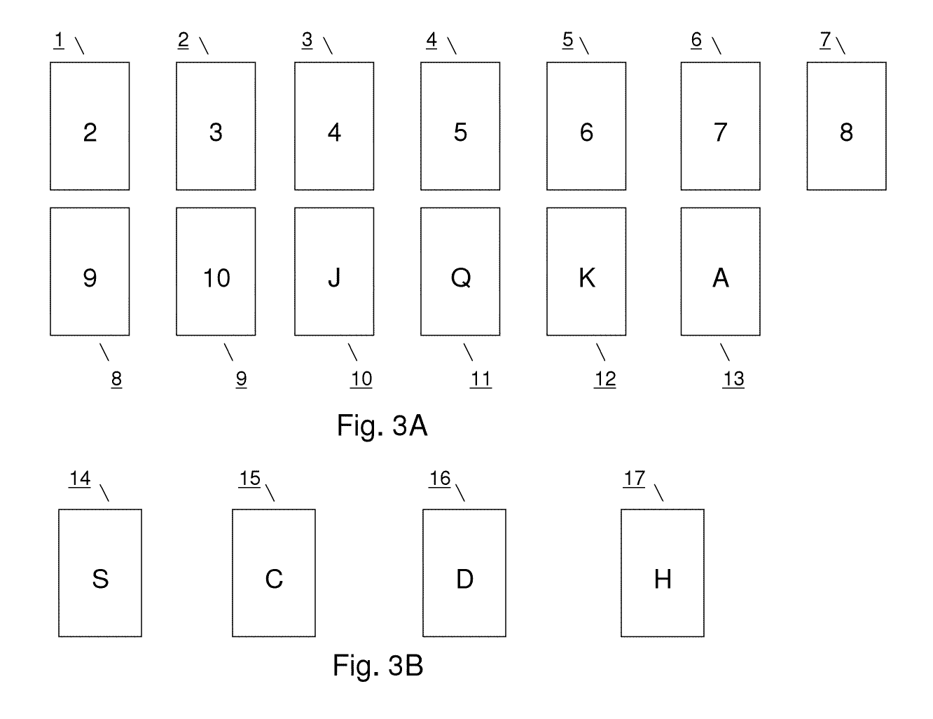

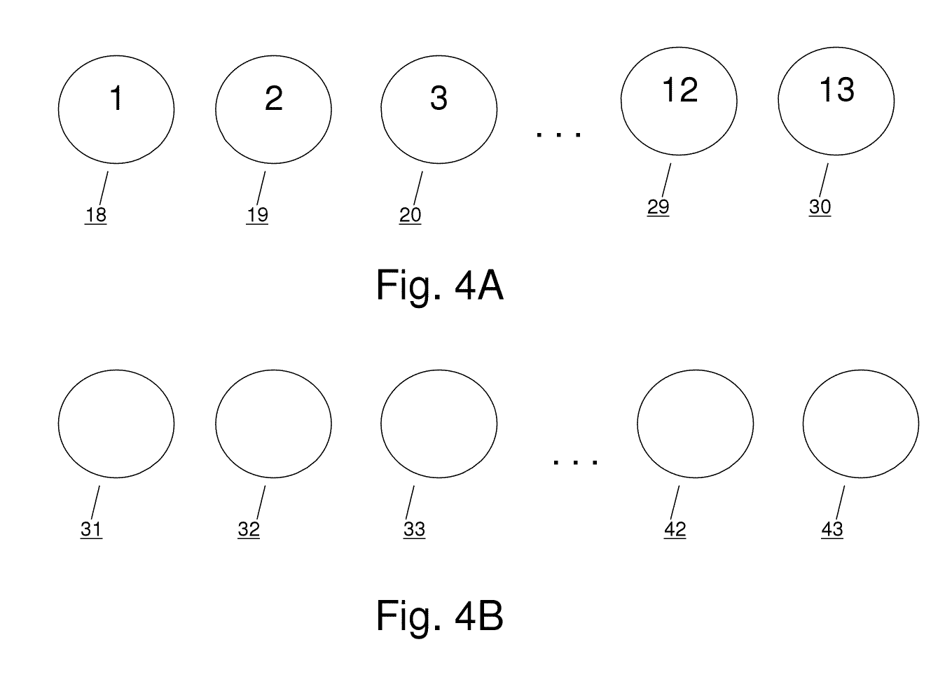

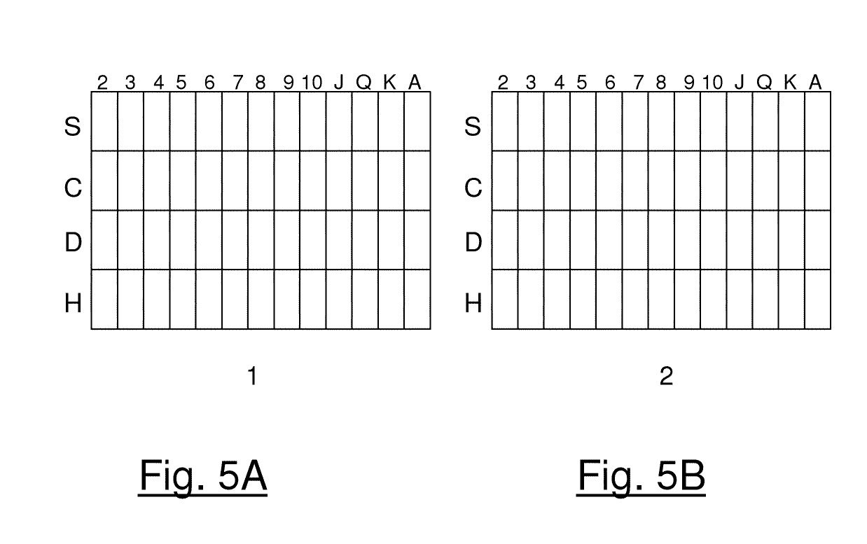

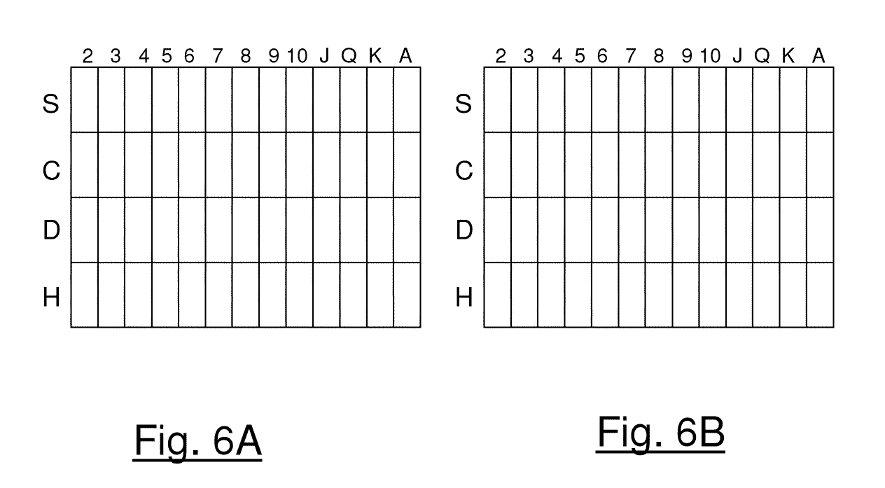

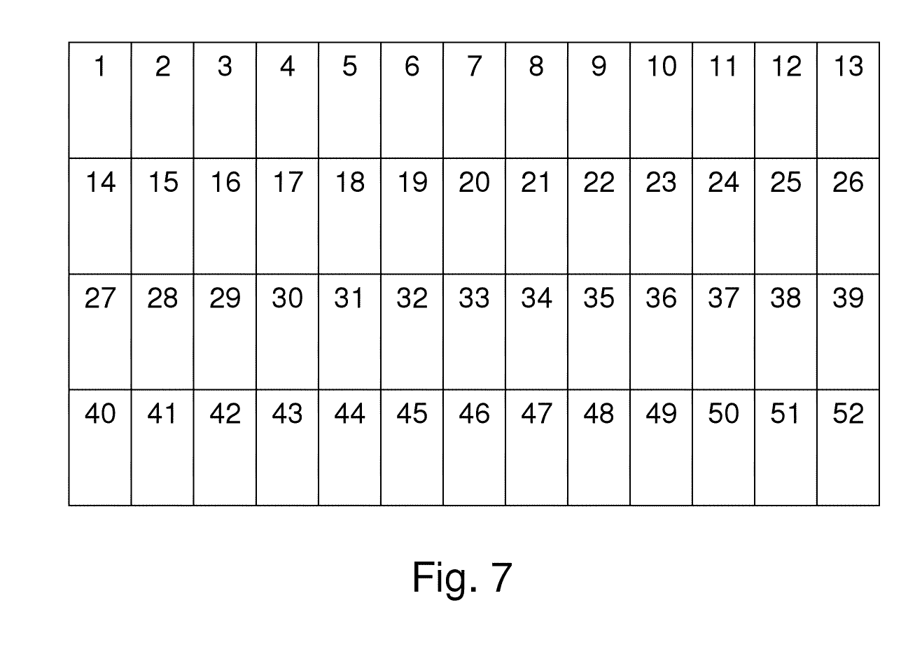

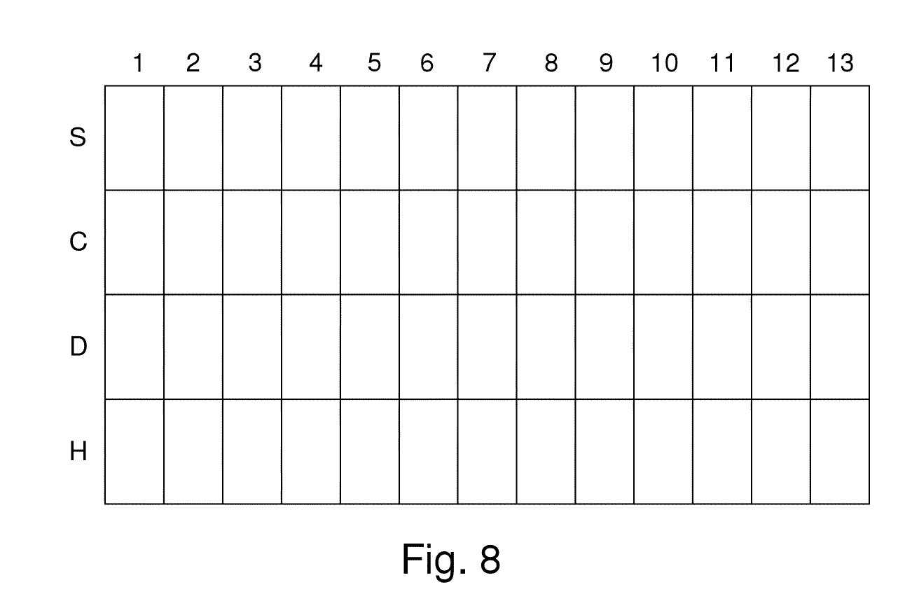

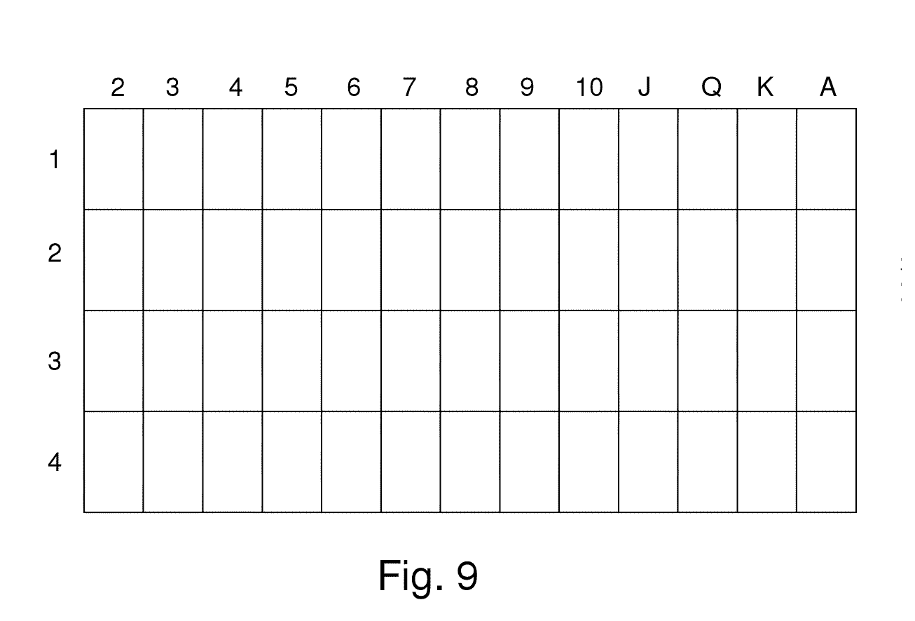

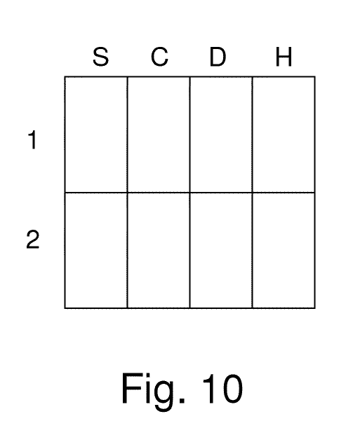

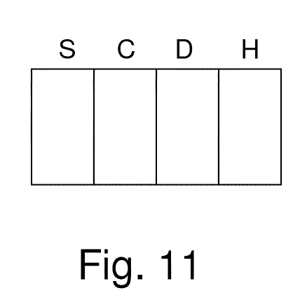

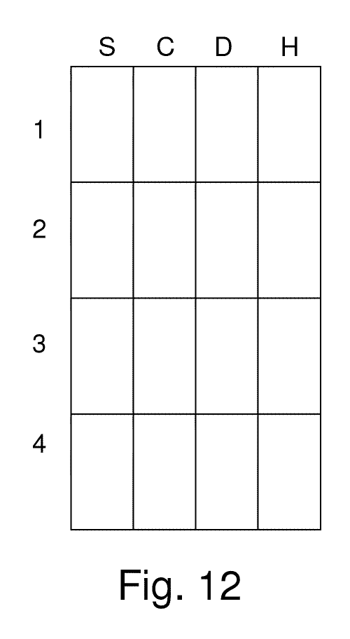

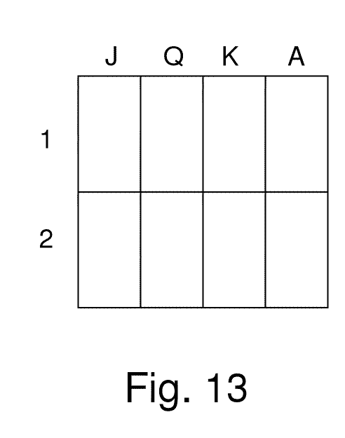

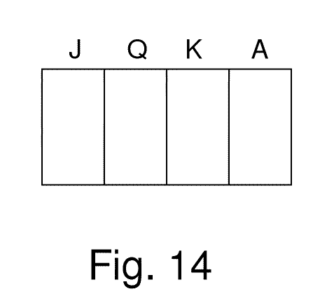

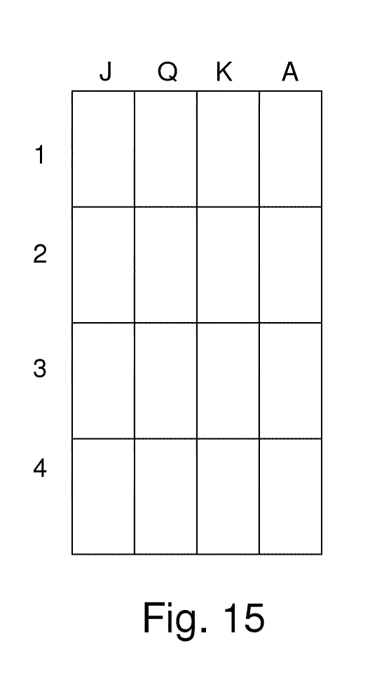

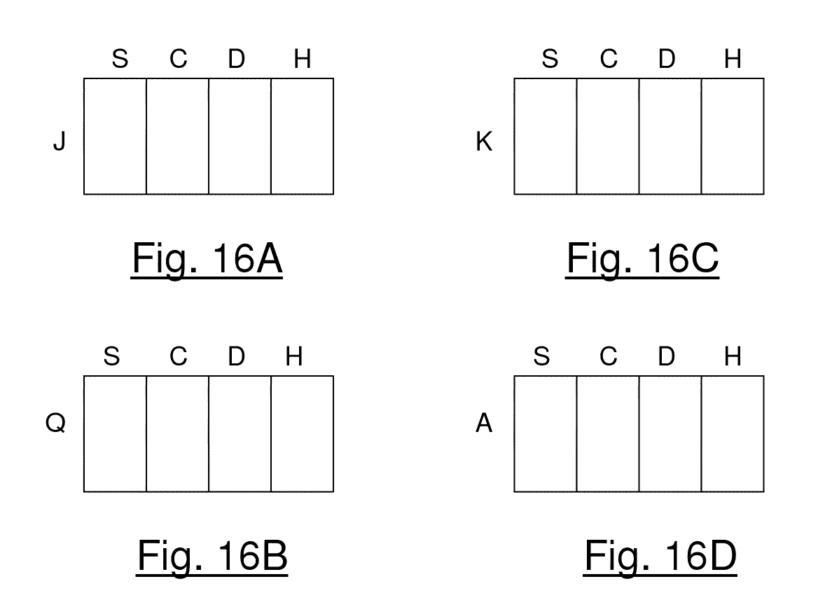

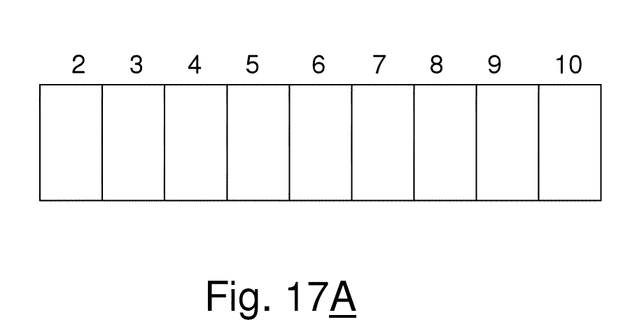

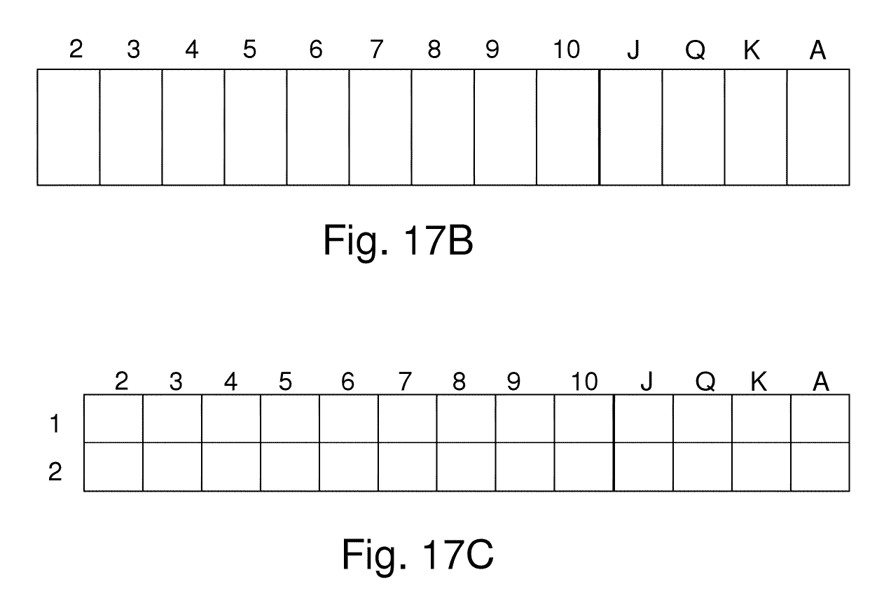

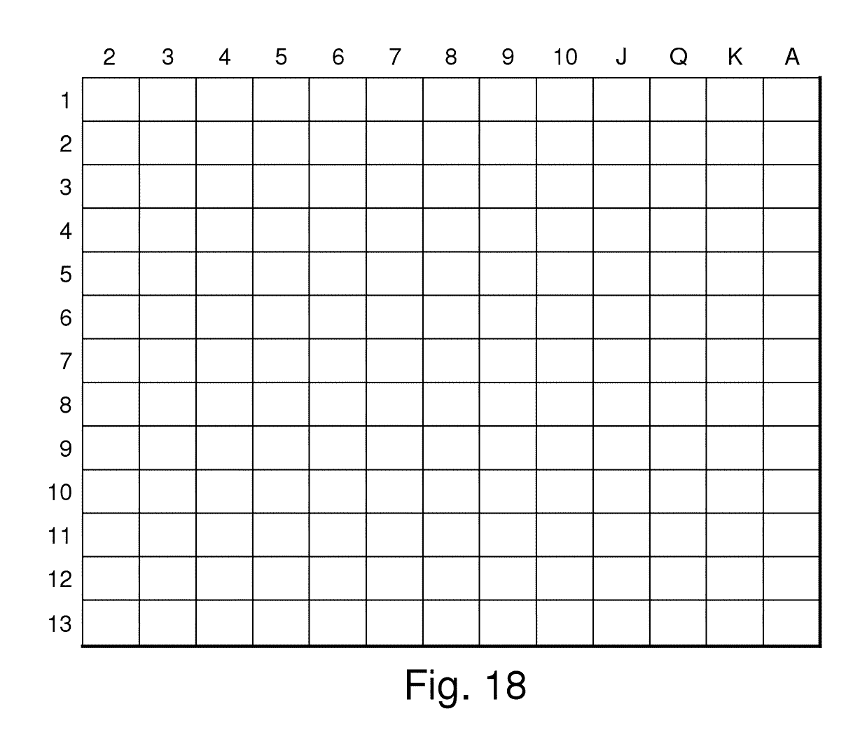

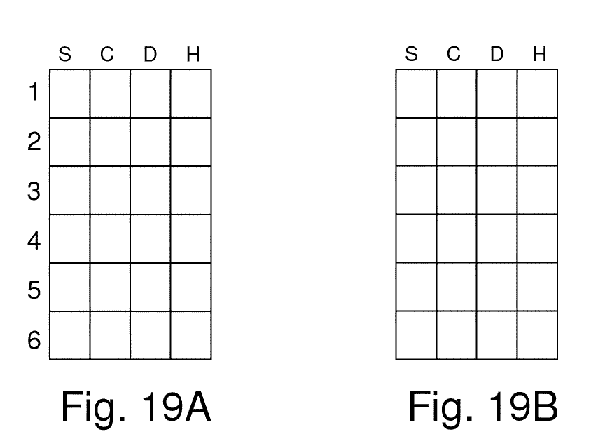

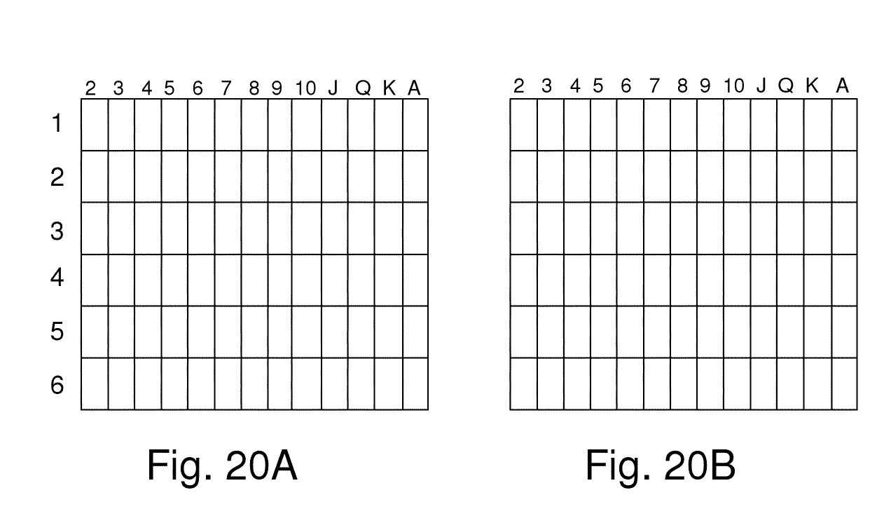

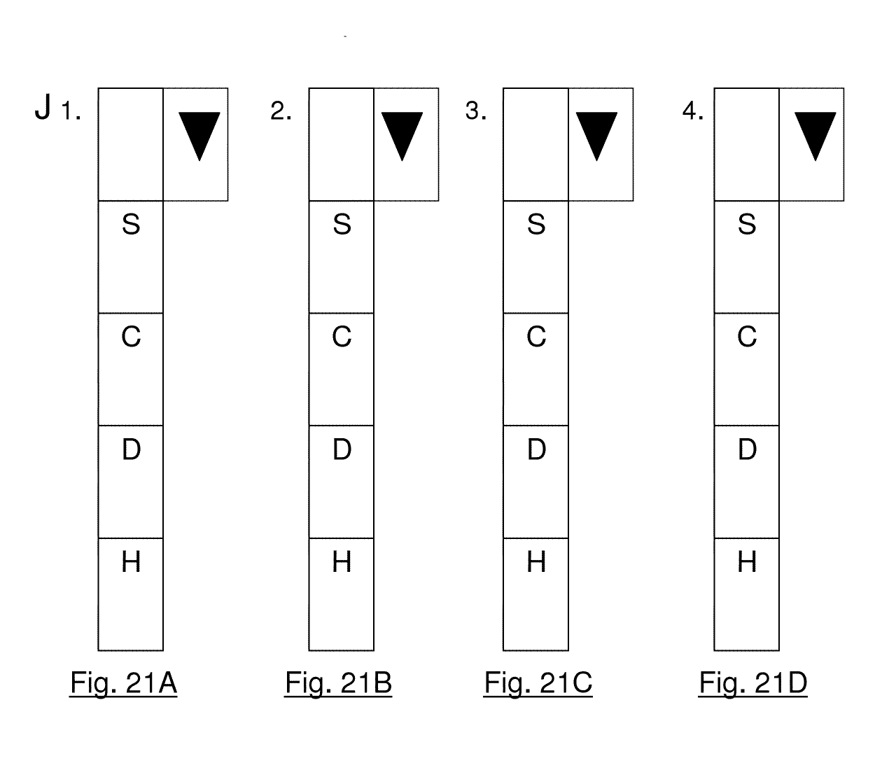

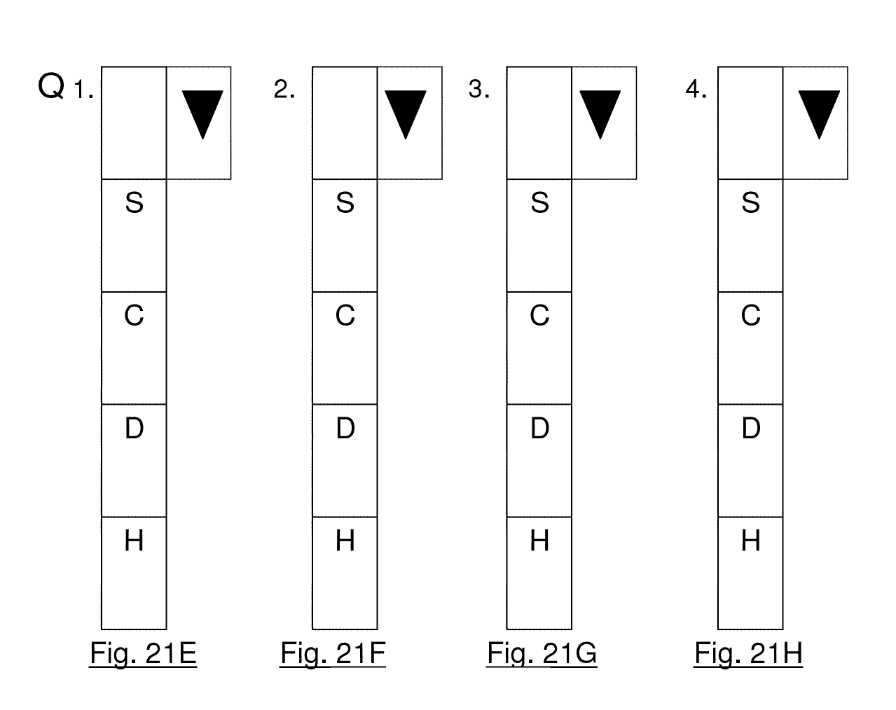

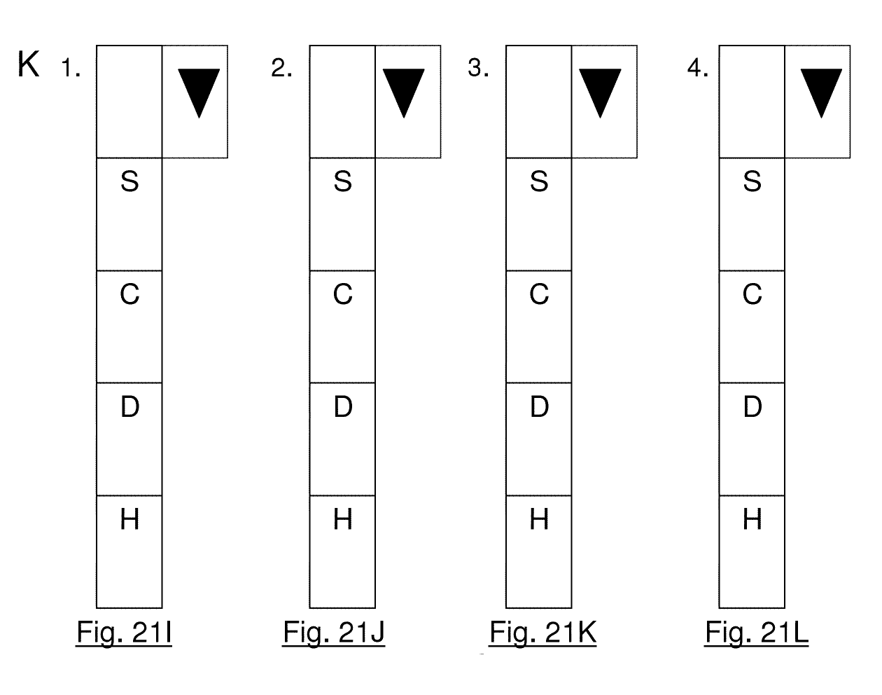

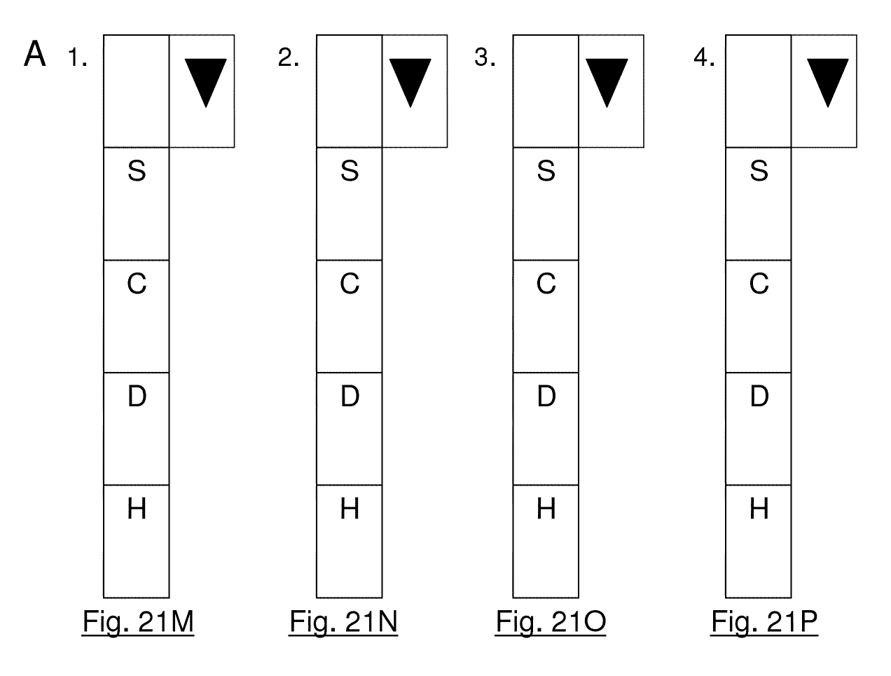

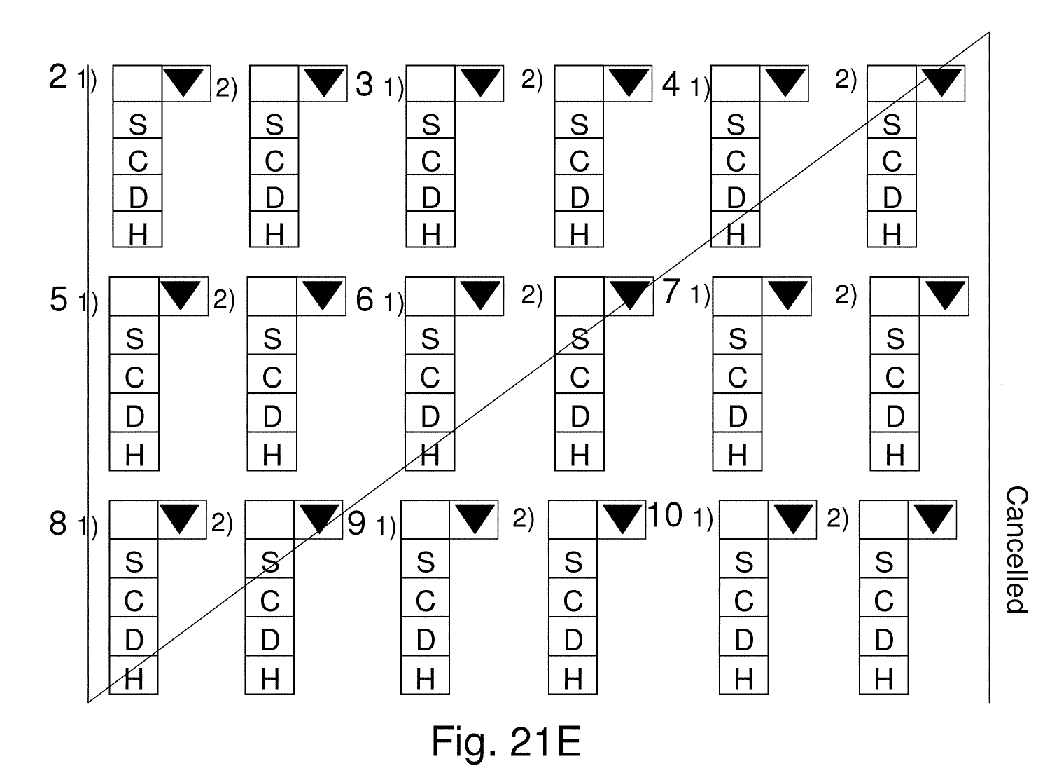

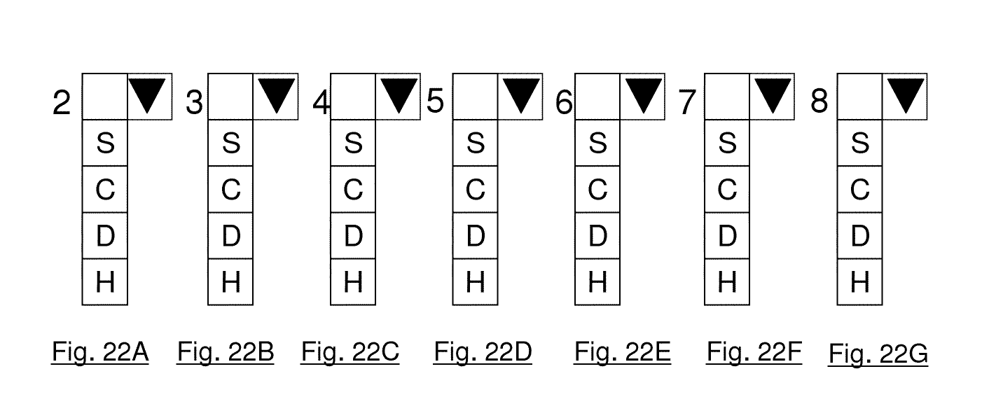

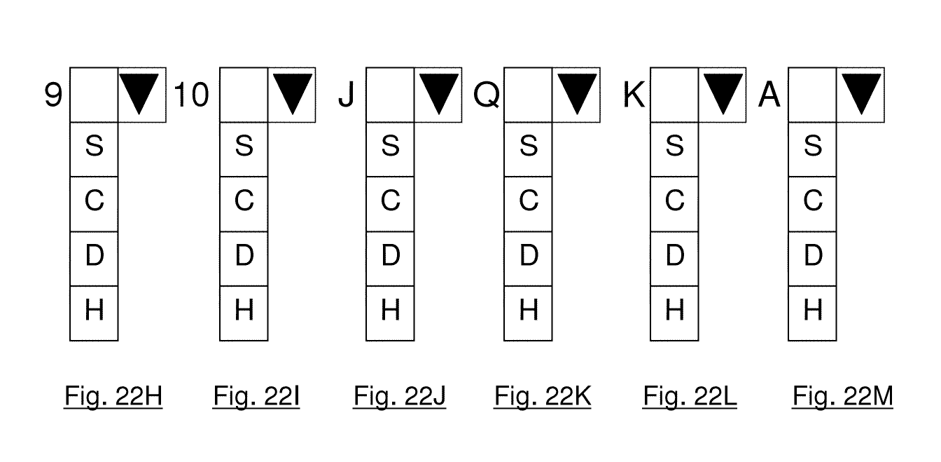

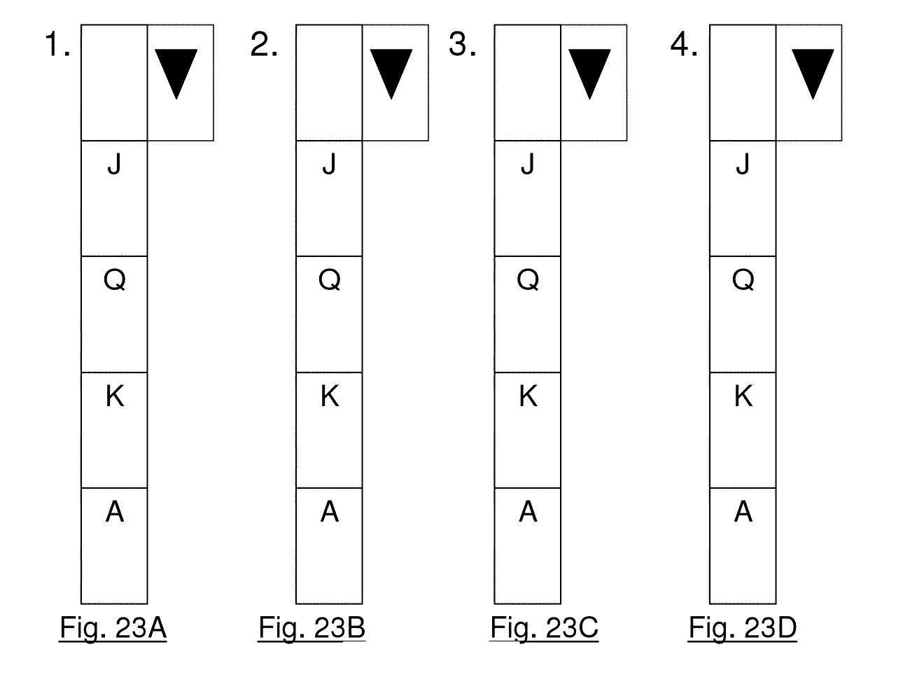

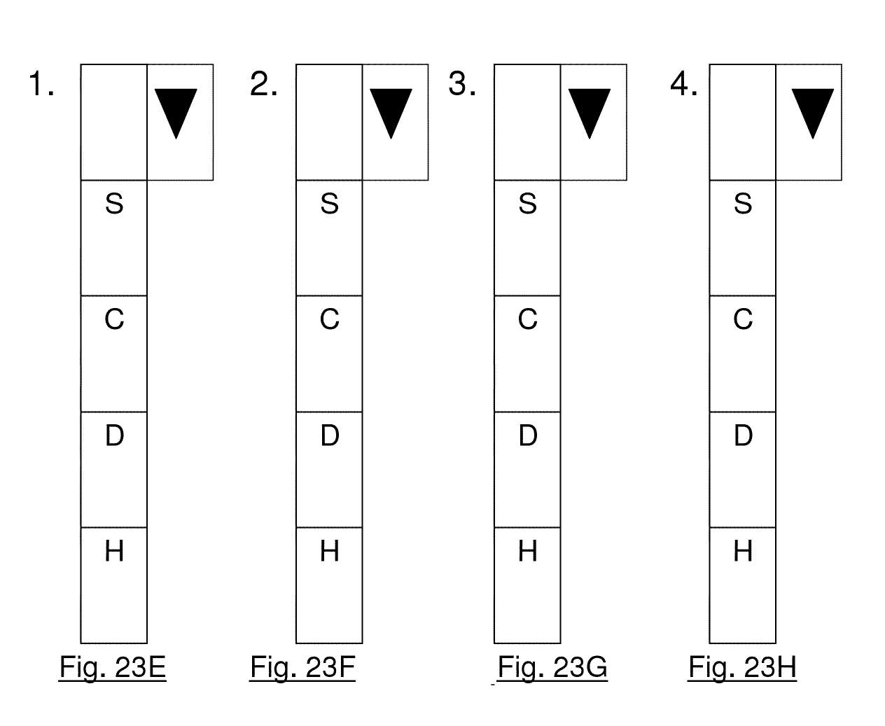

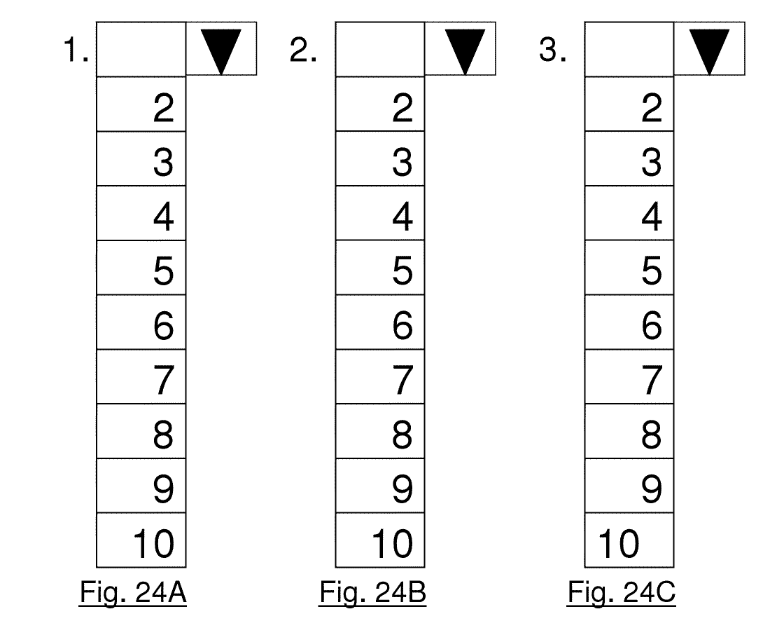

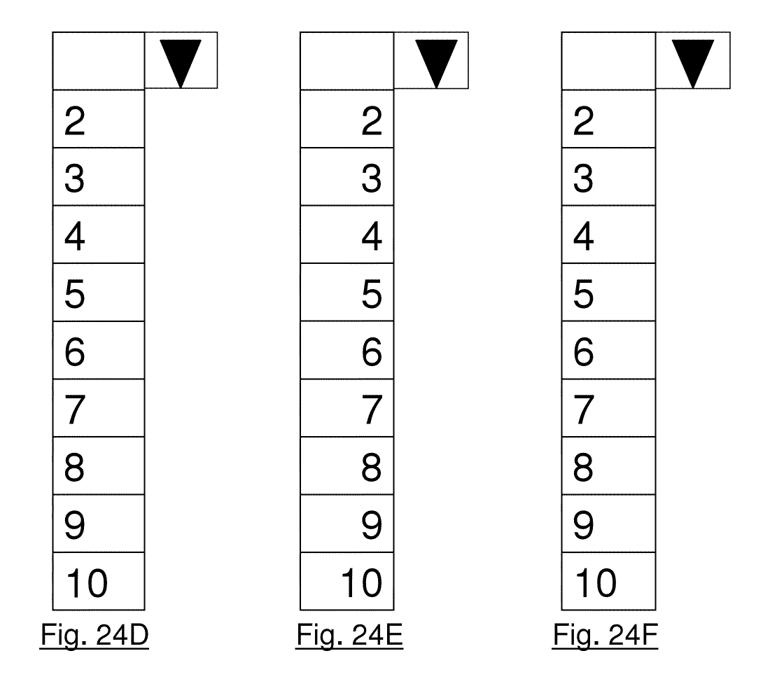

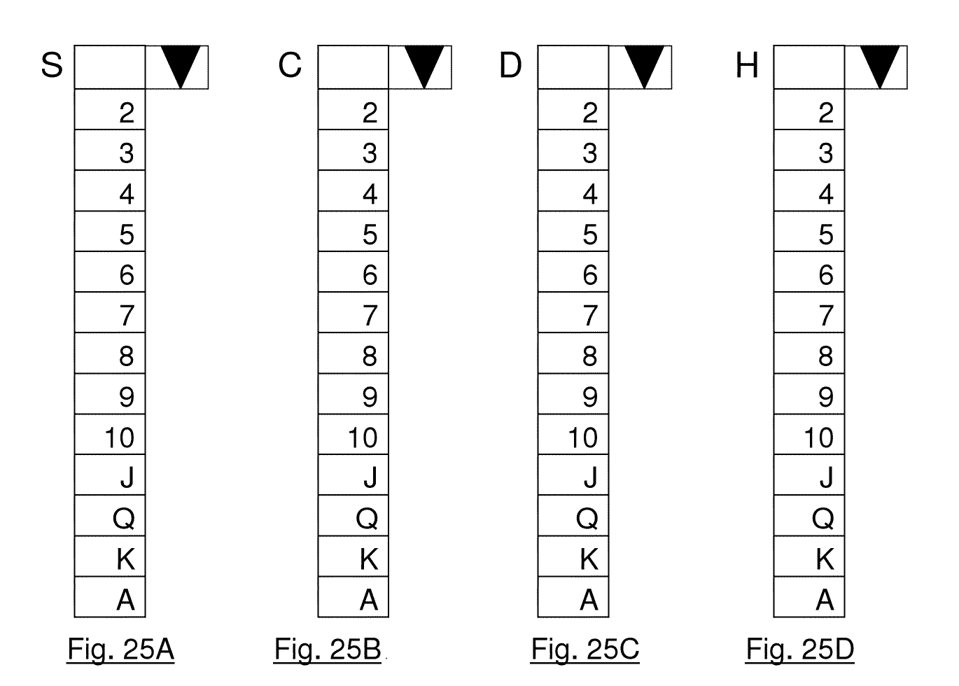

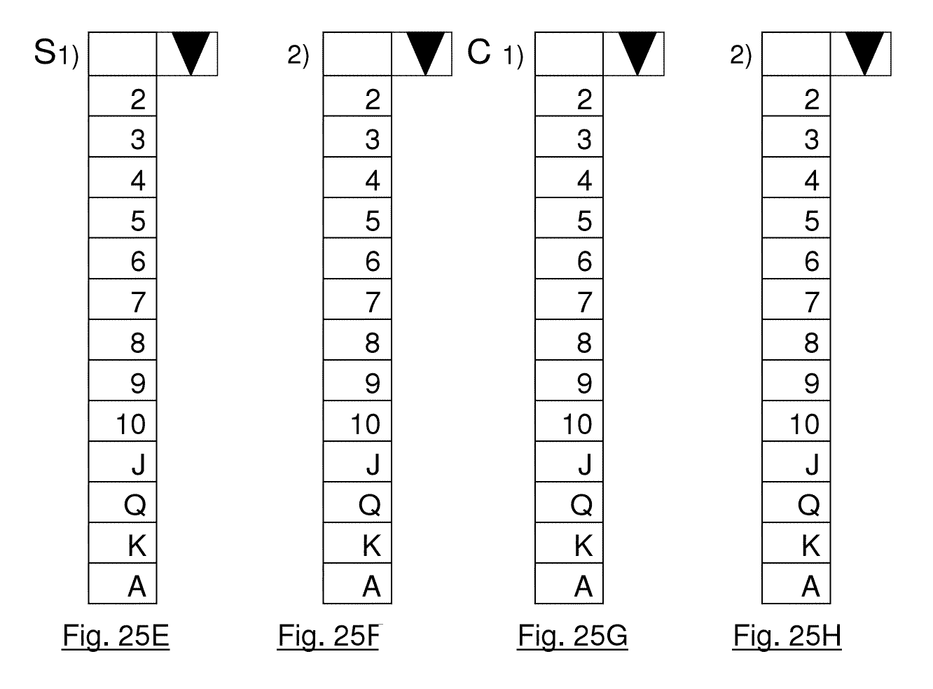

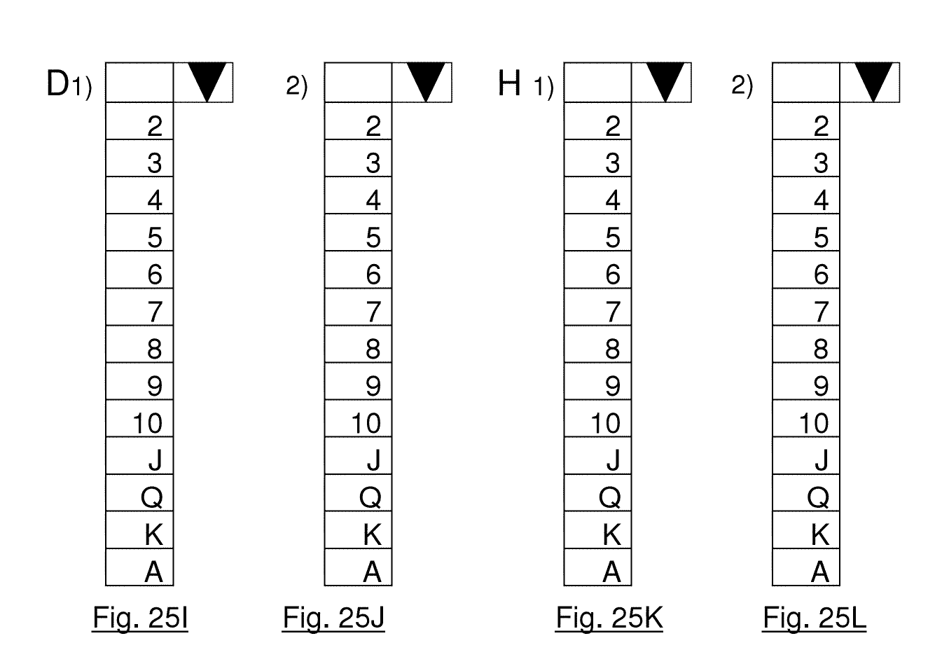

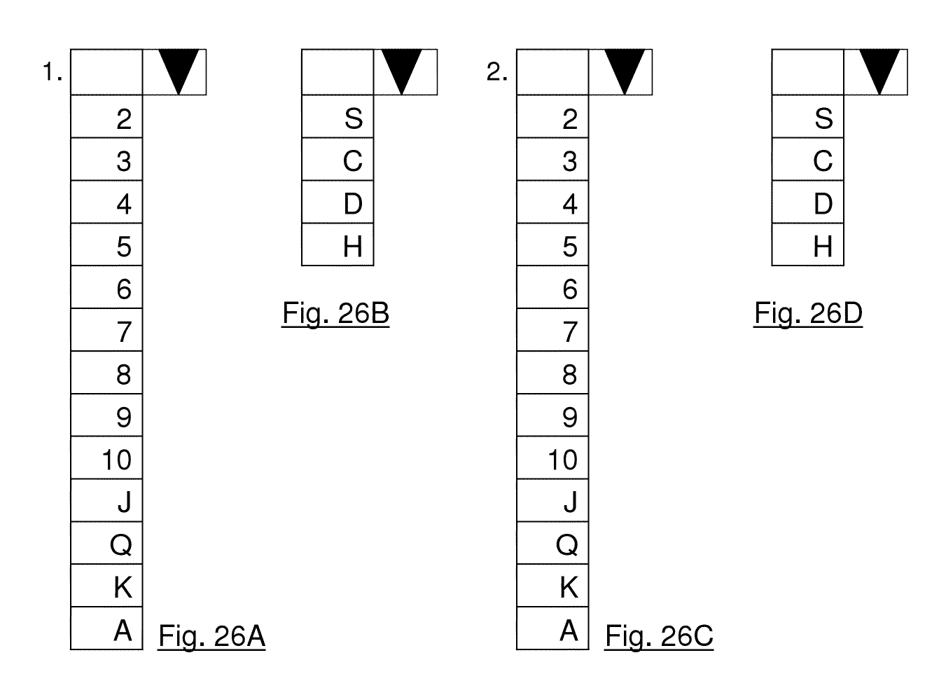

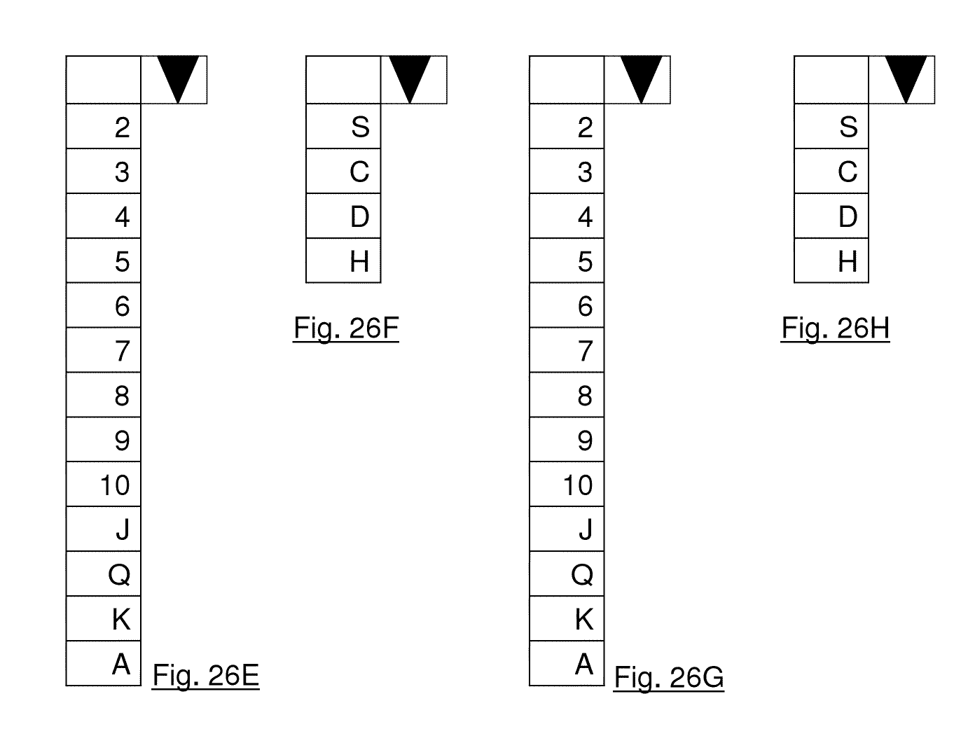

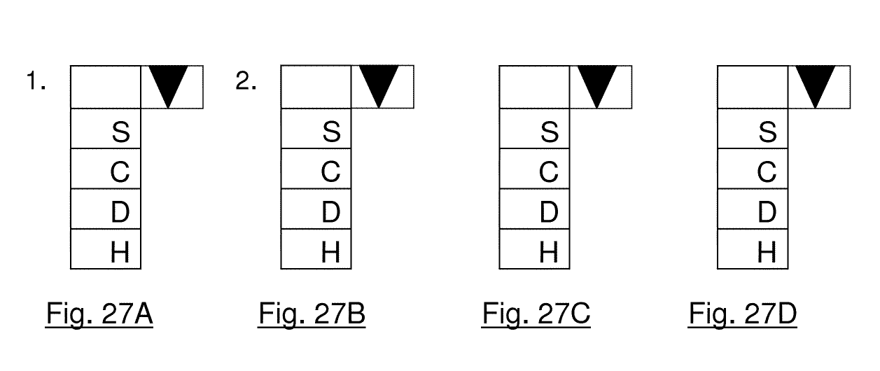

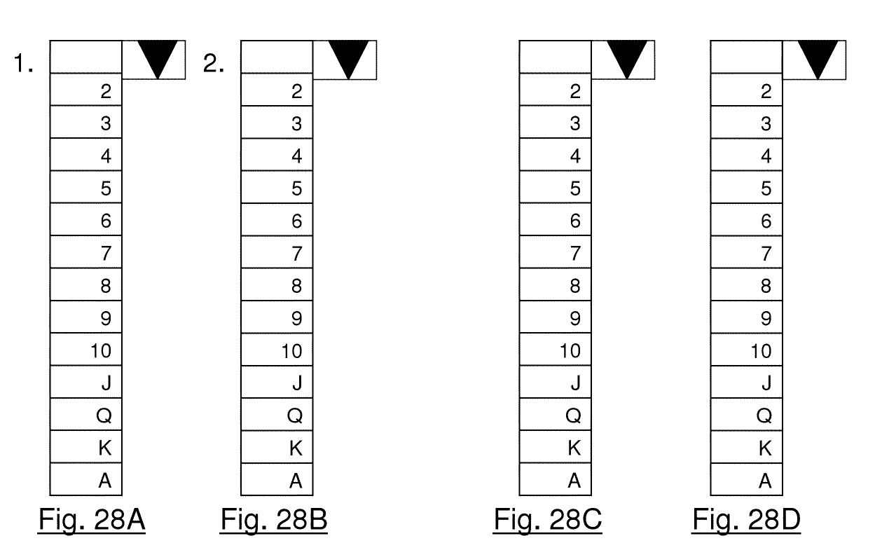

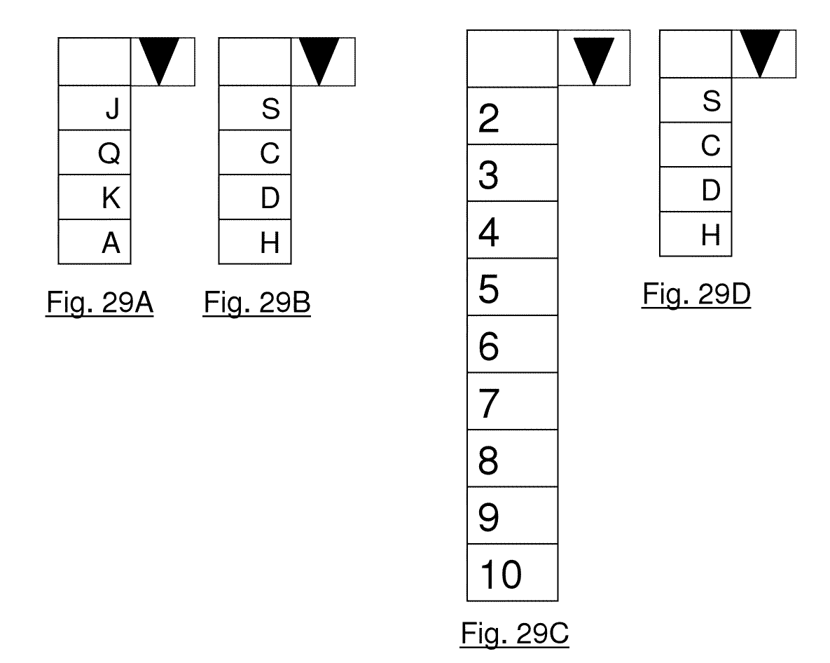

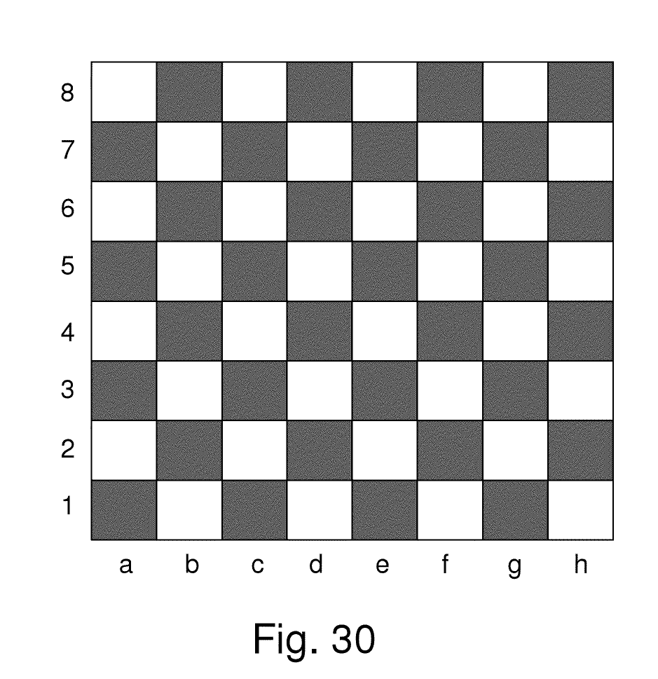

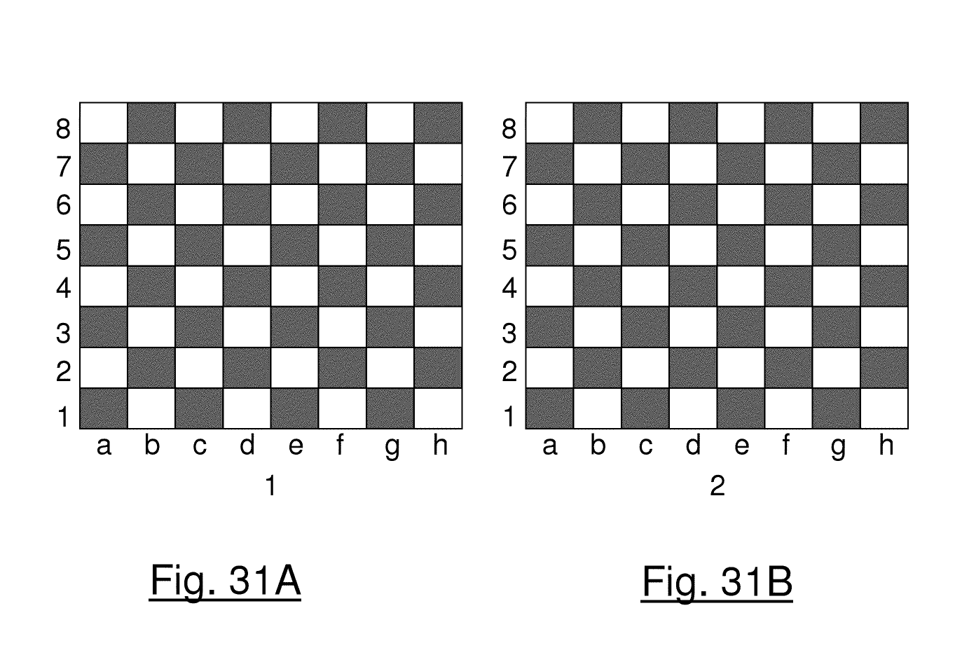

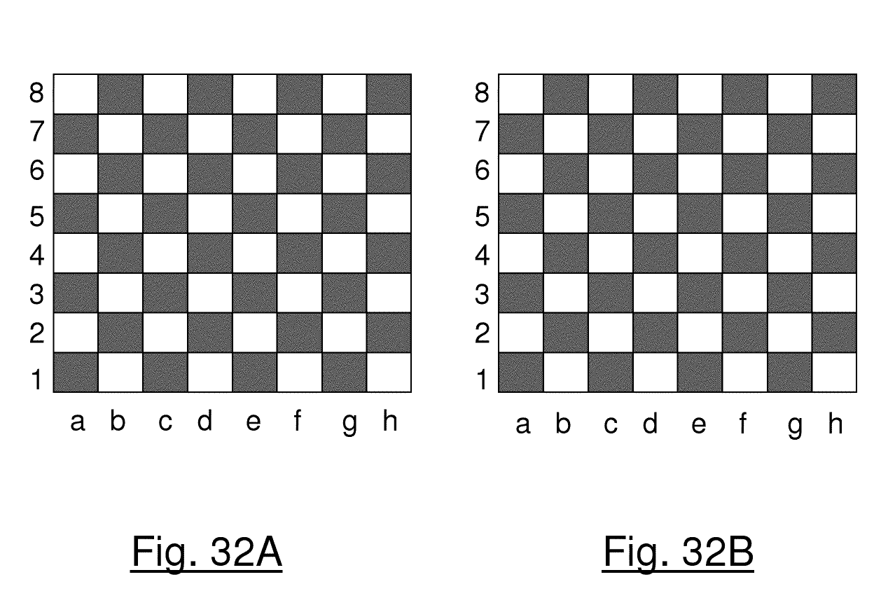

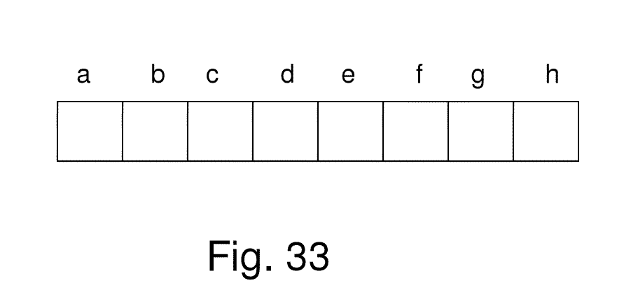

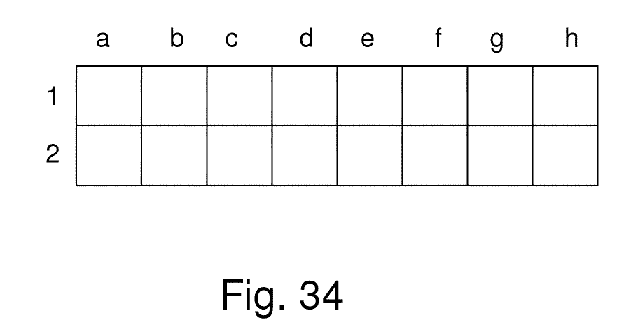

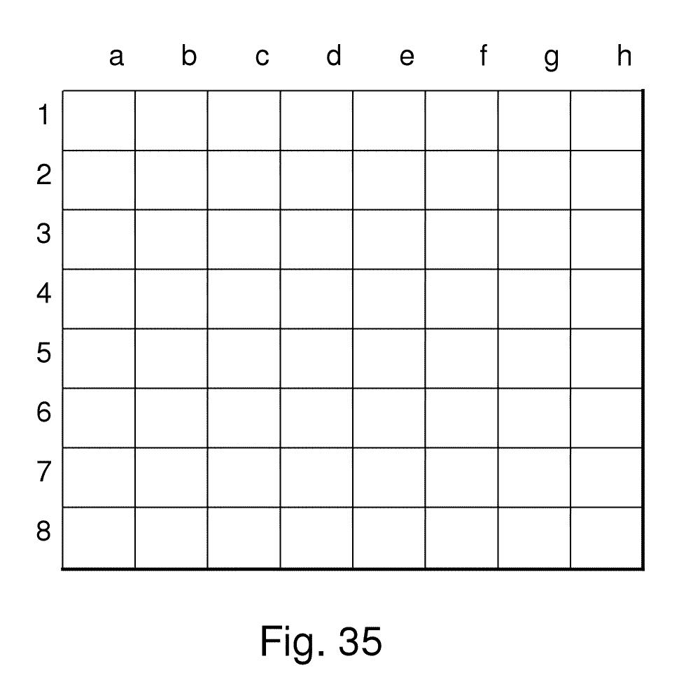

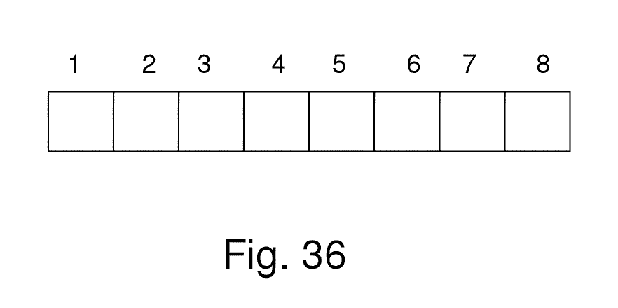

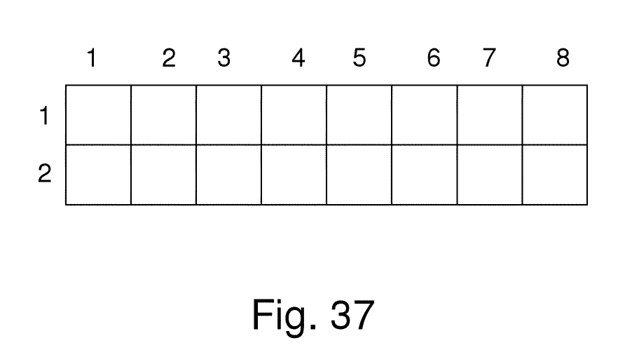

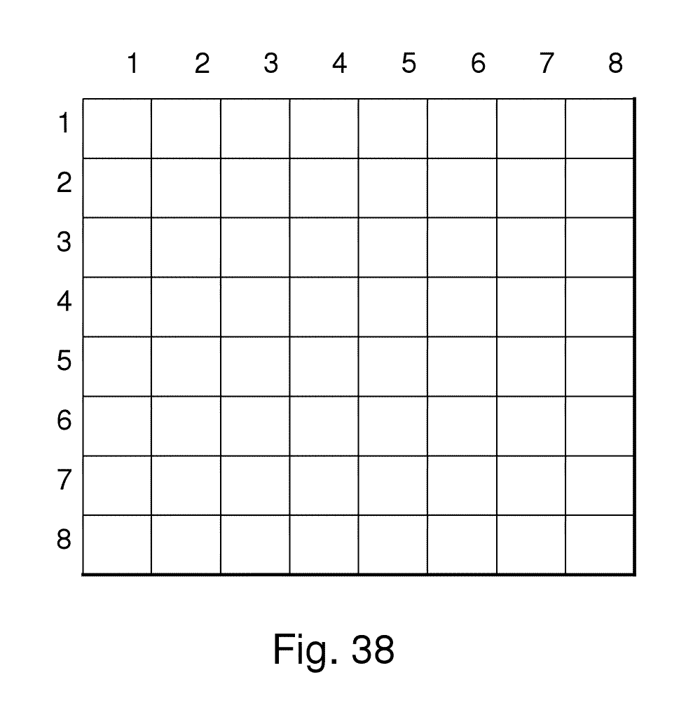

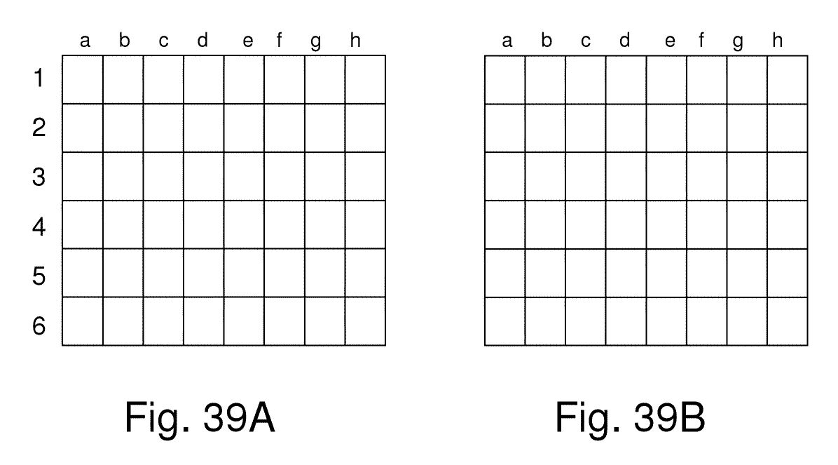

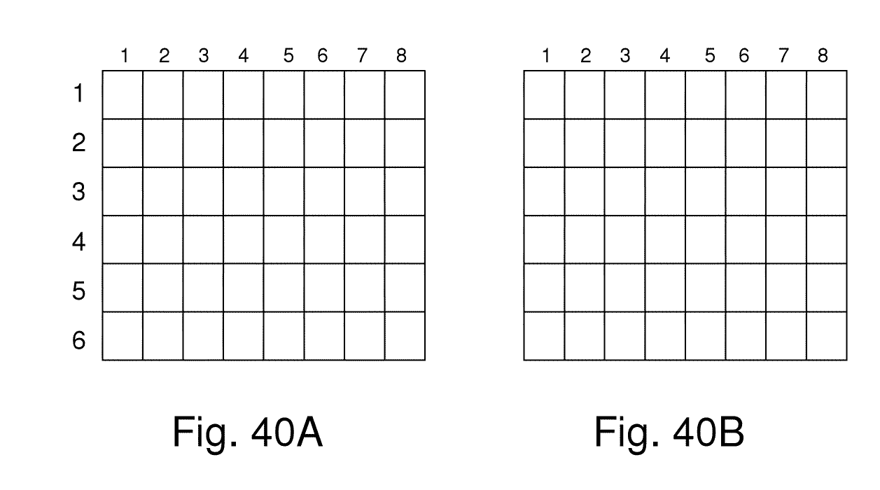

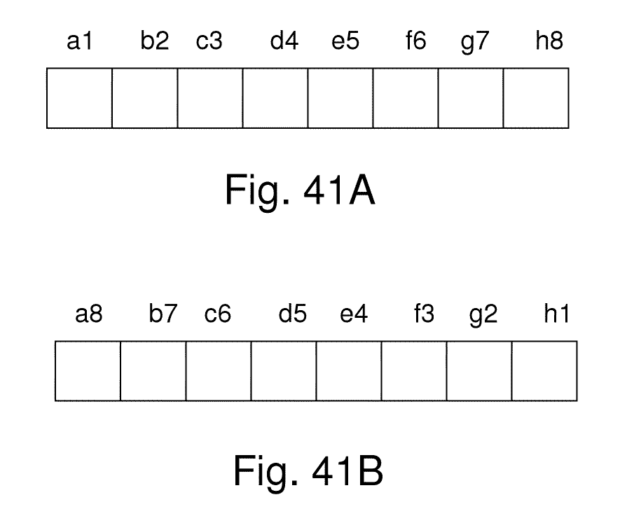

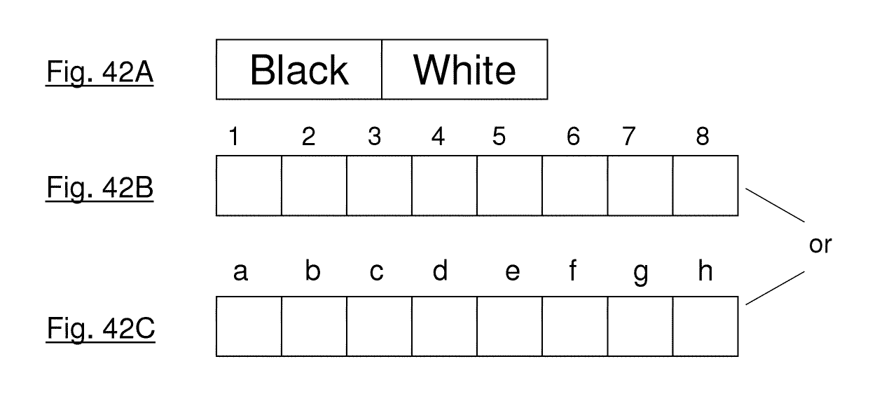

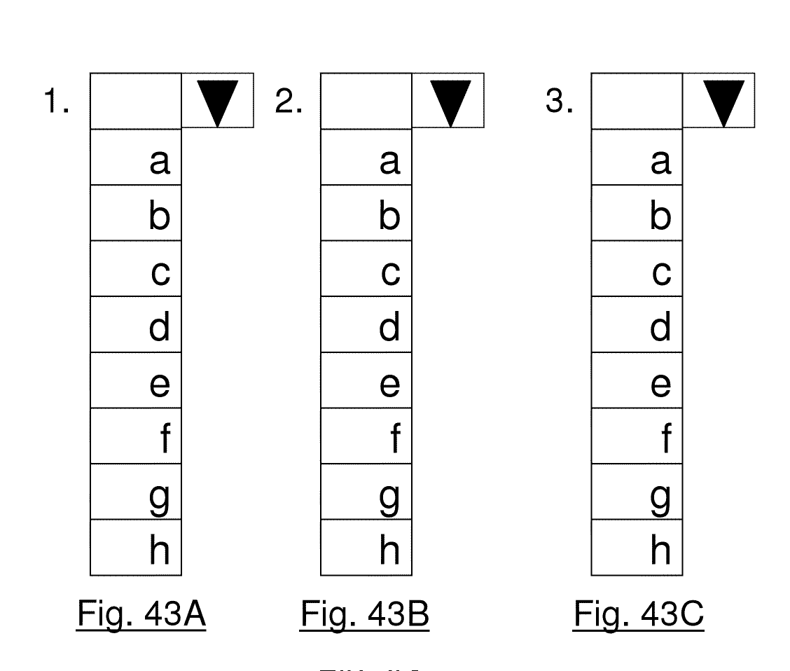

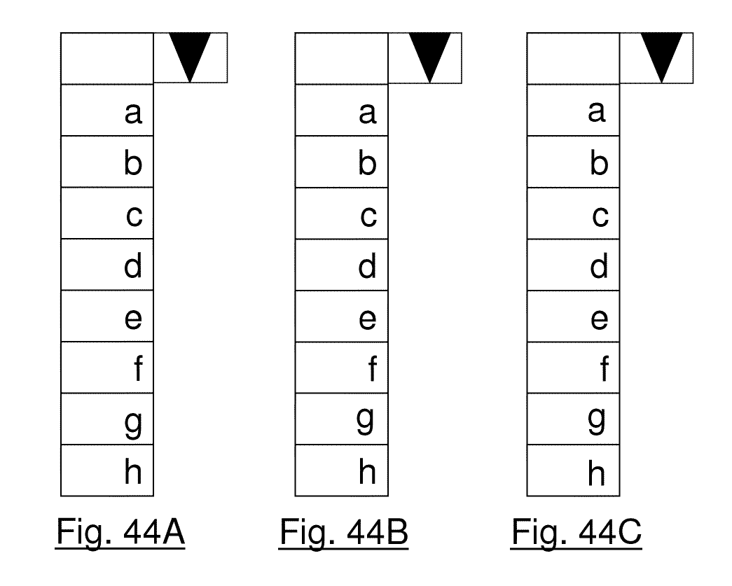

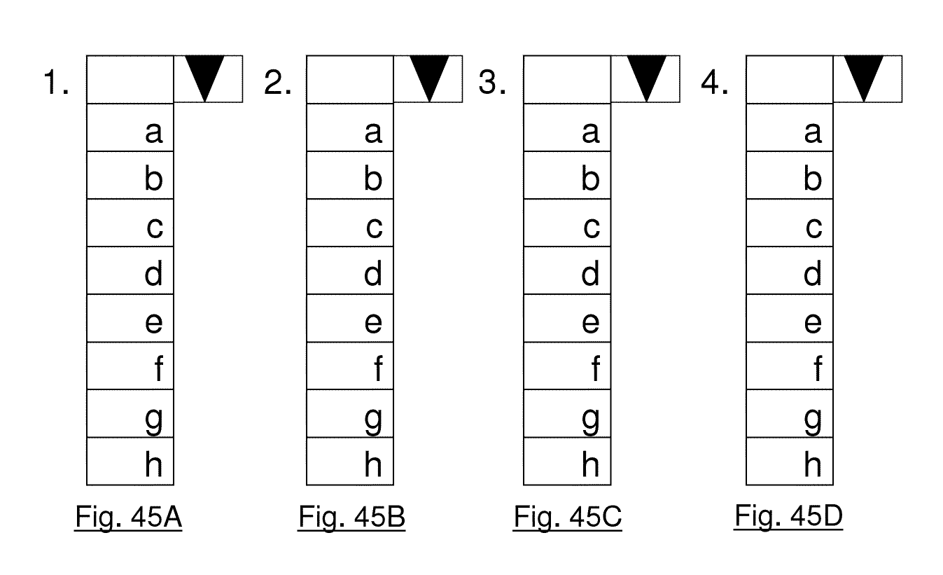

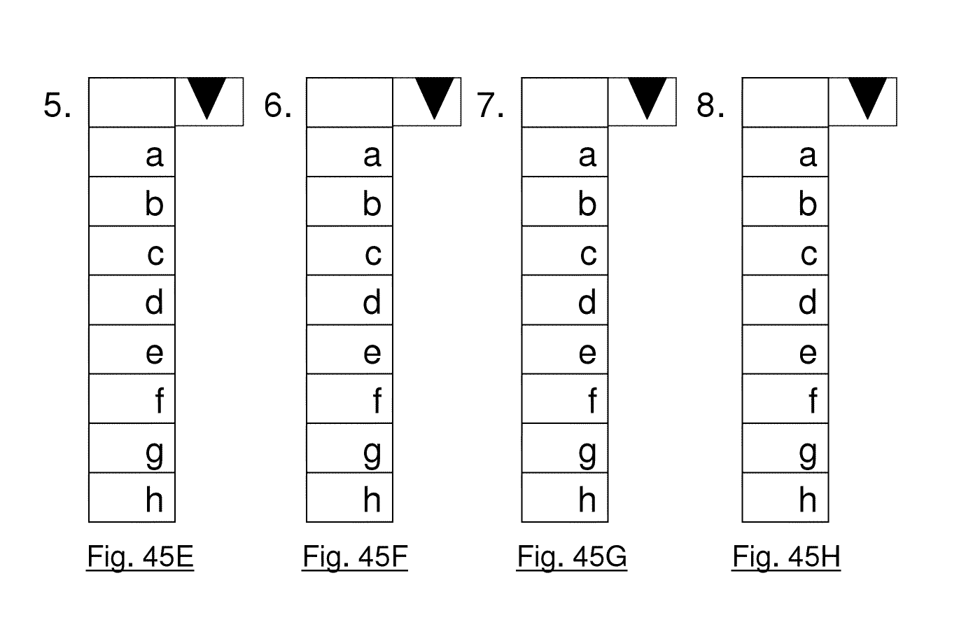

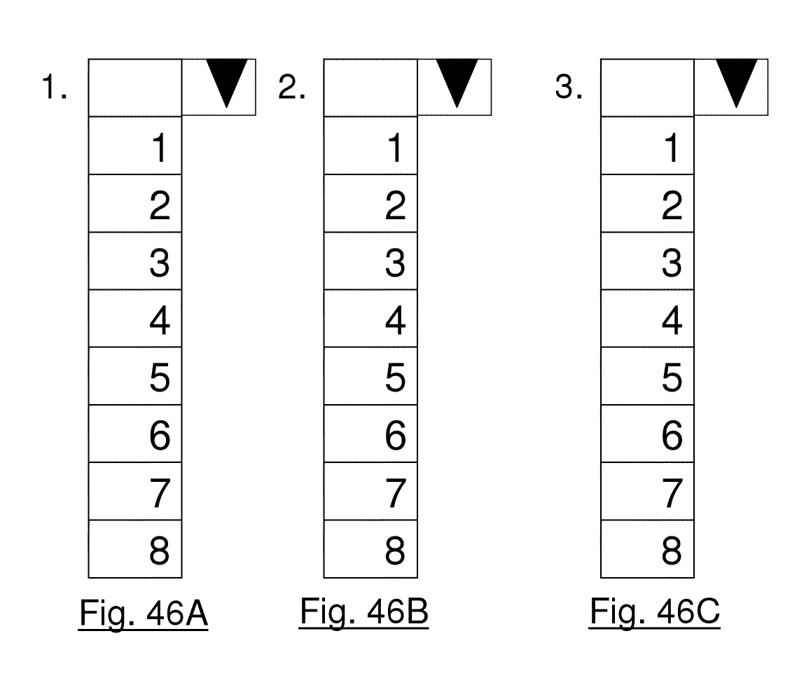

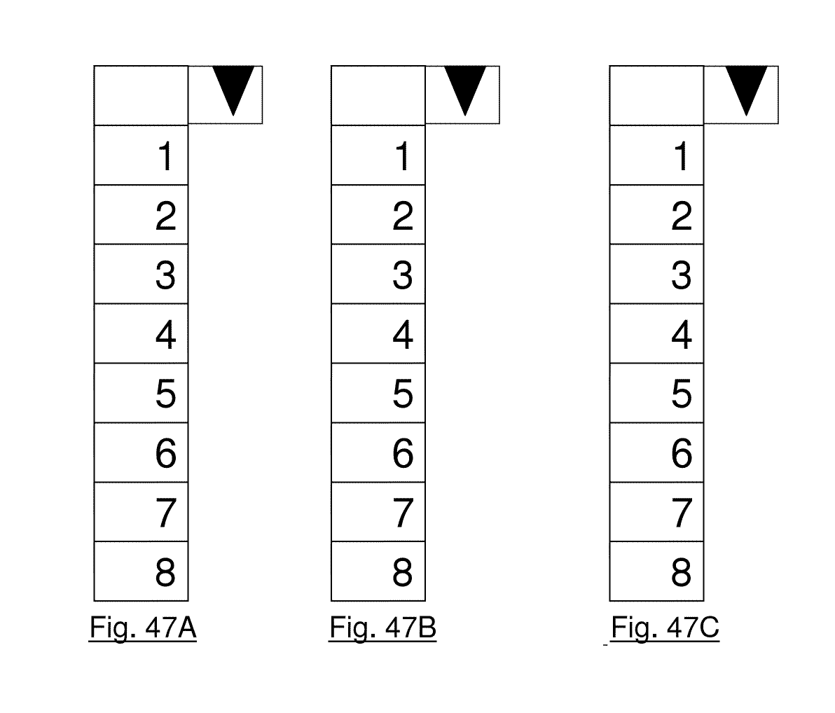

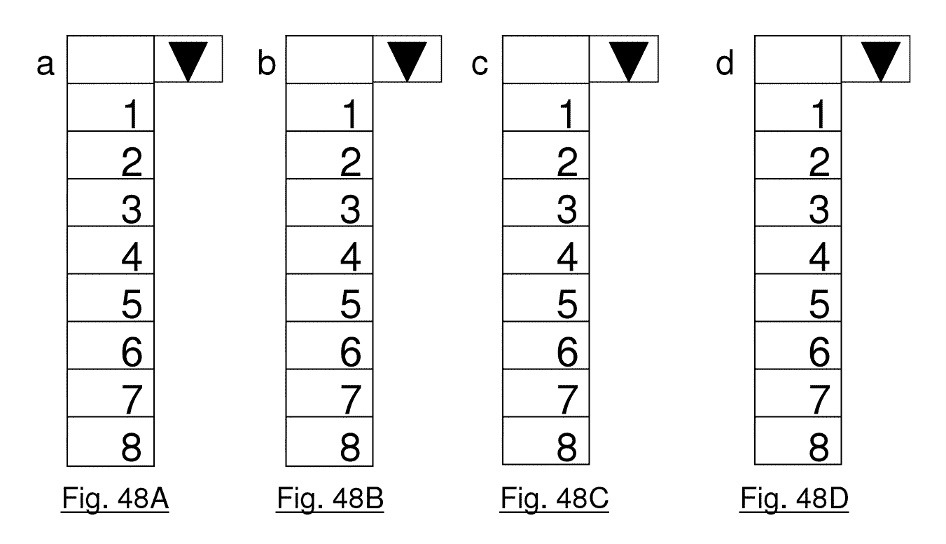

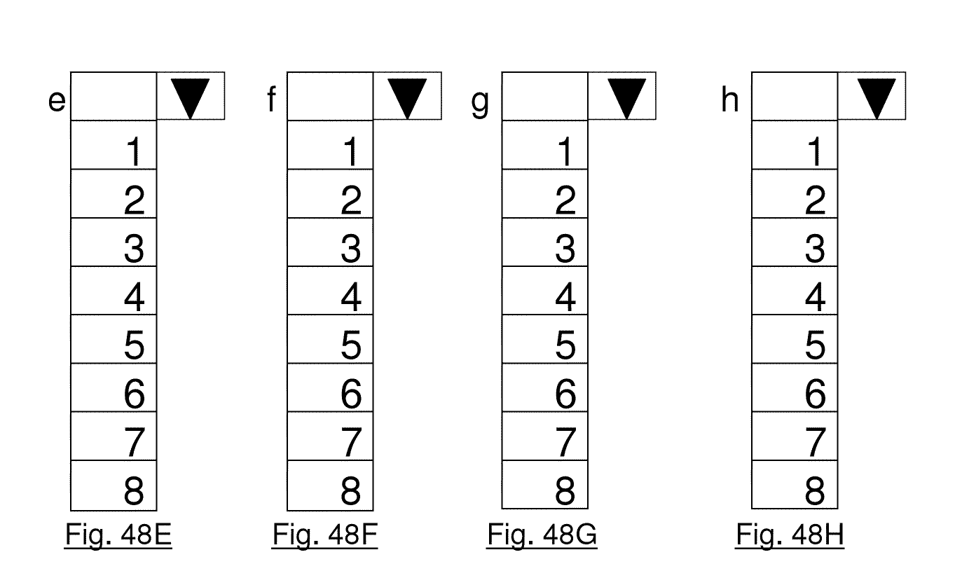

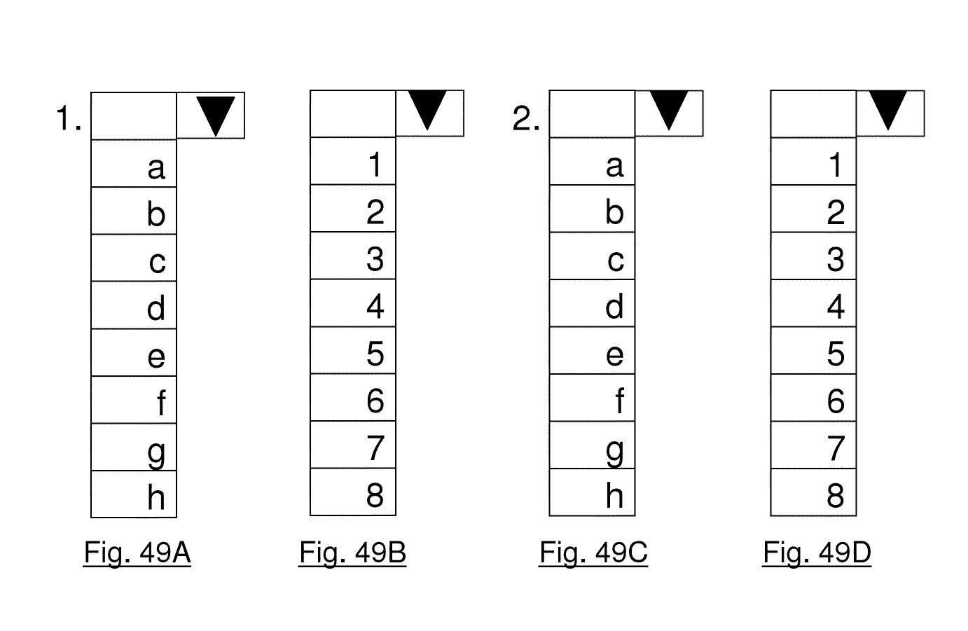

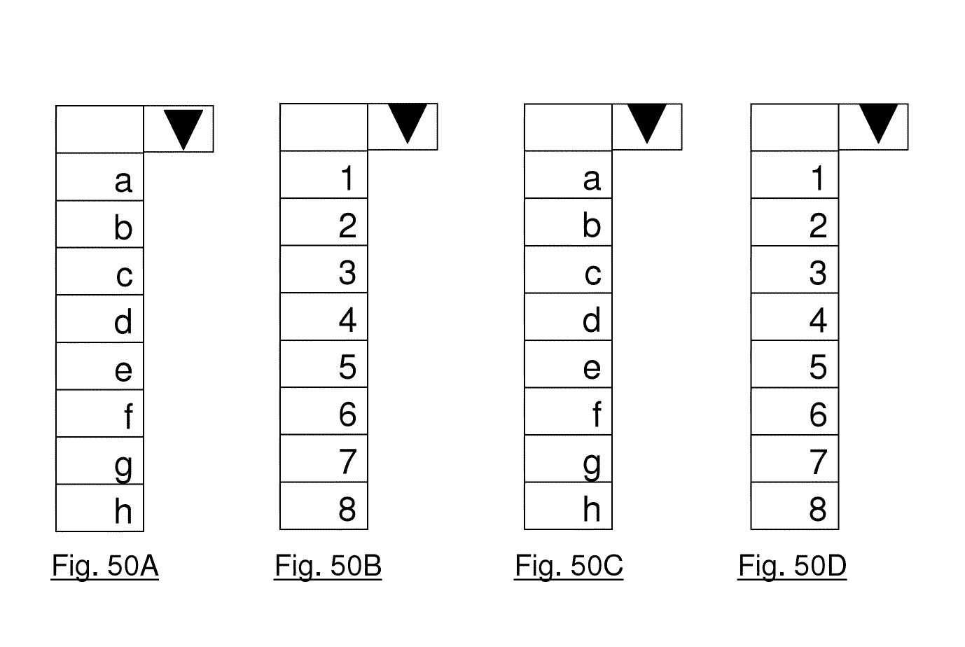

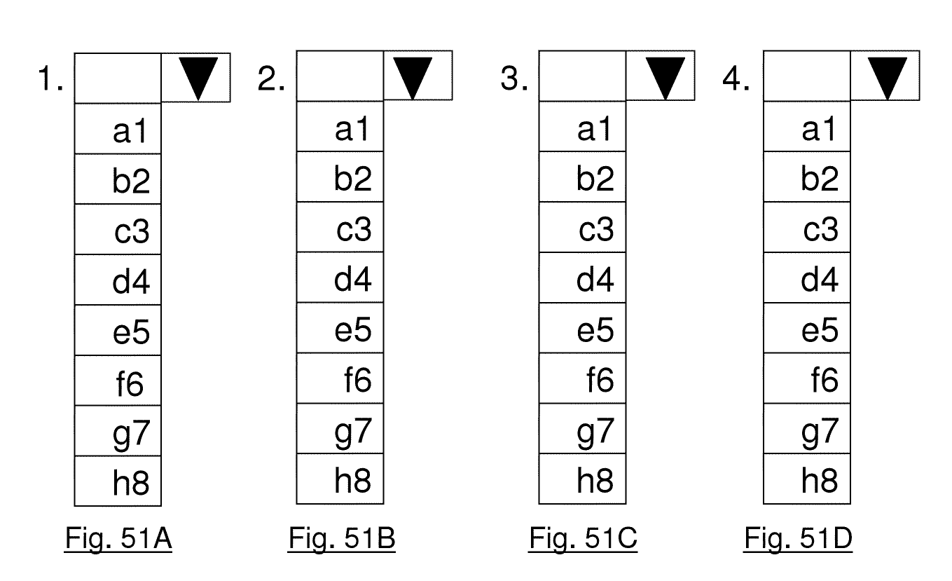

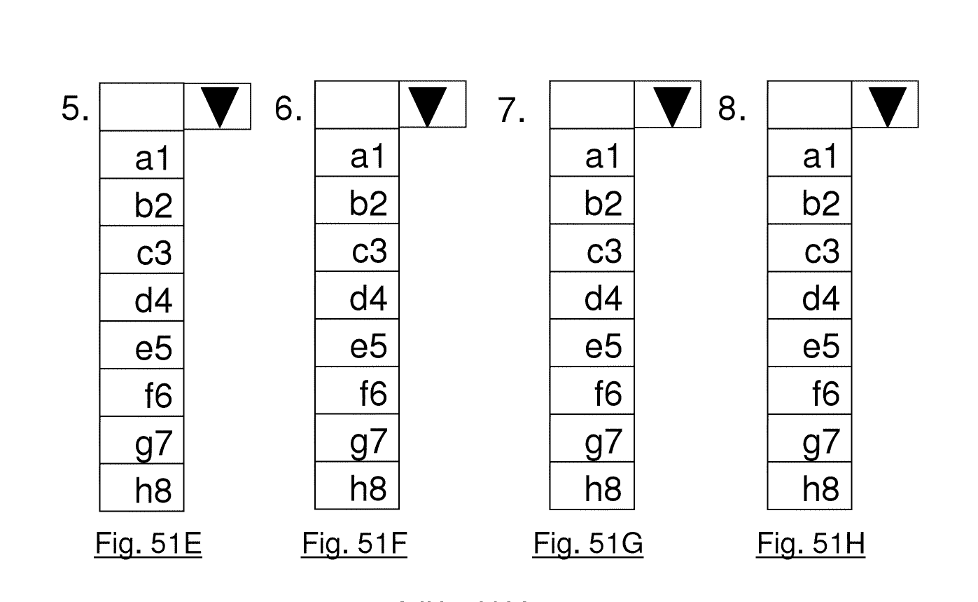

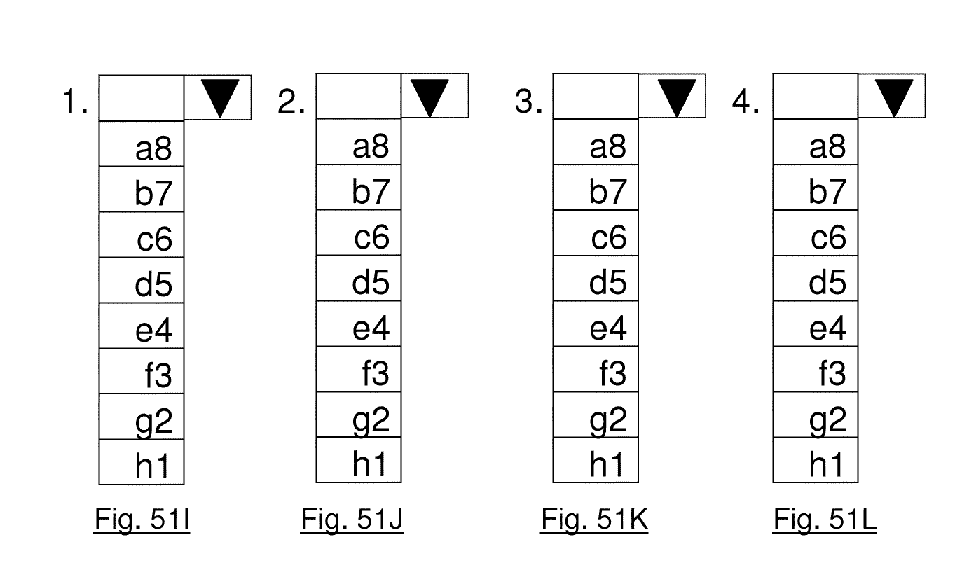

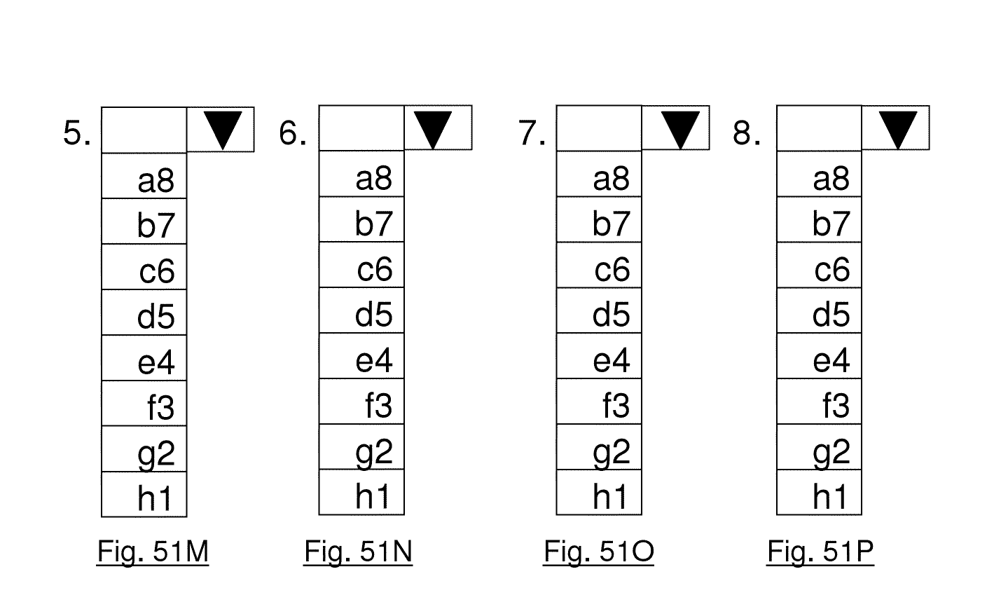

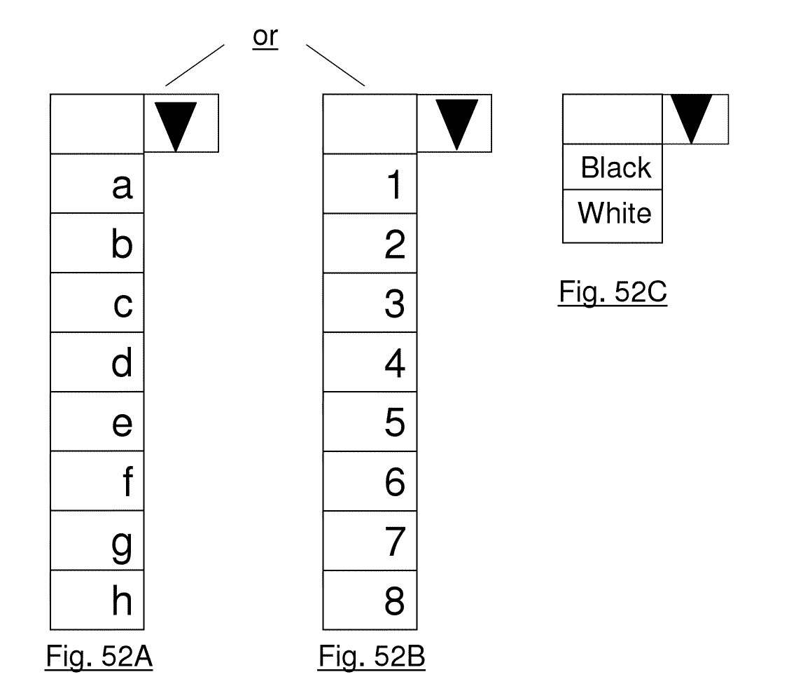

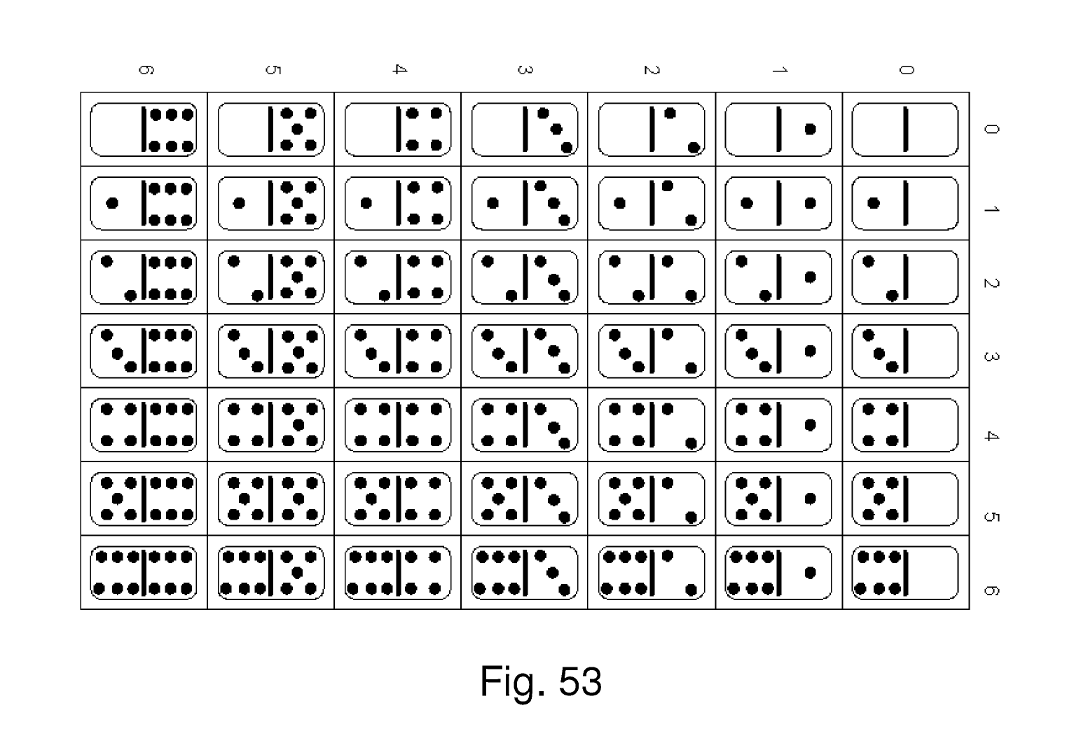

FIGS. 1, 5A, 5B, 6A, 6B, 7-9, 11, 12, 14, 15, 17A, 17B, 18, 19A, 19B, 20A, 20B and FIGS. 30, 31A, 31B, 32A, 32B and 33, 35, 36, 38, 39A, 39B, 40A, 40B, 41A, 41B, 42A-42C show tables associated with playing desk of a dealer;

FIGS. 1, 10-15, 16A-16D, 17A-17C, 19A, 19B, 20A, 20B and FIGS. 30, 33, 34, 36, 37, 39A, 39B, 40A, 40B, 41A, 41B, 42A-42C show tables associated with playing desk of a player;

FIGS. 1, 5A, 5B, 6A, 6B, 11, 17B, 17C, 18, 20A, 20B and FIGS. 30, 31A, 31B, 32A, 32B and 33, 35, 36, 38, 39A, 39B, 40A, 40B, 41A, 41B, 42A-42C, show tables used in lottery tickets;

FIGS. 21A-21P, 22A-22M, 23A-23D, 23E-23H, 24A-24C, 24D-24F, 25A-25L, 26A-26D, 26E-26H, 27A, 27B, 27C, 27D, 28A, 28B, 28C, 28D, 29A-29D and FIGS. 43A-43C, 44, 44A-44C, 45A-45D, 45E-45H, 46A-46C, 47A-47C, 48A-48D, 48E-48H, 49A-49D, 50A-50D, 51A-51D, 51A-51P, 52A-52C show combo boxes used in a computer version of the method.

### DETAILED DESCRIPTION OF PREFERRED EMBODIMENTS

The present invention discloses a method for playing lotto games based on bets on combinations and sequences of cards. Said method can be implemented with the help of a large number of games, such as one based on deck of playing cards or chess board. The description of the present invention and its related embodiments is given while based on examples of implementation of said method with a deck of 52 playing cards (FIG. 1) and chess board (FIG. 30).

Said method is based on allowing gamblers to choose combinations, combinations with repetitions, variations, variations with repetitions or permutations of cards according to their capacities to bet and to their goals to earn money.

According to an embodiment of the present invention, the method for playing lotto games can be implemented in a casino, for an entertainment television program or on a computer.

According to another embodiment of the present invention, the method of said invention can be played on television as lottery or daily game, according to the number of participants.

According to one another embodiment of the present invention, to implement the method of the present invention, each player needs a playing desk with tables (shown in FIGS. 1, 10-15, 16A-16D, 17A-17C, 19A, 19B, 20A, 20B or FIGS. 30, 33-38, 39A, 39B, 40A, 40B, 41A, 41B, 42A-42C) and tokens to make various bets.

According to one another embodiment of the present invention, in the implementation of the method disclosed in the present invention as a television version, making bets can be also done by means of a program through the Internet or by filling in regular lottery tickets with the tables like those used in the casino version of said method.

According to yet an embodiment of the present invention, numbered tables having 52 spaces according to the number of cards in a standard deck of playing cards, arranged in four rows according to suits and 13 columns according to values of cards can be used in said lottery tickets to make bets on sequences of single cards, with or without repetitions. A number of a table shows an ordinal number of a single card in a sequence. Said numbered tables can be used by a dealer or lottery operator to write down random sequences of single cards being created in a course of both games constituting the presented method, putting tokens without numbers or cards from auxiliary decks of playing cards, or marking appropriate spaces of said tables. Tables without numbers can be used in said lottery tickets to make bets on combinations or combinations with repetitions of single cards. One table is needed for each combination or for each single card in combination with repetitions.

In the game's implementation with the help of a chess board, numbered and non-numbered tables having 64 spaces, identical with a chess board can be used in said lottery tickets similarly, to make bets on variations and combinations of single squares of a chess board with or without repetitions.

According to still an embodiment of the present invention, more than one variant can be submitted for such kinds of bets where appropriate. Different stakes can be done on the same kinds of bets.

According to a further embodiment of the present invention, after finishing the games implementing the method of the present invention, a dealer or program checks the results of bets and calculates the losses and wins of each participant for each kind of bets, a total of each game and aggregate of all games for each participant (all games in which the participant took part).

According to a further embodiment of the present invention, the method can be implemented in order to automatically generate random sequences according to the set of predefined rules and to allow a player to make bets on said automatically generated random sequences.

According to yet a further embodiment of the present invention, a player can bet on the same sequence or combination for more than a draw.

According to still one another embodiment of the present invention, in the game constituting the first part of the presented method, the cards of the first kind of implementation of the present invention are picked out at random from a deck and put face up on their places in the table, filling in the rows and the columns and creating random sequences of cards of the same suit in each row and cards of the same value in each column. When cards of a particular suit are picked out in each value of cards, the suit is drawn out and all cards of this suit are placed face up. When cards of a particular value are picked out in each suit, the value of cards is drawn out and all cards of this value are placed face up. When all cards are placed face up the game is over. So, when single cards are picked out at random, cards of the same suit and cards of the same value are picked out in random sequences among them, respectively. The suits and the values of cards are also drawn out in random sequences among them, respectively. The arrangement of cards makes visual creation of said random sequences in the course of the game.

The same happens to the squares of a chess board, files and ranks.

According to yet an embodiment of the present invention, random sequences allowing repetitions of values of cards and suits are created as derivatives of random sequences of cards of the same suit and cards of the same value respectively. When all cards have been picked out and random sequences of cards of the same suit and cards of the same value have been created, said random sequences can be considered as separately created, i.e. as if cards were picked out from each suit and from each value of cards separately. Then the first cards of every suit and additional cards picked out under the same ordinal numbers in each suit, and the first cards of every value of cards and additional cards picked out under the same ordinal numbers in each value of cards constitute variations with repetitions of values of cards and suits respectively. Said cards constitute combinations with repetitions of values of cards and suits respectively, if an order of cards, i.e. from which suit or value of cards each card was picked out does not matter and only which cards were picked out is important.

For example, the first cards of every suit constitute variation with repetitions of values of cards, the first cards of every value of cards constitute variation with repetitions of suits. The first two cards of every suit constitute variation with repetitions of combinations of values of cards, the first and the second cards of every suit constitute variation with repetitions of variations of values of cards. Said first cards of every suit constitute combination with repetitions of values of cards if an order of cards, i.e. from which suit each card was picked out does not matter and only which values of cards were picked out is important. Similarly, said first cards of every value of cards constitute combination with repetitions of suits.

According to one another embodiment of the present invention, the game constituting the second part of the presented method allows repetitions of previously selected betting elements and creates random sequences containing variations with repetitions and combinations with repetitions of cards, suits and values of cards or squares of a chess board, files and ranks.

According to still another embodiment of the present invention, said two games together constitute the method for playing lotto games creating many random sequences of betting elements, containing all types of combinatorial structures thereof: permutations, variations, combinations (game 1), variations with repetitions and combinations with repetitions (game 2) and providing various possibilities for betting with a wide range of probabilities to win, based on said types of combinatorial structures.

According to yet an embodiment of the present invention, random sequences containing variations with repetitions and combinations with repetitions of sub-elements are created as derivatives of random sequences of single betting elements which belong to the same sub-element, being created in the course of the game constituting the first part of the presented method.

According to a further embodiment of the present invention, both games use the same arrangement of playing cards to make visual creation of said random sequences, containing said types of combinatorial structures in the course of the games.

According to yet a further embodiment of the present invention, both games can be implemented with the help of other table games or their parts, such as chess or checkers board, international draughts board, dominos, numbers or letters of the alphabet of different colours, pictures of different colours or symbols relating to any types of betting elements, comprising single betting elements and sub-elements of at least two kinds, forming said single betting elements.

According to yet an embodiment of the present invention, both games can be implemented with the help of numbers or letters of the alphabet having additional features to meet the requirements to betting elements, according to the definition of said betting elements, said numbers or letters can be of different colours and each colour group comprises the same numbers or letters.

### Method's Implementation Using a Deck of 52 Playing Cards: Rules of the Game

As the first example, the method disclosed in the present invention can be used with a classical deck of 52 playing cards. Said deck is associated with a playing desk of a dealer, having a table with 52 spaces according to the number of cards in a standard deck of playing cards, arranged in four rows according to suits (Spade (S), Club (C), Diamond (D), and Heart (H)) and 13 columns according to values of cards (2, 3, 4, 5, 6, 7, 8, 9, 10, Jack (J), Queen (Q), King (K), and Ace (A)), according to FIG. 1.

According to an embodiment of the present invention, said playing desk with tables having 52 spaces arranged in four rows according to suits and 13 columns according to values of cards and other tables, with tokens and auxiliary decks of playing cards is used by the dealer and his assistants to put face up cards picked out at random during the game and to write down the results of the game.

According to another embodiment of the present invention, in a casino implementation of the method, all players use playing desks with tables and tokens to make various bets.

According to still another embodiment of the present invention, 52 cards are drawn out of the deck at random one by one by a dealer and put face up on their spaces in the table. It can be done at random in the following way: the cards are shuffled thoroughly by the dealer and then drawn out one after another, consecutively from the upper side of the deck. When all cards are placed face up the game is over.

According to yet another embodiment of the present invention, when the method is implemented as a computer version of the game, 52 cards of a standard deck of playing cards are placed face down, arranged in four rows according to suits and 13 columns according to values of cards. All cards are numbered with numbers from 1 to 52, for example, according to suits: Spades are numbered from 1 to 13, Clubs are numbered from 14 to 26, Diamonds are numbered from 27 to 39 and Hearts are numbered from 40 to 52.

According to yet a further embodiment of the present invention, when the method is implemented as a computer version, the program is based on a random numbers generator that has been already invented. When the random numbers generator generates some random number within the range of numbers from 1 to 52, the card with the same number is picked out.

According to another embodiment of the present invention, the cards are drawn out randomly and put face up on their places. When all cards are placed face up the game is over.

According to another embodiment of the present invention, the following results are written down during the game:
in which sequence cards of each suit are drawn out among them (sequence of cards of the same suit);
in which sequence cards of each value are drawn out among them (sequence of cards of the same value);
in which sequence the suits are drawn out (the suit is drawn out when all cards of the same suit are placed face up);
in which sequence the values of cards are drawn out (the value of cards is drawn out when all cards of the same value are placed face up);
in which sequence the values of picture cards are drawn out among them (picture cards—J, Q, K, A);
in which sequence the values of non-picture cards are drawn out among them (non-picture cards—2, 3, 4, 5, 6, 7, 8, 9, 10);
which single cards are drawn out: the first, the second, the third, the fourth, the fifth, the sixth and the last;

According to an embodiment of the present invention, numbered tables having 52 spaces according to the number of cards in a standard deck of playing cards, arranged in four rows according to suits and 13 columns according to values of cards can be used to write down variations of single cards. A number of a table shows an ordinal number of a single card in a variation. Tables without numbers can be used to write down combinations of single cards. One table is needed for each combination or for each single card in a variation.

According to yet an embodiment of the present invention, auxiliary decks of playing cards can be used with said numbered and non-numbered tables having 52 spaces arranged in four rows according to suits and 13 columns according to values of cards to write down variations and combinations of single cards respectively.

According to another embodiment of the present invention, auxiliary deck of 52 playing cards can be used with table having 52 numbered spaces according to the number of cards in a standard deck of playing cards to write down random sequence of 52 cards forming the result of the game.

According to a further embodiment of the present invention, tables having equal numbers of columns or rows representing values of cards and numbered rows or columns respectively and tables having equal numbers of rows or columns representing suits and numbered columns or rows respectively can be used to write down random sequences forming the results of the game.

According to still a further embodiment of the present invention, auxiliary decks of playing cards can be used with tables having one row and numbered columns and tables having one column and numbered rows to write down random sequences of cards of the same suit and cards of the same value respectively.

According to yet a further embodiment of the present invention, said auxiliary decks of playing cards can be used with tables having 52 spaces arranged in four rows according to suits and 13 columns according to values of cards to write down said random sequences being created in the course of the game. More particularly, said tables with rows representing suits and numbered columns can be used with auxiliary decks of playing cards to write down random sequences of cards of the same suit, said tables with columns representing values of cards and numbered rows can be used with auxiliary decks of playing cards to write down random sequences of cards of the same value.

According to another embodiment of the present invention, when the method is implemented as a computerized version, 52 cards of a standard deck of playing cards are placed face up, arranged in four rows according to suits and 13 columns according to values of cards. All cards are numbered with numbers from 1 to 52, as mentioned above. When the random numbers generator generates some random number within the range of numbers from 1 to 52, a card with the same number is illuminated or otherwise highlighted. When all cards are illuminated the game is over.

### Method's Implementation Using a Deck of 52 Playing Cards: Rules of Bets

According to a further embodiment of the present invention, before the beginning of each game, participants can gamble on various chances. There are following possibilities.

According to still an embodiment of the present invention, one possibility of bets is based on choosing suits. In this case bets can be made on:
colour (black or red),
the first suit of four;
the first and the second suits of four (sequence of the first two suits);
the first two of four (combination of the first two suits);
a sequence of the four suits.

According to one another embodiment of the present invention, one possibility of bets is based on choosing values of picture cards. In this case bets can be made on:
the first value of picture cards of four;
the first and the second values of picture cards of four (sequence of the first two values of picture cards);
the first two values of picture cards of four (combination of the first two values of picture cards);
a sequence of the four values of picture cards.

According to an embodiment of the present invention, one possibility of bets is based on choosing values of non-picture cards. In this case bets can be made on:
the first value of non-picture cards of nine;
the first and the second values of non-picture cards of nine (sequence of the first two values of non-picture cards);
the first two values of non-picture cards of nine (combination of the first two values of non-picture cards);
the first, the second and the third values of non-picture cards of nine (sequence of the first three values of non-picture cards);
the first three values of non-picture cards of nine (combination of the first three values of non-picture cards); and so on
sequence of the nine values of non-picture cards.

According to yet a further embodiment of the present invention, one possibility of bets is based on choosing combinations of suits and values of picture cards. In this case bets can be made on:
the first of four suits and the first of four values of picture cards;
the first and the second suits and the first and the second values of picture cards (sequence of the first two suits and sequence of the first two values of picture cards);
the first two suits and the first two values of picture cards (combination of the first two suits and combination of the first two values of picture cards);
sequence of the four suits and sequence of the four values of picture cards.

According to another embodiment of the present invention, one possibility of bets is based on choosing values of cards. In this case bets can be made on:
the first value of 13;
the first and the last values of 13;
the first and the second values of 13 (sequence of the first two values of cards);
the first two values of 13 (combination of the first two values of cards);
the first, the second and the third values of 13 (sequence of the first three values of cards);
the first three values of 13 (combination of the first three values of cards); and so on
sequence of 13 values of cards.

According to one another embodiment of the present invention, one possibility of bets is based on choosing combination of picture cards and non-picture cards. In this context, bets can be made on a sequence of the four picture cards and sequence of the nine non-picture cards.

According to still a further embodiment of the present invention, one possibility of bets is based on choosing single cards. In said context bets can be made on:
the first card of 52;
the last card of 52;
the first and the second cards of 52 (sequence of the first two single cards);
the first two cards of 52 (combination of the first two single cards);
the first and the last cards of 52;
the first, the second and the third cards of 52 (sequence of the first three single cards);
the first three cards of 52 (combination of the first three single cards);
sequence of the first four single cards;
combination of the first four single cards;
sequence of the first five single cards;
combination of the first five single cards;
sequence of the first six single cards;
combination of the first six single cards; and so on . . .

According to still another embodiment of the present invention, one possibility of bets is based on choosing cards of the same suit. In this case bets can be made on:
the first card of 13;
the first and the second cards of the same suit of 13 (sequence of the first two cards of the same suit);
the first two cards of the same suit of 13 (combination of the first two cards of the same suit);
the first, the second and the third cards of the same suit of 13 (sequence of the first three cards of the same suit);
the first three cards of the same suit of 13 (combination of the first three cards of the same suit); and so on.
sequence of 13 cards of the same suit;

According to yet another embodiment of the present invention, one possibility of bets is based on choosing cards of different suits. In this case bets can be made on:
the first card of each red (black) suit (variation with repetitions of values of cards);
the first and the second cards of each red (black) suit (variation with repetitions of variations of two values of cards);
the first two cards of each red (black) suit (variation with repetitions of combinations of two values of cards);
the first, the second and the third cards of each red (black) suit (variation with repetitions of variations of three values of cards);
the first three cards of each red (black) suit (variation with repetitions of combinations of three values of cards); and so on . . .
the first card of each suit (variation with repetitions of values of cards);
the first and the second cards of each suit (variation with repetitions of variations of two values of cards);
the first two cards of each suit (variation with repetitions of combinations of two values of cards);
the first three cards of each suit (variation with repetitions of combinations of three values of cards); and so on . . .

According to another embodiment of the present invention, one possibility of bets is based on choosing cards of the same value. In this case bets can be made on:
the first card of four;
the first and the second cards of the same value of four (sequence of the first two cards of the same value);
the first two of four (combination of the first two cards of the same value).
sequence of four cards of the same value;

According to still another embodiment of the present invention, one possibility of bets is based on choosing cards of different values. In this case bets can be made on:
the first card of each value of picture cards (variation with repetitions of suits);
the first and the second cards of each value of picture cards (variation with repetitions of variations of two suits);
the first two cards of each value of picture cards (variation with repetitions of combinations of two suits);
sequence of four cards of each value of picture cards;
the first card of each value of non-picture cards (variation with repetitions of suits);
the first and the second cards of each value of non-picture cards (variation with repetitions of variations of two suits);
the first two cards of each value of non-picture cards (variation with repetitions of combinations of two suits); and so on . . .
the first card of each value of cards (variation with repetitions of suits);
the first two cards of each value of cards (variation with repetitions of combinations of two suits); and so on . . .

According to an embodiment of the present invention, in the casino implementation of the method to play, participants can submit their bets by putting tokens on appropriate spaces of the tables. Each table has numbered rows. A number of a row shows an ordinal number of a card or suit in a sequence. Tables having one row can be used to make bets on combinations of cards or suits. Said tables and tokens can be used by a dealer to write down the results of the game.

As few examples, FIGS. 10 to 12 show tables, used for suits, wherein:
FIG. 10, to make bets on the first and the second of four (sequence of the first two suits);
FIG. 11, to make bets on the first two of four (combination of the first two suits);
FIG. 12, to make bets on sequence of the four suits.

As few examples, FIGS. 13 to 15 show tables, used for pictures cards, wherein:
FIG. 13, to make bets on the first and the second of four (sequence of the first two picture cards);
FIG. 14, to make bets on the first two of four (combination of the first two picture cards);
FIG. 15, to make bets on a sequence of the four picture cards.

According to still another embodiment of the present invention, there is another way to make bets in casinos, using two kinds of tokens: with numbers and without numbers. A number of a token shows an ordinal number of a card or suit in a sequence. Each table has only one row. Tokens without numbers can be used to make bets on combinations of cards or suits. Said tokens and tables can be used by the dealer to write down the results of the game.

As an example, FIG. 14 shows a table which can be used for picture cards, to make bets on:
a sequence of the first two picture cards (tokens with numbers);
a combination of the first two picture cards (tokens without numbers);
a sequence of the four picture cards (tokens with numbers).

As an example, FIG. 17A shows a table, which can be used for non-picture cards, to make bets on:
the first and the second of nine (sequence of the first two non-picture cards). Tokens with numbers;
The first two of nine (combination of the first two non-picture cards). Tokens without numbers.

As another example, FIG. 17B shows a table, which can be used in order to make bets on a sequence of the first two values of cards (tokens with numbers); or to make bets on a combination of the first two values of cards (tokens without numbers). Said table can be used for writing down a sequence of 13 values of cards.

As yet another example, FIG. 17C shows a table, allowing making bets on a sequence of the first two values of cards (regular tokens without numbers).

According to another embodiment of the present invention, tables having one row can be used by players in lottery tickets to make bets on variations with repetitions of combinations of the first card of each suit and additional cards picked out under the same ordinal numbers in each suit, tables having one column can be used to make bets on variations with repetitions of the first card of each value of cards, tables having numbered rows can be used in said lottery tickets to make bets on variations with repetitions of variations of the first card of each suit and additional cards picked out under the same ordinal numbers in each suit and on permutations of values of cards.

According to yet another embodiment of the present invention, tables with equal number of rows or columns representing suits and numbered columns or rows respectively and tables with equal number of columns or rows representing values of cards and numbered rows or columns respectively can be used by a player to make bet on one or more permutations of suits and values of cards respectively.

According to one another embodiment of the present invention, in the computer implementation of the method, it can be done by means of a program.

According to another embodiment of the present invention, a computer implementation of the method can use said tables and other virtual tools comprising auxiliary decks of playing cards and tokens of two kinds—with numbers and without numbers or, as an example, combo-boxes fulfilling functions which are the same as those of said tables. Said combo boxes can be used by the program to write down the results of the game and by players to make bets. Numbered combo boxes can be used to make bets on sequences of cards or suits, a number of a combo-box shows an ordinal number of a card or a suit in a sequence. Combo-boxes without numbers can be used to make bets on combinations of cards or suits. FIGS. 21A-21D, 21E-21H, 21I-21L and 21M-21P show examples of combo boxes, which can be used for a sequence of four cards of each picture card.

FIGS. 22A-22G and 22H-22M show examples of combo boxes, which can be used for the first card of each value. FIGS. 23A-23D and FIGS. 23E-23H show examples of combo boxes, which can be used for sequences of the four picture cards and four suits, respectively. FIGS. 24A-24C schematically show a set of combo-boxes, which can be used by game participants in a computer version of the method to make bets on a sequence of the first three non-picture cards. FIGS. 24D-24F schematically show a set of combo-boxes, which can be used by game participants in a computer version of the method to make bets on a combination of the first three non-picture cards. FIGS. 25A-25D, 25E-25H and 25I-25L schematically show a few sets of combo-boxes, which can be used by game participants in a computer version of the method to make bets. More particularly, set of combo-boxes of FIGS. 25A-25D allow making bets on the first card of each suit and set of combo-boxes of FIGS. 25E-25L allow making bets on a sequence of the first two cards of each suit.

FIGS. 26A-26D and 26E-26H schematically show examples of sets of combo-boxes, which can be used by game participants in a computer version of the method to make bets. More particularly, set of combo-boxes of FIGS. 26A-26D allow making bets on a sequence of the first two single cards and set of combo-boxes of FIGS. 26E-26H allow making bets on a combination of the first two single cards.

### Method's Implementation Using a Deck of 64 Square Cards: Rules of the Game

As the second example, the method disclosed in the present invention can be implemented with a deck of 64 square cards matching 64 squares of a chess board. FIG. 30 shows an example of implementation of the method using chess board.

According to an embodiment of the present invention, each card is of the same color, as an example, black or white, as the matching square of a chess board, and the mark of the square is written on the card. The rear sides of all cards are the same, as in a standard deck of playing cards.

According to still another embodiment of the present invention, the method can use said deck of 64 square cards matching 64 squares of a chess board and a playing desk of a dealer with tables similar to a chess board and other tables drawn on it, with tokens and auxiliary decks of 64 square cards, for putting face up said 64 square cards picked out at random during the game and for writing down the results of the game.

According to a further embodiment of the present invention, an implementation of the method can use playing desk of a player with tables and tokens to make various bets.

According to yet a further embodiment of the present invention, 64 square cards are drawn out of the deck at random one by one by a dealer and put face up on their squares of the chess board. It can be done at random in the following way: the cards are shuffled thoroughly by the dealer and then drawn one after another, consecutively from the upper side of the deck.

According to still a further embodiment of the present invention, and as disclosed in the first example of implementation, when all cards are placed face up the game is over.

According to another embodiment of the present invention, when the method is implemented as a computer version, 64 squares of a chess board are picked out at random by a program. When the square is picked out its mark appears on the chess board. When all squares are marked the game is over.

According to still one another embodiment of the present invention, when the method is implemented as a computer version, said program is based on a random numbers generator that has been already invented. All squares of the chess board are numbered with numbers from 1 to 64, for example, by columns: “a” from 1 to 8, “b” from 9 to 16, “c” from 17 to 24, “d” from 25 to 32, “e” from 33 to 40, “f” from 41 to 48, “g” from 49 to 56, and “h” from 57 to 64.

According to another embodiment of the present invention, when the random numbers generator generates some random number within the range of numbers from 1 to 64, the square of the chess board with the same number is picked out.

According to yet another embodiment of the present invention, the following results are written down during the game:
in which sequence the squares of the same file are picked out;
in which sequence the squares of the same rank are picked out;
in which sequence the squares of the same diagonal are picked out;
which diagonal is picked out first: black (a1-h8) or white (a8-h1) (the diagonal is picked out when all squares of the same diagonal are marked);
in which sequence the files (also called columns) are picked out (the file is picked out when all squares of the same file are marked);
in which sequence the ranks are picked out (the rank is picked out when all squares of the same rank are marked);
which single squares are picked out: the first, the second, the third, the fourth, the fifth, the sixth and the last.

According to an embodiment of the present invention, numbered tables having 64 spaces, identical with a chess board can be used to write down variations of single squares of a chess board. A number of a table shows an ordinal number of a single square in a variation. Tables without numbers can be used to write down combinations of single squares. One table is needed for each combination or for each single square in a variation.

According to yet an embodiment of the present invention, auxiliary decks of 64 square cards matching 64 squares of a chess board can be used with said numbered and non-numbered tables having 64 spaces, identical with a chess board to write down variations and combinations of single squares of a chess board respectively.

According to another embodiment of the present invention, auxiliary deck of 64 square cards matching 64 squares of a chess board can be used with table having 64 numbered squares to write down random sequence of 64 squares of a chess board forming the result of the game.

According to a further embodiment of the present invention, tables having equal numbers of columns representing files of a chess board and numbered rows and equal numbers of rows representing ranks of a chess board and numbered columns can be used to write down random sequences of files and ranks.

According to still a further embodiment of the present invention, said auxiliary decks of 64 square cards matching 64 squares of a chess board can be used with tables having one row and numbered columns and tables having one column and numbered rows to write down random sequences of squares of the same rank and squares of the same file.

According to an embodiment of the present invention, 64 squares of the chess board are picked out at random. When a square is picked out it is illuminated or otherwise highlighted and when all squares are illuminated the game is over.

### Method's Implementation Using a Deck of 64 Square Cards: Rules of Bets

According to a further embodiment of the present invention, and as previously disclosed in the first example, before the beginning of each game, participants can bet on various chances. There are following possibilities.

According to one another embodiment of the present invention, one possibility of bets is based on choosing squares of the same file (rank). In this case bets can be made on:
the first square of eight;
the first and the last squares of eight;
the first and the second squares of eight (sequence of the first two squares of the same file);
the first two squares of eight (combination of the first two squares of the same file);
the first, the second and the third squares of eight (sequence of the first three squares of the same file);
the first three squares of eight (combination of the first three squares of the same file); and so on . . .
sequence of eight squares of the same file;
similarly with squares of the same rank;

According to still another embodiment of the present invention, one possibility of bets is based on choosing squares of different files (ranks). In this case bets can be made on:
the first square of each file (variation with repetitions of ranks);
the first square of each rank (variation with repetitions of files);
the first square of each file (rank) and the first square of black (white) diagonal;
the first square of each file (rank) and the first square of each diagonal.

According to still an embodiment of the present invention, one possibility of bets is based on choosing squares of different diagonals. In this case bets can be made on:
the first square of each diagonal—black (a1-h8) and white (h1-a8);
the first and the last squares of each diagonal;
the first and the second squares of each diagonal (sequence of the first two squares of each diagonal);
the first two squares of each diagonal (combination of the first two squares of each diagonal);
the first, the second and the third squares of each diagonal (sequence of the first three squares of each diagonal);
the first three squares of each diagonal (combination of the first three squares of each diagonal); and so on
sequence of eight squares of each diagonal, such as squares of the black diagonal a1-h8 including a1, b2, c3, d4, e5, f6, g7, and h8 or squares of the white diagonal h1-a8 including h1, g2, f3, e4, d5, c6, b7, a8.

According to yet an embodiment of the present invention, one possibility of bets is based on choosing diagonals. In this case bets can be made on the first of two diagonals: a1-h8 (black) or a8-h1 (white).

According to an embodiment of the present invention, one possibility of bets is based on choosing columns. In this case bets can be made on:
the first of eight;
the first and the last of eight;
the first and the second of eight (sequence of the first two files);
the first two of eight (combination of the first two files);
the first, the second and the third of eight (sequence of the first three files);
the first three of eight (combination of the first three files); and so on
sequence of the eight files.

According to an embodiment of the present invention, one possibility of bets is based on choosing ranks. In this case bets can be made on:
the first of eight;
the first and the last of eight;
the first and the second of eight (sequence of the first two ranks);
the first two of eight (combination of the first two ranks);
the first, the second and the third of eight (sequence of the first three ranks);
the first three of eight (combination of the first three ranks); and so on
sequence of the eight ranks.

According to a further embodiment of the present invention, one possibility of bets is based on choosing combinations of columns and ranks. In this case bets can be made on:
the first file and the first rank;
sequence of the first two files and sequence of the first two ranks;
combination of the first two files and combination of the first two ranks;
sequence of the first three files and sequence of the first three ranks;
combination of the first three files and combination of the first three ranks; and so on
sequence of the eight files and sequence of the eight ranks.

According to another embodiment of the present invention, one possibility of bets is based on choosing single squares. In this case bets can be made on:
the first of 64;
the last of 64;
the first and the last squares of 64;
sequence of the first two squares of 64;
combination of the first two squares of 64;
sequence of the first three squares of 64;
combination of the first three squares of 64;
sequence of the first four squares of 64;
combination of the first four squares of 64;
sequence of the first five squares of 64;
combination of the first five squares of 64;
sequence of the first six squares of 64;
combination of the first six squares of 64; and so on . . .

According to one another embodiment of the present invention, in casino implementation of the method to play, participants can submit their bets by putting tokens on appropriate spaces of tables. Each table has numbered rows. A number of a row shows an ordinal number of a file or a rank in a sequence. Tables having one row can be used to make bets on combinations of columns or ranks. Said tables and tokens can be used by a dealer or his assistant to write down the results of the game.

As few examples, FIGS. 33 and 34 show tables, used for columns, and wherein:
FIG. 33, to make bets on the first and the second of eight (sequence of the first two files);
FIG. 34, to make bets on the first two of eight (combination of the first two files).

As few examples, FIGS. 36 and 37 show tables, used for ranks, and wherein:
FIG. 36, to make bets on the first and the second of eight (sequence of the first two ranks);
FIG. 37, to make bets on the first two of eight (combination of the first two ranks).

According to an embodiment of the present invention and as disclosed in the first example, there is another way to make bets in casinos, using two kinds of tokens: with numbers and without numbers. A number of a token shows an ordinal number of a file or rank in a sequence. Each table has only one row. Tokens without numbers can be used to make bets on combinations of files or ranks. Said tokens and tables can be used by the dealer or his assistant to write down the results of the game.

As an example, FIG. 34 shows a table which can be used to make bets on:
a sequence of the first two files (tokens with numbers);
a combination of the first two files (tokens without numbers).

As an example, FIG. 37 shows a table, which can be used to make bets on:
a sequence of the first two ranks (tokens with numbers);
a combination of the first two ranks (tokens without numbers).

According to an embodiment of the present invention, tables having one row and tables having one column can be used in lottery tickets to make bets on variations with repetitions of the first squares of every rank and the first squares of every file respectively, tables having equal numbers of columns and numbered rows or equal numbers of rows and numbered columns can be used in said lottery tickets to make bets on permutations of files and permutations of ranks of a chess board.

According to still an embodiment of the present invention, in the computer implementation of the method, it can be done by means of a program.

According to another embodiment of the present invention, a computer implementation of the method can use said tables and other virtual tools comprising auxiliary decks of 64 square cards and tokens of two kinds—with numbers and without numbers or, as an example, combo-boxes fulfilling functions, which are the same as those of said tables. Said combo boxes can be used by the program to write down the results of the game and by players to make bets. Numbered combo boxes can be used to make bets on sequences of files and ranks. A number of a combo-box shows an ordinal number of a file or a rank in a sequence. Combo-boxes without numbers can be used to make bets on combinations of files and ranks. FIGS. 43A-43C show an example of combo boxes, which can be used for a sequence of the first three files (columns). FIGS. 44A-44C show an example of combo boxes, which can be used for a combination of the first three files (columns). FIGS. 46A-46C show an example of combo boxes, which can be used for a sequence of the first three ranks (rows). FIGS. 47A-47C show an example of combo boxes, which can be used for a combination of the first three ranks (rows). FIGS. 49A-49D show an example of pairs of combo boxes, which can be used for a sequence of the first two single squares. FIGS. 50A-50D show an example of pairs of combo boxes, which can be used for a combination of the first two single squares (each single square of a chess board can be designated as a combination of a file and a rank). FIGS. 51A-51D, 51E-51H, 51I-51L and 51M-51P show examples of sets of combo-boxes which can be used by game participants in a computer version of the method to make bets on a sequence of eight squares of each diagonal: black (a1-h8) (FIGS. 51A-51H) and white (a8-h1) (FIGS. 51I-51P). FIGS. 41A and 41B show examples of tables, which can be used for writing down a sequence of squares of each diagonal: black (a1-h8) and white (a8-h1).

Method's Implementation Using a Deck of 52 Playing Cards with Repetitions: Rules of the Game

According to one embodiment of the present invention there are a standard deck of 52 playing cards and a table having 52 spaces according to the number of cards in a standard deck of playing cards, arranged in four rows according to suits and 13 columns according to values of cards, such that each card is represented by a particular space of the table.

In a further embodiment, one card is picked out at random from the deck by a dealer, put face up on its place in the table and returned to the deck. Similarly several more cards are picked out at random and returned one by one.

All cards are shuffled thoroughly after each draw. Each card can be picked out more than one time. Besides, two additional cards are picked out at random and put face up on their places. There is one more deck of 52 playing cards divided in two parts: 16 picture cards and 36 non-picture cards. One additional card is picked out from the picture cards and another from the non-picture cards.

All cards picked out during the game are written down by the dealer or his assistant with the help of playing desk of said dealer with tables for each result being written down, tokens of two kinds and auxiliary decks of 52 playing cards.

In still another embodiment, this game can be played in another way:

There are several numbered decks of 52 playing cards and the same number attached numbered or coloured tables, for example:

white—1, yellow—2, orange—3, green—4, blue—5, red—6. Each table is attached to the deck of playing cards with the same number. One card is picked out at random from each deck by a dealer and put face up on its place in the attached table. Cards of the same value and suit can be picked out from different decks, so each card can be picked out more than one time. There is also one more deck of 52 playing cards with attached table for additional draws, divided in two parts: 16 picture cards and 36 non-picture cards. Two additional cards are picked out at random and put face up on their places in the attached table; one of them is picked out from the picture cards and another from the non-picture cards.

All cards picked out during the game are written down by the dealer or his assistant with the help of said playing desk with tables for each result being written down, said tokens of two kinds and auxiliary decks of 52 playing cards.

According to yet an embodiment of the present invention, numbered tables having 52 spaces according to the number of cards in a standard deck of playing cards, arranged in four rows according to suits and 13 columns according to values of cards can be used to write down variations with repetitions of single cards being created in the course of the game. A number of a table shows an ordinal number of a single card in a variation with repetitions. Tables without numbers can be used to write down combinations with repetitions of single cards, separate table is needed for each single card.

According to one another embodiment of the present invention, auxiliary decks of playing cards can be used with said numbered and non-numbered tables having 52 spaces arranged in four rows according to suits and 13 columns according to values of cards to write down variations with repetitions and combinations with repetitions of single cards respectively.

According to yet another embodiment of the present invention, tables having four columns according to the number of suits and tables having 13 columns according to the number of values of cards with numbered rows can be used by a dealer to write down variations with repetitions of suits and values of cards respectively, being created in the course of the game constituting the second part of the presented method, wherein a number of a row shows an ordinal number of a suit or a value of cards in variation with repetitions and a total number of numbered rows in each table is equal to the number of draws of cards.

In still another embodiment, the game can be also implemented as a regular lottery with the help of drums with balls:

There are several numbered or coloured drums with 52 balls in each drum according to the number of cards in a standard deck of playing cards, such that each card is represented by a particular ball. A suit and a value of card are designated on each ball instead of number. One ball is picked out at random from each drum. Balls representing cards of the same value and suit can be picked out from different drums, so each card can be picked out more than one time.

There are two more drums with balls for additional draws. One additional ball is picked out at random from the drum with 16 balls representing picture cards and another from the drum with 36 balls representing non-picture cards. All cards represented by balls picked out during the game are written down by a dealer.

In still another embodiment, the game can be also implemented as a computer version of the method through the Internet as follows: 52 cards of a standard deck of playing cards are placed face down, arranged in four rows according to suits and 13 columns according to values of cards. One card is picked out at random by a program and put face up on its place. Then the card is returned to the deck and put face down on its place again. Similarly several more cards are picked out at random and returned one by one. Besides, two additional cards are picked out at random and put face up on their places. One additional card is picked out from 16 picture cards and another from 36 non-picture cards. Each card can be picked out more than one time. All cards picked out during the game are written down by the program using said tables or combo boxes fulfilling the same functions.

In yet another embodiment, the game can be implemented as a computer version of the method through the Internet or on television, as follows: 52 cards of a standard deck of playing cards are placed face up arranged in four rows according to suits and 13 columns according to values of cards. When a card is picked out at random by a program it is illuminated or otherwise highlighted, when the card is returned to the deck, the illumination is turned off. All cards picked out during the game are written down by the program using said tables or combo boxes fulfilling the same functions.

According to yet a further embodiment of the present invention, when the method is implemented as a computer version, the program is based on a random numbers generator that has been already invented. All cards are numbered with numbers from 1 to 52, for example, according to suits: Spades are numbered from 1 to 13, Clubs are numbered from 14 to 26, Diamonds are numbered from 27 to 39 and Hearts are numbered from 40 to 52. When the random numbers generator generates some random number within the range of numbers from 1 to 52, the card with the same number is picked out.

In one particular embodiment, the computer game can be played through the Internet in another way, as follows:

There are several numbered or coloured decks of 52 playing cards, for example: white—1, yellow—2, orange—3, green—4, blue—5, red—6. The cards of each deck are placed face down, arranged in four rows according to suits and 13 columns according to values of cards. One card is picked out at random from each deck by a program and put face up on its place. Cards of the same value and suit can be picked out from different decks, so each card can be picked out more than one time. There is one more deck of 52 playing cards for additional draws. The cards of this deck are also placed face down, arranged in four rows according to suits and 13 columns according to values of cards. Two additional cards are picked out at random and put face up on their places; one of them is picked out from 16 picture cards and another from 36 non-picture cards. All cards picked out during the game are written down by the program using said tables or combo boxes fulfilling the same functions.

Method's Implementation Using a Deck of 52 Playing Cards with Repetitions: Rules of Bets

In one aspect of the present invention, players can make bets on variations with repetitions in any one of the following examples:

of single cards, i.e. which single card will be picked out in each draw, of suits, i.e. card of which suit will be picked out in each draw and of values of cards, i.e. card of which value will be picked out in each draw.

In still another aspect of the present invention, players can make bets on combinations with repetitions in any one of the following examples:

of single cards, i.e. which combination of single card will be picked out during each game, of suits, i.e. cards of which suits will be picked out during each game and of values of cards, i.e. cards of which values will be picked out during each game.

Particular examples of bets are listed below:

sequence of the first two suits (variation with repetitions);
combination of the first two suits (combination with repetitions);
sequence of the first three suits;
combination of the first three suits;
sequence of the first four suits;
combination of the first four suits;
sequence of the first five suits;
combination of the first five suits;
sequence of the first six suits;
combination of the first six suits;
and so on . . .
sequence of the first two values of cards (variation with repetitions);
combination of the first two values of cards (combination with repetitions);
sequence of the first three values of cards;
combination of the first three values of cards;
sequence of the first four values of cards;
combination of the first four values of cards;
sequence of the first five values of cards;
combination of the first five values of cards;
sequence of the first six values of cards;
combination of the first six values of cards;
and so on . . .

In one embodiment of the present invention, participants of the lottery can make bets by filling in regular lottery tickets with the tables having 52 spaces arranged in four rows according to suits and 13 columns according to values of cards, described above.

More particularly, numbered said tables can be used to make bets on variations with repetitions of single cards, where a number of a table shows an ordinal number of a single card in variation with repetitions. Tables without numbers can be used to make bets on combinations with repetitions of single cards. Separate table is needed for each card and one additional table for two additional cards.

In one another embodiment of the present invention, players in a casino can make bets on variations with repetitions and combinations with repetitions of suits and values of cards by putting tokens on appropriate spaces of tables with numbered and non-numbered rows, having four columns according to the number of suits and 13 columns according to the number of values of cards, respectively. More particularly, tables with numbered rows can be used to make bets on variations with repetitions, wherein a number of a row shows an ordinal number of a suit or a value of cards in variation with repetitions and a total number of rows in each table is equal to the number of draws of cards. Tables with non-numbered rows can be used to make bets on combinations with repetitions of suits and values of cards. Said tables and tokens can be used by a dealer or his assistant to write down the results of the game.

As few examples, FIGS. 19A and 19B schematically show tables, which can be used by game participants to make bets;
FIG. 19A to make bets on variations with repetitions of suits;
FIG. 19B to make bets on combinations with repetitions of suits;

As few examples, FIGS. 20A and 20B schematically show tables, which can be used by game participants to make bets;
FIG. 20A to make bets on variations with repetitions of values of cards;
FIG. 20B to make bets on combinations with repetitions of values of cards;

In still an embodiment of the present invention, there is another way to make bets in a casino, using two kinds of tokens: with numbers and without numbers. Each table has non-numbered rows. A number of a token shows an ordinal number of a suit or a value of cards in variation with repetitions. Tokens without numbers can be used to make bets on combinations with repetitions of suits and values of cards. Said tokens and tables can be used by the dealer or his assistant to write down the results of the game.

As an example, FIG. 19B shows a table which can be used to make bets on:
a variation with repetitions of suits (tokens with numbers);
a combination with repetitions of suits (tokens without numbers);

As one more example, FIG. 20B shows a table, which can be used to make bets on:
a variation with repetitions of values of cards (tokens with numbers);
a combination with repetitions of values of cards (tokens without numbers);

According to still another embodiment of the present invention, in the computer version of the presented method, a program can use said tables and other virtual tools comprising auxiliary decks of 52 playing cards and tokens of two kinds—with numbers and without numbers or, as an example, combo boxes fulfilling functions which are the same as those of said tables. Said combo boxes can be used by the program to write down random sequences forming the results of the game and by players to make bets on said results of the game. Pairs of combo boxes can be used to make bets on single cards. One combo box of each pair shows the list of values of cards and the other shows the list of suits, such that each single card is represented as a combination of a value of card and a suit. More particularly, pairs of combo boxes without numbers can be used to make bets on combinations with repetitions of single cards. Numbered pairs of combo boxes can be used to make bets on variations with repetitions of single cards, where a number of a pair of combo boxes shows an ordinal number of a single card in variation.

According to yet another embodiment, two additional pairs of combo boxes are needed for two additional cards. One combo box of each pair shows the list of suits, the other combo box of the first pair shows the list of values of picture cards, since the first additional card is picked out from 16 picture cards and the other combo box of the second pair shows the list of values of non-picture cards, since the second additional card is picked out from 36 non-picture cards.

In still another embodiment, combo boxes showing the lists of suits or values of cards can be used to make bets on variations with repetitions and combinations with repetitions of suits or values of cards, respectively. More particularly, numbered combo boxes can be used to make bets on variations with repetitions, where a number of a combo box shows an ordinal number of a suit or a value of cards in variation with repetitions. Combo boxes without numbers can be used to make bets on combinations with repetitions of suits or values of cards.

As few examples, FIGS. 27A-27D schematically show sets of combo boxes, which can be used by game participants in a computer version of the presented method to make bets on suits;
FIGS. 27A and 27B to make bets on variations with repetitions of suits;
FIGS. 27C and 27D to make bets on combinations with repetitions of suits.

As few more examples, FIGS. 28A-28D schematically show sets of combo boxes, which can be used by game participants in a computer version of the method to make bets on values of cards;
FIGS. 28A and 28B to make bets on variations with repetitions of values of cards;
FIGS. 28C and 28D to make bets on combinations with repetitions of values of cards.

As one more example, FIGS. 29A-29D schematically show two pairs of combo boxes, which can be used by game participants in a computer version of the method to make bets on additional cards in the second game.

Method's Implementation Using a Deck of 64 Square Cards with Repetitions: Rules of the Game

In one embodiment of the present invention, this game can be implemented with the help of a chess board as follows: There are a chess board and a deck of 64 square cards matching 64 squares of a chess board. Each card is of the same colour, black or white, as the matching square of a chess board and the mark of the square is written on the card, such that each square of a chess board is represented by a particular card. The rear sides of all cards are the same, as in a standard deck of playing cards.

Explanation: a chess board has eight files which are marked by letters: a, b, c, d, e, f, g, h and eight ranks which are marked by figures: 1, 2, 3, 4, 5, 6, 7, 8. Each square of a chess board is the intersection of some file with some rank, so it is marked by both letter and figure, for example: a2, e4, h8 etc. The marks of the squares are not usually written on a chess board. Only marks of the files and the ranks are written on the margins of a chess board.

According to an embodiment of the present invention, one card is picked out at random from the deck by a dealer, put face up on its square of the chess board and returned to the deck. Similarly several more cards are picked out at random and returned one by one. All cards are shuffled thoroughly after each draw. Cards representing the same squares of a chess board can be picked out more than one time. There are also eight cards with numbers: 1, 2, 3, 4, 5, 6, 7 and 8 or with letters: a, b, c, d, e, f, g, h and two blank cards of white and black colours for two additional draws. One additional draw is made from the eight numbers or letters and the other from the two colours. Additional cards are put face up on a playing desk of the dealer. All squares of a chess board picked out during the game and the results of additional draws are written down by the dealer or his assistant with the help of said playing desk with tables for each result being written down, tokens of two kinds and auxiliary decks of 64 square cards.

According to another embodiment of the present invention, numbered tables having 64 spaces, identical with a chess board can be used to write down variations with repetitions of single squares of a chess board being created in the course of the game. A number of a table shows an ordinal number of a single square in variation with repetitions. Said tables without numbers can be used to write down combinations with repetitions of single squares, separate table is needed for each single square of a chess board.

According to still a further embodiment of the present invention, auxiliary decks of 64 square cards matching 64 squares of a chess board can be used with said numbered and non-numbered tables having 64 spaces, identical with a chess board to write down variations with repetitions and combinations with repetitions of single squares of a chess board respectively.

According to yet a further embodiment of the present invention, tables with columns representing files or ranks and numbered rows can be used to write down variations with repetitions of files and ranks of a chess board being created in the course of the game constituting the second part of the presented method, a number of a row shows an ordinal number of a file or a rank in variation with repetitions and a total number of numbered rows is equal to the number of draws of single squares of a chess board.

In still another embodiment of the present invention, the game can be played in another way, with the help of several numbered decks of 64 square cards with the same number attached numbered chess boards. Each chess board is attached to the deck of square cards with the same number. One card is picked out at random from each deck by a dealer and put face up on its square of the attached chess board. Cards representing the same squares of a chess board can be picked out from different decks, so each square of a chess board can be picked out more than one time. Two additional draws are made as described above.

All squares of a chess board picked out during the game and the results of additional draws are written down by the dealer or his assistant with the help of said playing desk with tables for each result being written down, tokens of two kinds and auxiliary decks of 64 square cards.

In one embodiment of the present invention, the game can be also implemented as a regular lottery, with the help of several numbered or coloured drums with 64 balls matching 64 squares of a chess board in each drum. Each ball is of the same colour (black or white) as the matching square of a chess board and the mark of the square is written on the ball, so each square of a chess board is represented by a particular ball. One ball is picked out at random from each drum and written down by a dealer or his assistant. Balls representing the same squares of a chess board can be picked out from different drums, so each square of a chess board can be picked out more than one time. There are two more drums for additional draws, one of them with eight balls designated by numbers: 1, 2, 3, 4, 5, 6, 7, 8 or letters: a, b, c, d, e, f, g, h and the other with two balls of black and white colours. One ball is picked out at random from each drum. The results of additional draws are also written down by the dealer or his assistant.

In still another embodiment, the game can be also played as a computer game through the Internet as follows:

Several squares of a chess board are picked out at random and returned by a program one by one. When a square is picked out its mark appears on the chess board, when it is returned its mark disappears.

Each square can be picked out more than one time. All squares of the chess board picked out during the game are written down by the program. Besides, two additional draws are made. There are two additional tables: the table having eight spaces arranged in one row or column with numbers from 1 to 8 or letters from a to h and the table having two coloured spaces—black and white. One number or letter is picked out from the eight numbers or letters and one colour is picked out from the two colours. When a number or a letter and a colour are picked out they are illuminated. The results of additional draws are also written down by the program.

In still another particular embodiment, the computer game can be played through the Internet in another way, with the help of several chess boards and two tables for additional draws described above. One square is picked out at random from the 64 squares of each chess board. When the square is picked out its mark appears on the chess board. Squares with the same mark can be picked out on different chess boards, so each square can be picked out more than one time. When a number or a letter and a colour are picked out they are illuminated. All squares picked out during the game and the results of additional draws are written down by the program.

According to yet a further embodiment of the present invention, when the method is implemented as a computer version, said program is based on a random numbers generator that has been already invented. All squares of the chess board are numbered with numbers from 1 to 64, for example, by columns: “a” from 1 to 8, “b” from 9 to 16, “c” from 17 to 24, “d” from 25 to 32, “e” from 33 to 40, “f” from 41 to 48, “g” from 49 to 56, and “h” from 57 to 64.

According to another embodiment of the present invention, when the random numbers generator generates some random number within the range of numbers from 1 to 64, the square of the chess board with the same number is picked out.

Method's Implementation Using a Deck of 64 Square Cards with Repetitions: Rules of Bets

In one aspect of the present invention, players can make bets on variations with repetitions as follows: of squares of a chess board, i.e. which square of a chess board will be picked out in each draw, of files, i.e. square of which file will be picked out in each draw and of ranks, i.e. square of which rank will be picked out in each draw. In still another aspect of the present invention, players can make bets on combinations with repetitions as follows: of squares of a chess board, i.e. which squares of a chess board will be picked out during each game, of files, i.e. squares of which files will be picked out during each game and of ranks, i.e. squares of which ranks will be picked out during each game.

The following lists several examples of bets according to the above aspects of the invention:

sequence of the first two squares of a chess board (variation with repetitions) with or without additional draws;
combination of the first two squares of a chess board (combination with repetitions) with or without additional draws;
sequence of the first three squares of a chess board with or without additional draws;
combination of the first three squares of a chess board with or without additional draws;
sequence of the first four squares of a chess board with or without additional draws;
combination of the first four squares of a chess board with or without additional draws;
sequence of the first five squares of a chess board with or without additional draws;
combination of the first five squares of a chess board with or without additional draws;
and so on . . .
sequence of the first two files (variation with repetitions);
combination of the first two files (combination with repetitions);
sequence of the first three files;
combination of the first three files;
sequence of the first four files;
combination of the first four files;
sequence of the first five files;
combination of the first five files;
and so on . . .
sequence of the first two ranks (variation with repetitions);
combination of the first two ranks (combination with repetitions);
sequence of the first three ranks;
combination of the first three ranks;
sequence of the first four ranks;
combination of the first four ranks;
sequence of the first five ranks;
combination of the first five ranks;
and so on . . .

In one embodiment, participants of the lottery can make bets by filling in lottery tickets having tables identical with chess boards.

More particularly, numbered said tables can be used to make bets on variations with repetitions, where a number of a table shows an ordinal number of a single square of a chess board in variation with repetitions. Tables without numbers can be used to make bets on combinations with repetitions of squares of a chess board. Separate table is needed for each single square of a chess board.

In yet another embodiment, tables having eight spaces with numbers from 1 to 8 or letters from a to h, arranged in one row or column and tables having two coloured spaces—black and white can be used to make bets on additional draws.

In one particular embodiment, players in a casino can make bets on variations with repetitions and combinations with repetitions of files or ranks by putting tokens on appropriate spaces of tables having eight columns according to the number of files or ranks and numbered and non-numbered rows. More particularly, tables with numbered rows can be used to make bets on variations with repetitions, wherein a number of a row shows an ordinal number of a file or a rank in variation with repetitions and a total number of numbered rows is equal to the number of draws of single squares of a chess board. Tables with non-numbered rows can be used to make bets on combinations with repetitions of files or ranks. Said tables and tokens can be used by a dealer or his assistant to write down the results of the game.

As few examples, FIGS. 39A and 39B schematically show tables, which can be used by game participants to make bets;
FIG. 39A to make bets on variations with repetitions of files of a chess board;
FIG. 39B to make bets on combinations with repetitions of files of a chess board.

As few more examples, FIGS. 40A and 40B schematically show tables, which can be used by game participants to make bets;
FIG. 40A to make bets on variations with repetitions of ranks of a chess board;
FIG. 40B to make bets on combinations with repetitions of ranks of a chess board.

According to still an embodiment, there is another way to make bets in a casino, using two kinds of tokens: with numbers and without numbers. Each table has non-numbered rows. A number of a token shows an ordinal number of a file or a rank in variation with repetitions. Tokens without numbers can be used to make bets on combinations with repetitions of files and ranks. Said tokens and tables can be used by the dealer or his assistant to write down the results of the game.

As an example, FIG. 39B shows a table which can be used to make bets on:
a variation with repetitions of files (tokens with numbers);
a combination with repetitions of files (tokens without numbers);

As one more example, FIG. 40B shows a table, which can be used to make bets on:
a variation with repetitions of ranks (tokens with numbers);
a combination with repetitions of ranks (tokens without numbers);

According to one embodiment of the present invention, in the computer version of the presented method, a program can use said tables and other virtual tools comprising auxiliary decks of 64 square cards and tokens of two kinds—with numbers and without numbers or, as an example, combo boxes fulfilling functions which are the same as those of said tables. Said combo boxes can be used by the program to write down random sequences forming the results of the game and by players to make various bets on said results of the game. Pairs of combo boxes can be used to make bets on squares of a chess board. One combo box of each pair shows the list of letters: a, b, c, d, e, f, g, h and the other shows the list of figures: 1, 2, 3, 4, 5, 6, 7, 8, so each square of a chess board is represented as a combination of a letter and a figure. More particularly, pairs of combo boxes without numbers can be used to make bets on combinations with repetitions of squares of a chess board. Numbered pairs of combo boxes can be used to make bets on variations with repetitions, where a number of a pair of combo boxes shows an ordinal number of a square of a chess board in variation with repetitions.

According to another embodiment of the present invention, two additional combo boxes are needed for two additional draws. One combo box shows the list of figures: 1, 2, 3, 4, 5, 6, 7, 8 or letters: a, b, c, d, e, f, g, h and the other shows the list of colours: black, white.

In still another embodiment, combo boxes showing the lists of files or ranks can be used to make bets on variations with repetitions and combinations with repetitions of files or ranks, respectively. More particularly, numbered combo boxes can be used to make bets on variations with repetitions, where a number of a combo box shows an ordinal number of a file or a rank in variation with repetitions. Combo boxes without numbers can be used to make bets on combinations with repetitions of files or ranks.

As few examples:

FIGS. 43A-43C schematically show a set of combo-boxes, which can be used by game participants in a computer version of the method to make bets on variations with repetitions of files of a chess board;

FIGS. 44A-44C schematically show a set of combo-boxes, which can be used by game participants in a computer version of the method to make bets on combinations with repetitions of files of a chess board.

As few more examples:

FIGS. 46A-46C schematically show a set of combo-boxes, which can be used by game participants in a computer version of the method to make bets on variations with repetitions of ranks of a chess board;

FIGS. 47A-47C schematically show a set of combo-boxes which can be used by game participants in a computer version of the method to make bets on combinations with repetitions of ranks of a chess board.

As one more example, FIGS. 52A-52C schematically show a set of combo boxes, which can be used by game participants in the computer version of the method to make bets on the results of additional draws.

Although embodiments of the invention have been described by way of illustration, it will be understood that the invention may be carried out with many variations, modifications and adaptations without exceeding the scope of the claims.

1. A method for playing lotto games using various types of betting elements and creating many random sequences of said betting elements containing all possible types of combinatorial structures thereof, wherein said betting elements of each type comprise single betting elements and sub-elements of at least two kinds, forming said single betting elements, said method consisting of two parts and comprising:
placing bets on single betting elements and sub-elements or combinations, variations, permutations, combinations with repetitions or variations with repetitions thereof, according to selected by a player bet amount and a chance to win, by putting tokens on appropriate spaces of one or more tables on playing desk of a player in a casino or filling in one or more tables in lottery tickets, said tables allow making every possible bet on results of games constituting both parts of said method, each table is designed for a particular kind of bets, or betting with a computing device using said tables and other virtual tools or combo boxes fulfilling functions which are the same as those of said tables;
picking out betting elements at random one by one from a set of said betting elements and putting each betting element face up on a space representing it in a table having a number of spaces according to a number of single betting elements, arranged in rows and columns according to numbers of sub-elements, such that each single betting element is represented by a particular space of said table as a combination of two sub-elements, which makes visual creation of random sequences forming results of games constituting both parts of said method, as follows:
picking out all betting elements at random one by one from a set of said betting elements during a game constituting the first part of said method, which brings about creation of random sequences of single betting elements and sub-elements of different kinds, which are permutations containing variations and combinations of different numbers of said single betting elements and sub-elements and also of variations with repetitions and combinations with repetitions of different numbers of said sub-elements, and writing down results of the game by putting tokens or single betting elements from auxiliary sets of said betting elements on appropriate spaces of tables, or marking appropriate spaces of tables on playing desk of a dealer or lottery operator with tables for each result being written down, or with said computing device using said tables and other virtual tools or combo boxes fulfilling functions which are the same as those of said tables;
picking out at random and returning to a set, one by one a particular number of said betting elements during a game constituting the second part of said method, which brings about creation of random sequences of different kinds allowing repetitions of previously selected said betting elements, containing variations with repetitions and combinations with repetitions of different numbers of said single betting elements and sub-elements and writing down results of the game using said playing desk of a dealer or lottery operator with tables for each result being written down, tokens and auxiliary sets of betting elements or with said computing device, using said tables and other virtual tools or said combo boxes fulfilling functions which are the same as those of said tables;
picking out at random and writing down at least two additional betting elements;
determining whether a successful bet has occurred after each part of the presented method, and in the affirmative case, granting a player winning amount according to the probability of success of his bet.

2. A kit of tools for playing lotto games which comprises: sets of betting elements of different types comprising main and auxiliary sets of said betting elements, each type comprises single betting elements and sub-elements of at least two kinds, forming said single betting elements; tables comprising: tables associated with playing desk of a dealer with tokens of two kinds—with numbers and without numbers, tables associated with playing desk of a player with said tokens of two kinds, tables used in lottery tickets, said tables and other virtual tools or combo boxes used in a computer version of the method for playing lotto games; said tables and combo boxes being used for writing down results of the games and for making bets and tables for putting said betting elements, picked out at random during the games constituting the presented method are selected according to a type of betting elements from the following list:
sets of numbered and non-numbered tables having a number of spaces according to a number of single betting elements, arranged in rows and columns according to numbers of sub-elements, such that each single betting element is represented by a particular space of each of said tables as a combination of two sub-elements;
sets of tables having a number of columns or rows according to a number of the first sub-element with numbered and non-numbered rows or columns respectively and with one row or column;
sets of tables having a number of columns or rows according to a number of the second sub-element with numbered and non-numbered rows or columns respectively and with one row or column;
sets of tables having equal numbers of columns or rows representing sub-elements and numbered rows or columns respectively;
sets of tables having a number of spaces according to a number of single betting elements, arranged in rows and columns according to numbers of sub-elements, with columns representing the first sub-element and numbered rows and with rows representing the second sub-element and numbered columns, said tables are used with auxiliary sets of betting elements;
sets of numbered and non-numbered combo boxes showing lists of sub-elements in a computer version of said method;
sets of numbered and non-numbered pairs of combo boxes in the computer version of said method, one combo box of each pair shows a list of the first sub-element and the other shows a list of the second sub-element, such that each single betting element is represented by a pair of combo boxes as a combination of two sub-elements.

3. A method for playing lotto games according to claim 1, wherein said variations with repetitions and combinations with repetitions of sub-elements are created as derivatives of random sequences of single betting elements which belong to the same sub-element, being created in a course of the game constituting the first part of the presented method.

4. A method for playing lotto games according to claim 1, which is implemented with the help of each type from a plurality of types of betting elements comprising 52 cards of a standard deck of playing cards, 64 squares of chess or checkers board, 100 squares of an international draughts board, 28 dominos, symbols relating to other table games, numbers or letters of the alphabet of different colours, pictures of different colours and any types of betting elements comprising single betting elements and sub-elements of at least two kinds, forming said single betting elements.

5. A method for playing lotto games according to claim 1, wherein said random sequences of betting elements of different kinds, being created during the game constituting the first part of the presented method are 24 random sequences of five different kinds, which comprise a main random sequence of 52 cards and additional 23 random sequences of four kinds, comprising:
four random sequences of cards of the same suit;
13 random sequences of cards of the same value;
a random sequence of suits, which contains additional two random sequences: of black suits and of red suits;
a random sequence of values of cards, which contains additional two random sequences: of values of picture cards and of values of non-picture cards;
which are permutations containing variations and combinations of different numbers of single cards, suits and values of cards.

6. A method for playing lotto games according to claim 1, wherein said random sequences of different kinds allowing repetitions of previously selected betting elements, being created during the game constituting the second part of the presented method are three random sequences of three different kinds, which comprise:
random sequence of single cards;
random sequence of suits;
random sequence of values of cards;
which contain variations with repetitions and combinations with repetitions of different numbers of single cards, suits and values of cards.

7. A method for playing lotto games according to claim 3, wherein said variations with repetitions and combinations with repetitions of sub-elements are created as derivatives of random sequences of cards of the same suit and cards of the same value and contain the first cards of every suit, the first cards of every value of cards and additional cards picked out under the same ordinal numbers in each suit and in each value of cards respectively.

8. A method for playing a lotto game according to claim 1, wherein 52 cards being picked out at random one by one are put face up on spaces representing them in a table having 52 spaces according to the number of cards, arranged in four rows according to suits and 13 columns according to values of cards, such that each card is represented by a particular space of the table as a combination of a value of card and a suit, in order to make visual the creation of said random sequences in a course of the game.

9. A method for playing a lotto game according to claim 1, which is played with a computing device, wherein at the beginning of each game 52 cards of a standard deck of playing cards are placed face down, arranged in four rows according to suits and 13 columns according to values of cards; when a card is picked out at random by a program it is turned over and put face up on its place, when all cards are put face up the game constituting the first part of said method is over, when the card is returned to the deck in the game constituting the second part of said method, it is turned over again and put face down on its place.

10. A method for playing a lotto game according to claim 1, which is played with a computing device, wherein at the beginning of each game 52 cards of a standard deck of playing cards are placed face up, arranged in four rows according to suits and 13 columns according to values of cards; when a card is picked out at random by a program it is illuminated or otherwise highlighted, when all cards are illuminated the game constituting the first part of said method is over, when the card is returned to the deck in the game constituting the second part of said method, the illumination is turned off.

11. A method for playing lotto games according to claim 1, wherein bet is made on one or more single cards, which include cards of a particular suit and cards of a particular value.

12. A method for playing lotto games according to claim 1, wherein bet is made on one or more variations with repetitions and combinations with repetitions of cards of different suits.

13. A method for playing lotto games according to claim 1, wherein bet is made on one or more variations with repetitions and combinations with repetitions of cards of different values.

14. A method for playing lotto games according to claim 1, wherein bet is made on one or more combinations and variations of at least two cards of different values of the same suit.

15. A method for playing lotto games according to claim 1, wherein bet is made on one or more combinations and variations of at least two cards of different suits of the same value.

16. A method for playing lotto games according to claim 1, wherein bet is made on one or more combinations and variations of at least two single cards.

17. A method for playing lotto games according to claim 1, wherein bet is made on one or more combinations and variations of at least two suits.

18. A method for playing lotto games according to claim 1, wherein bet is made on one or more combinations and variations of at least two values of cards.

19. A method for playing lotto games according to claim 1, wherein bet is made on one or more variations with repetitions and combinations with repetitions of at least two single cards.

20. A method for playing lotto games according to claim 1, wherein bet is made on one or more variations with repetitions and combinations with repetitions of at least two suits.

21. A method for playing lotto games according to claim 1, wherein bet is made on one or more variations with repetitions and combinations with repetitions of at least two values of cards.

22. A method for playing lotto games according to claim 1, wherein bet is made on one or more permutations of cards of the same suit.

23. A method for playing lotto games according to claim 1, wherein bet is made on one or more permutations of cards of the same value.

24. A method for playing lotto games according to claim 1, wherein bet is made on one or more permutations of suits.

25. A method for playing lotto games according to claim 1, wherein bet is made on one or more permutations of values of cards.

26. A method for playing lotto games according to claim 1, which is implemented as a lottery.

27. A method for playing lotto games according to claim 1, which is implemented as a casino game.

28. A method for playing lotto games according to claim 1, which is implemented as a computer game.

29. A kit of tools for playing lotto games according to claim 2, comprising:
regular tokens without numbers and the following three kinds of tables: tables having one row, tables having non-numbered rows and tables having numbered rows;
following two kinds of tables: tables having one row and tables having non-numbered rows, and following two kinds of tokens: tokens with numbers and tokens without numbers;
said tokens and tables are used by a player to make one or more bets in a casino and by a dealer or lottery operator to write down the results of the game by putting said tokens on appropriate spaces of one or more of said tables.

30. A kit of tools for playing lotto games according to claim 2, comprising tables having one row and tokens without numbers, which are used by a player in a casino to make bet on one or more cards of a particular suit, cards of a particular value, suits or values of cards, or combinations thereof, and tables having non-numbered rows and tokens without numbers, which are used to make bet on one or more combinations with repetitions of suits or values of cards.

31. A kit of tools for playing lotto games according to claim 2, comprising tables having numbered rows and tokens without numbers, which are used by a player in a casino to make bet on one or more variations, variations with repetitions or permutations, a number of a row shows an ordinal number of card of a particular suit, or card of a particular value, or suit, or value of cards in variation or permutation, or an ordinal number of suit or value of cards in variation with repetitions, said tables and tokens are used by the dealer or lottery operator to write down the results of the game.

32. A kit of tools for playing lotto games according to claim 2, comprising tables having one row and tokens with numbers, which are used by a player in a casino to make bet on one or more variations or permutations, wherein a number of a token shows an ordinal number of card of a particular suit, or card of a particular value, or suit, or value of cards in variation or permutation, said tables and tokens are used by the dealer or lottery operator to write down the results of the game.

33. A kit of tools for playing lotto games according to claim 2, comprising tables having non-numbered rows and tokens with numbers, which are used by a player in a casino to make bet on one or more variations with repetitions, wherein a number of a token shows an ordinal number of a suit or a value of cards in variation with repetitions, said tables and tokens are used by the dealer or lottery operator to write down the results of the game.

34. A kit of tools for playing lotto games according to claim 2, comprising regular lottery tickets with tables having one row, tables having one column and tables having numbered rows, wherein tables having one row are used by a participant in the lottery to make bet on one or more variations with repetitions of combinations of the first card of each suit and additional cards picked out under the same ordinal numbers in each suit, tables having one column are used to make bet on one or more variations with repetitions of the first cards of every value of cards, tables having numbered rows are used to make bet on one or more variations with repetitions of variations of the first card of each suit and additional cards picked out under the same ordinal numbers in each suit and on one or more permutations of values of cards.

35. A kit of tools for playing lotto games according to claim 2, comprising tables having 52 spaces, arranged in four rows according to suits and 13 columns according to values of cards, such that each single card is represented by a particular space of the table, which are used by a player in a casino or a participant in the lottery to make bet on one or more single cards or one or more combinations of single cards respectively, putting tokens without numbers or marking appropriate spaces of one or more of said tables, one table is used for each single card or each combination of single cards, or for one or two additional cards, and table of the same kind is used by a dealer in a casino or by lottery operator to put face up cards picked out at random from a deck and to write down variations of single cards putting tokens with numbers on appropriate spaces of said table, wherein a number of a token shows an ordinal number of a single card in a variation.

36. A kit of tools for playing lotto games according to claim 2, comprising numbered said tables having 52 spaces arranged in four rows according to suits and 13 columns according to values of cards, which are filled in by a participant in the lottery to make bet on one or more variations or variations with repetitions of single cards, wherein a number of a table shows an ordinal number of a single card in a variation or variation with repetitions and tables of the same kind are used to write down variations and variations with repetitions of single cards being created in the course of the games constituted said method, putting tokens without numbers or marking appropriate spaces of said tables, said non-numbered tables are filled in by a player to make bet on one or more combinations with repetitions of single cards, one table is used for each single card.

37. A kit of tools for playing lotto games according to claim 2, comprising auxiliary decks of 52 playing cards which are used with said numbered tables having 52 spaces arranged in four rows according to suits and 13 columns according to values of cards to write down variations and variations with repetitions of single cards, said auxiliary decks of playing cards are used with said non-numbered tables to write down combinations and combinations with repetitions of single cards.

38. A kit of tools for playing lotto games according to claim 2, comprising auxiliary deck of 52 playing cards which is used with table having 52 numbered spaces according to the number of cards in a standard deck of playing cards, to write down random sequence of 52 cards forming the result of the game constituting the first part of the presented method.

39. A kit of tools for playing lotto games according to claim 2, comprising tables having four columns according to the number of suits and tables having 13 columns according to the number of values of cards, said tables with numbered rows are used by a player to make bet on one or more variations with repetitions of suits and values of cards respectively and by a dealer to write down variations with repetitions of suits and values of cards being created in the course of the game constituting the second part of the presented method, wherein a number of a row shows an ordinal number of a suit or a value of cards in variation with repetitions and a total number of rows in each table is equal to a number of draws of cards, said tables with non-numbered rows are used to make bet on one or more combinations with repetitions of suits or values of cards.

40. A kit of tools for playing lotto games according to claim 2, comprising tables with equal number of rows or columns representing suits and numbered columns or rows respectively and tables with equal number of columns or rows representing values of cards and numbered rows or columns respectively, which are used to write down random sequences being created in the course of the game constituting the first part of the presented method, said tables are used by a player to make bet on one or more permutations of suits and values of cards respectively.

41. A kit of tools for playing lotto games according to claim 2, wherein said auxiliary decks of 52 playing cards are used with tables having 52 spaces arranged in four rows according to suits and 13 columns according to values of cards to write down random sequences being created in the course of the game constituting the first part of the presented method, said tables with rows representing suits and numbered columns are used with said auxiliary decks of playing cards to write down random sequences of cards of the same suit, said tables with columns representing values of cards and numbered rows are used with said auxiliary decks of playing cards to write down random sequences of cards of the same value.

42. A kit of tools for playing lotto games according to claim 2, which are played with a computing device, wherein a program uses said tables and other virtual tools comprising auxiliary decks of 52 playing cards and tokens of two kinds—with numbers and without numbers or combo boxes fulfilling functions which are the same as those of said tables.

43. A kit of tools for playing lotto games according to claim 2, comprising combo boxes, which are used by a player in a computer version of the method to make bet on one or more cards of a particular suit, cards of a particular value, suits or values of cards, or combinations thereof by choosing from one or more lists of suits and of values of cards, shown by said combo boxes.

44. A kit of tools for playing lotto games according to claim 2, comprising numbered combo boxes, which are used by a player in the computer version of the method to make bet on one or more variations or permutations, a number of a combo box shows an ordinal number of card of a particular suit, or card of a particular value, or suit, or value of cards in variation or permutation, said numbered combo boxes are used by the program to write down random sequences of cards of the same suit, cards of the same value, suits and values of cards being created in the course of the game constituting the first part of the presented method.

45. A kit of tools for playing lotto games according to claim 2, comprising numbered combo boxes, which are used by a player in the computer version of the method to make bet on one or more variations with repetitions of suits or values of cards, a number of a combo box shows an ordinal number of a suit or a value of cards in variation with repetitions, and combo boxes without numbers, which are used to make bet on one or more combinations with repetitions of suits or values of cards, said numbered combo boxes are used by the program to write down variations with repetitions of suits and values of cards being created in the course of the game constituting the second part of the presented method.

46. A kit of tools for playing lotto games according to claim 2, comprising pairs of combo boxes, which are used by a player in the computer version of the method to make bet on one or more single cards, wherein one combo box of each pair shows the list of values of cards and the other shows the list of suits, such that each single card is represented as a combination of a value of card and a suit, pairs of combo boxes without numbers are used by a player to make bet on one or more single cards, combinations or combinations with repetitions thereof, numbered pairs of combo boxes are used to make bet on one or more variations or variations with repetitions of single cards, a number of a pair of combo boxes shows an ordinal number of a single card in variation or variation with repetitions, said numbered pairs of combo boxes are used by the program to write down variations and variations with repetitions of single cards being created in the course of the games constituting the presented method, non-numbered pairs of combo boxes are used to write down combinations and combinations with repetitions of single cards.

47. A kit of tools for playing lotto games according to claim 2, comprising two pairs of combo boxes, which are used by a player in the computer version of the method to make bet on one or two additional cards and by the program to write down said additional cards, wherein one combo box of each pair shows the list of suits, the other combo box of the first pair shows the list of values of picture cards, since the first additional card is picked out from 16 picture cards, and the other combo box of the second pair shows the list of values of non-picture cards, since the second additional card is picked out from 36 non-picture cards.

48. A method for playing lotto games according to claim 1, wherein the betting elements are picked out at random from a deck of 64 square cards matching 64 squares of a chess board, each card is of the same color as the matching square, black or white, and the mark of the square is written on the card.

49. A method for playing lotto games according to claim 48, further comprising picking out additional cards at random from eight cards with numbers: 1, 2, 3, 4, 5, 6, 7, 8 or with letters: a, b, c, d, e, f, g, h and two blank cards of white and black colors for two additional draws, wherein one additional draw is made from said eight numbers or letters and the other from said two blank cards of white and black colors, said additional cards are put face up on a desk of a dealer, all squares of a chess board picked out during the game and the results of additional draws are written down by said dealer or his assistant.

50. A method for playing lotto games according to claim 1, which is implemented with the help of numbers or letters of the alphabet, or pictures having additional features to meet the requirements to betting elements, according to the definition of said betting elements.

51. A method for playing lotto games according to claim 50, wherein said numbers or letters of the alphabet, or pictures are of different colours and each colour group comprises the same numbers or letters, or pictures.

52. A method for playing lotto games according to claim 1, wherein different possibilities from the variety of possibilities provided by the games are used according to a number of players.

53. A method for playing lotto games according to claim 1, wherein a player plays against a house or against other players.

54. A method for playing lotto games according to claim 1, wherein a dealer is either a human or an automated system and a player is either a human or an automated system.
